(19) United States
(12) Patent Application Publication
(10) Pub. No.: US 2025/0252515 A1
(43) Pub. Date: Aug. 7, 2025

(54) CONSTRUCTION SOFTWARE PLATFORM FOR EVALUATING USE OF ONE OR MORE CONSTRUCTION PRODUCTS FOR USE IN CONSTRUCTION PROJECTS

(71) Applicant: KOPE AI Ltd, London (GB)

(72) Inventors: Radu-Mihail Gidei, Liège (BE); Mark Daniel Thorley, London (GB); David Flynn, London (GB); Oliver Edward Green, Kent (GB); Alvaro Ortega-Pickmans, Valencia (ES)

(73) Assignee: KOPE AI Ltd, London (GB)

(21) Appl. No.: 19/047,816

(22) Filed: Feb. 7, 2025

Related U.S. Application Data
(60) Provisional application No. 63/550,930, filed on Feb. 7, 2024.

(51) Int. Cl. G06Q 50/08; G06F 30/13; G06F 30/20

(52) U.S. Cl. CPC G06Q 50/08; G06F 30/13; G06F 30/20

(57) ABSTRACT

Techniques for evaluating use of one or more construction products in a construction project, the techniques involving executing a construction software platform to perform: (A) obtaining an initial construction project model for the construction project; (B) obtaining a selection of a first construction product for evaluating its use in the construction project, the first construction product being in a first construction project category; (C) identifying, using the first construction product category, a first mapping software program for mapping the first construction product to the initial construction project model; (D) executing the first mapping software program to map the first construction product to the initial construction project model to obtain an updated construction project model; and (E) outputting the updated construction project model.

### CROSS-REFERENCE TO RELATED APPLICATIONS

This application claims the benefit of priority to U.S. Provisional Application No. 63/550,930, filed Feb. 7, 2024, and titled “CONSTRUCTION SOFTWARE PLATFORM FOR EVALUATING USE OF ONE OR MORE CONSTRUCTION PRODUCTS FOR USE IN CONSTRUCTION PROJECTS,” which is incorporated by reference herein in its entirety.

### FIELD

Aspects of the present disclosure relate to techniques for evaluating use of one or more construction products in construction projects, which may be offsite construction projects, onsite construction objects, and/or prefab construction projects. The techniques may be implemented as part of a software platform that can be used by suppliers and buyers of the construction products.

### BACKGROUND

Construction may be performed entirely at a build site where the constructed project will remain upon completion (“on site” or “onsite”). In onsite construction, various building materials and/or prefabricated building components are transported to the build site, where construction teams work to assemble the building materials and/or prefabricated building components according to a project plan. Construction may also be performed at least in part at a location other than the build site (“off site” or “offsite”). In both offsite and onsite construction, some components can be assembled from one or more prefabricated construction products and/or systems and, in the case of offsite construction, the resulting assembly can be subsequently transported to the build site, where they are used in the project.

### SUMMARY

Some embodiments provide for a method for use by a construction software platform for evaluating use of one or more construction products in a construction project, the method comprising executing the construction software platform using at least one computer hardware processor to perform: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

Some embodiments provide for a system for evaluating use of one or more construction products in a construction project, the system comprising at least one computer hardware processor to perform: at least one non-transitory computer-readable storage medium storing processor executable instructions that, when executed by the at least one computer hardware processor, cause the at least one computer hardware processor to perform: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

Some embodiments provide for at least one non-transitory computer-readable storage medium storing processor executable instructions that, when executed by at least one computer hardware processor, cause the at least one computer hardware processor to perform a method for evaluating use of one or more construction products in a construction project, the method comprising: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

Some embodiments provide for a method for use by a construction software platform for evaluating use of one or more construction products, the method comprising: executing the construction software platform using at least one computer hardware processor to perform: (A) obtaining a selection of a first construction product for evaluating its use, the first construction product being in a first construction project category; (B) identifying, using the first construction product category or first construction product, a first mapping software program for generating a product design composed of one or more instances of the first construction product; (C) executing the first mapping software program to generate the product design composed of the one or more instance of the first construction product; and (D) outputting the product design.

Some embodiments provide for a system for evaluating use of one or more construction products, the system comprising: at least one computer hardware processor to perform: at least one non-transitory computer-readable storage medium storing processor executable instructions that, when executed by the at least one computer hardware processor, cause the at least one computer hardware processor to perform: (A) obtaining a selection of a first construction product for evaluating its use, the first construction product being in a first construction project category; (B) identifying, using the first construction product category or first construction product, a first mapping software program for generating a product design composed of one or more instances of the first construction product; (C) executing the first mapping software program to generate the product design composed of the one or more instance of the first construction product; and (D) outputting the product design.

Some embodiments provide for at least one non-transitory computer-readable storage medium storing processor executable instructions that, when executed by at least one computer hardware processor, cause the at least one computer hardware processor to perform a method for evaluating use of one or more construction products, the method comprising: (A) obtaining a selection of a first construction product for evaluating its use, the first construction product being in a first construction project category; (B) identifying, using the first construction product category or the first construction product, a first mapping software program for generating a product design composed of one or more instances of the first construction product; (C) executing the first mapping software program to generate the product design composed of the one or more instance of the first construction product; and (D) outputting the product design.

Some embodiments provide for using optimization to evaluate use of one or more construction products in a construction project, the one or more construction products including a first construction product in a first construction product category, the method comprising using at least one computer hardware processor to perform: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

Some embodiments provide for a system for using optimization to evaluate use of one or more construction products in a construction project, the one or more construction products including a first construction product in a first construction product category, the system comprising at least one computer hardware processor to perform: at least one non-transitory computer-readable storage medium storing processor executable instructions that, when executed by the at least one computer hardware processor, cause the at least one computer hardware processor to perform: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

Some embodiments provide for at least one non-transitory computer-readable storage medium storing processor executable instructions that, when executed by the at least one computer hardware processor, cause the at least one computer hardware processor to perform a method for using optimization to evaluate use of one or more construction products in a construction project, the one or more construction products including a first construction product in a first construction product category, the method comprising: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

Some embodiments provide for a method for evaluating use of one or more construction products in a construction project, the one or more construction products including a first construction product in a first construction product category, the method comprising using at least one computer hardware processor to perform: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

Some embodiments provide for a system for evaluating use of one or more construction products in a construction project, the one or more construction products including a first construction product in a first construction product category, the system comprising at least one computer hardware processor to perform: at least one non-transitory computer-readable storage medium storing processor executable instructions that, when executed by the at least one computer hardware processor, cause the at least one computer hardware processor to perform: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

Some embodiments provide for at least one non-transitory computer-readable storage medium storing processor executable instructions that, when executed by the at least one computer hardware processor, cause the at least one computer hardware processor to perform a method for evaluating use of one or more construction products in a construction project, the one or more construction products including a first construction product in a first construction product category, the method comprising: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

Some embodiments provide for a method for registering one or more construction products with a construction software platform, the method comprising executing the construction software platform using at least one computer hardware processor to perform: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

Some embodiments provide for a system for registering one or more construction products with a construction software platform, the system comprising: at least one computer hardware processor to perform: at least one non-transitory computer-readable storage medium storing processor executable instructions that, when executed by the at least one computer hardware processor, cause the at least one computer hardware processor to perform: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

Some embodiments provide for at least one non-transitory computer-readable storage medium storing processor executable instructions that, when executed by the at least one computer hardware processor, cause the at least one computer hardware processor to perform a method for registering one or more construction products with a construction software platform, the method comprising: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

The foregoing summary is non-limiting.

### BRIEF DESCRIPTION OF THE DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is a block diagram of an illustrative construction software platform and an environment in which the illustrative construction software platform may be used, in accordance with some embodiments of the technology described herein.

FIG. 1B is a block diagram of an illustrative implementation of a marketplace module part of the illustrative construction software platform of FIG. 1A, in accordance with some embodiments of the technology described herein.

FIG. 1C is a block diagram of an illustrative project design environment part of the illustrative construction software platform of FIG. 1A, in accordance with some embodiments of the technology described herein.

FIG. 1D is a block diagram of an illustrative construction product mapping module part of the illustrative construction software platform of FIG. 1A, in accordance with some embodiments of the technology described herein.

FIG. 1E is a block diagram of an illustrative product design optimization module part of the illustrative construction software platform of FIG. 1A, in accordance with some embodiments of the technology described herein.

FIG. 2 illustrates a flowchart of an illustrative process 200 for using a construction software platform to evaluate one or more construction products in a construction project, in accordance with some embodiments of the technology described herein.

FIG. 3A illustrates an example of a graphical user interface (GUI) 300 for obtaining an initial construction project model for a construction project, in accordance with some embodiments described herein.

FIG. 3B illustrates an example of two GUIs for selecting a collection of products associated with a designer profile 318 and an initial construction project model for a construction project design environment 322, in accordance with some embodiments of the technology described herein.

FIG. 3C illustrates an example of a GUI 331 for selecting a product associated with a first product category from a collection of products associated with a designer profile, in accordance with some embodiments of the technology described herein.

FIG. 3D illustrates an example of a GUI 340 for selecting a product associated with a second product category from a collection of products associated with a designer profile, in accordance with some embodiments of the technology described herein.

FIG. 3E illustrates an example GUI 348 for executing a configurable computational pipeline for mapping two products with default values to an initial construction project model, in accordance with some embodiments of the technology described herein.

FIG. 3F illustrates an example GUI 354 for viewing the updated construction project model resulting from the mapping shown in FIG. 3E, in accordance with some embodiments of the technology described herein.

FIG. 3G illustrates an example GUI 362 for specifying input attributes for a construction product associated with a construction product category, in accordance with some embodiments of the technology described herein.

FIG. 3H illustrates an example GUI 378 for viewing the updated construction project model resulting from the mapping configured in FIG. 3G, in accordance with some embodiments of the technology described herein.

FIG. 3I illustrates, an example GUI 386 for viewing the output attributes for products mapped to the construction project model, in accordance with some embodiments of the technology described herein.

FIG. 4A illustrates an example GUI 400 for a supplier profile, in accordance with some embodiments of the technology described herein.

FIG. 4B illustrates an example GUI 412 for a construction product, in accordance with some embodiments of the technology described herein.

FIG. 4C illustrates an example GUI 418 for a collection of products associated with a designer profile, in accordance with some embodiments of the technology described herein.

FIG. 4D illustrates an example of a GUI 424 for selecting an initial construction project model, in accordance with some embodiments of the technology described herein.

FIG. 4E illustrates an example of a GUI 434 for selecting a product from a collection of products associated with a designer profile, in accordance with some embodiments of the technology described herein.

FIG. 4F illustrates an example of a GUI 442 for optionally configuring product attributes for a product which has been selected for mapping to an initial construction project model, in accordance with some embodiments of the technology described herein.

FIG. 4G illustrates an example GUI 450 for viewing the updated construction project model resulting from the mapping of selected products to the initial construction project model, in accordance with some embodiments of the technology described herein.

FIG. 5A illustrates product attributes that are associated with a specific product from a product category, in accordance with some embodiments of the technology described herein.

FIG. 5B illustrates an example GUI 520 illustrating a product and product attributes, in accordance with some embodiments of the technology described herein.

FIG. 6A illustrates a construction product category schema and attributes thereof, in accordance with some embodiments of the technology described herein.

FIG. 6B illustrates groupings of example input attributes, in accordance with some embodiments of the technology described herein.

FIG. 6C illustrates examples of output attributes 610 associated with a product, in accordance with some embodiments of the technology described herein.

FIG. 6D illustrates examples of input attributes for a SIPs schema, in accordance with some embodiments of the technology described herein.

FIG. 6E illustrates examples of output attributes for a SIPs schema, in accordance with some embodiments of the technology described herein.

FIG. 7 illustrates another example of product design optimization module 700 that may be part of the construction software platform shown in FIG. 1A, in accordance with some embodiments of the technology described herein.

FIG. 8 illustrates a flowchart of an illustrative process 800 for using optimization to evaluate use of one or more construction products in a construction project, in accordance with some embodiments of the technology described herein.

FIG. 9A illustrates GUI 900 for specifying values for inputs not used in the optimization process, in accordance with some embodiments described herein.

FIG. 9B illustrates GUI 912 for obtaining a selection of one or more attributes for use as an objective with respect to which to optimize the construction product, in accordance with some embodiments described herein.

FIG. 9C illustrates a GUI 928 for showing a designer the results of the optimization, in accordance with some embodiments of the technology described herein.

FIG. 10A illustrates a construction product category group and mappings between construction product categories in the group and a configurable computational pipeline to be used for creating product designs with products falling in the construction product category group, in accordance with some embodiments of the technology described herein.

FIG. 10B illustrates a mapping between construction product categories in different construction product category groups and multiple configurable computational pipelines-one per construction product category group, in accordance with some embodiments the technology described herein.

FIG. 10C illustrates aspects of an example construction product mapping module for mapping multiple construction products to a configurable computational pipeline, in accordance with some embodiments of the technology described herein.

FIG. 10D illustrates a pipeline configuration module part of the construction product mapping module illustrated in FIG. 10C, in accordance with some embodiments of the technology described herein.

FIG. 10E illustrates an example of a pipeline configuration module for mapping code portions associated with an example product category to a configurable computational pipeline, in accordance with the construction product mapping module shown in FIG. 10D.

FIG. 10F illustrates an example mapping between product categories and configurable computational pipelines, in accordance with some embodiments of the technology described herein.

FIG. 11 is a flowchart of an illustrative process 1100 for evaluating use of one or more construction products in a construction project, in accordance with some embodiments of the technology described herein.

FIG. 12A illustrates examples of code portions for processing interfaces and models 1200, in accordance with some embodiments of the technology described herein.

FIG. 12B illustrates examples of code portions for doing processes in connection with a construction plan 1218, in accordance with some embodiments of the technology described herein.

FIG. 12C illustrates model and operation code portions associated with mapping products to a construction model, in accordance with some embodiments of the technology described herein.

FIG. 12D illustrates strategies 1242 and post/pre operations 1243 associated with mapping products to a construction model, in accordance with some embodiments of the technology described herein.

FIG. 13A illustrates an example of a configurable computational pipeline, in accordance with some embodiments of the technology described herein.

FIG. 13B illustrates a second example of a configurable computation pipeline, in accordance with some embodiments of the technology described herein.

FIG. 14 is a flowchart of an illustrative process 1400 for registering one or more construction products with a construction software platform, in accordance with some embodiments of the technology described herein.

FIG. 15A illustrates an example of a GUI 1500 for registering a product with a construction software platform, in accordance with some embodiments of the technology described herein.

FIG. 15B illustrates an example of a GUI 1518 for modifying the product details associated with the product registered in FIG. 15A.

FIG. 15C illustrates an example of a GUI 1534 for editing product attributes for a registered product on a construction software platform, in accordance with some embodiments of the technology described herein.

FIG. 15D illustrates an example of a GUI 1546 for prompting a supplier to provide additional attribute inputs based on the category of the product, in accordance with some embodiments of the technology described herein.

FIG. 15E illustrates an example GUI 1566 for prompting a supplier to provide additional attribute inputs based on the category of the product, in accordance with some embodiments of the technology described herein.

FIG. 15F illustrates an example GUI 1574 for prompting a supplier to provide additional inputs based on the product category, in accordance with some embodiments of the technology described herein.

FIG. 16 is a block diagram of an illustrative computing system 1600 that may be used in implementing some embodiments of the technology described herein.

### DETAILED DESCRIPTION

As described above, prefabricated products and/or systems can be used in construction projects including offsite construction projects, where the prefabricated products and/or systems are assembled at one or more locations separate from a project build site, and onsite construction projects where they are assembled at the project build site. In offsite construction, use of prefabrication and assembly not only streamlines construction for certain types of construction components and assemblies, respectively, but also reduces the need to engage in complex construction and its management at the project build site. The use of offsite construction and/or prefabrication methods (whether onsite or offsite) expedites the rate of construction through the use of specialized facilities for constructing the respective building components. In addition, offsite construction methods have the added benefits of potentially lowering the cost of construction projects while offering a greater degree of specialization, as offsite construction facilities may utilize a wider variety of tools and construction methods then may be traditionally available on a construction site for assembling raw materials.

Notwithstanding the benefits of offsite construction, making use of offsite construction methods presents with a number of challenges in practice. It is helpful to consider such challenges from the perspective of a project designer (e.g., an architect, a builder, a designer of a build, and/or any other individual or entity) designing a construction project using at least some offsite construction as part of the project. There are numerous construction products available on the market that the project designer may wish to evaluate for potentially using as part of the project, including similar types of construction products provided by different suppliers. For example, there may be multiple insulated panel systems, multiple flooring systems, multiple roofing systems, etc., on the market and the project designer may wish to evaluate using some or all of them for potential use as part of the project. And such an evaluation is important because there may be significant differences among even similar types of construction products that materially impact the resulting design including, but not limited to, differences in: product cost, difficulty of assembly, availability and timing for delivery, size options available, possible modifications available, compatibility with other construction products part of the project, materials used in fabricating the products, environmental characteristics of the product, quantity of product required, and reliability of product suppliers. Moreover, different construction products are associated with specific rules and constraints for how they can be used as part of a design and, therefore, to actually include them as part of the design, ad hoc highly-customized software code has to be created (e.g., as part of a collaboration between a product supplier and the designer) in order to allow the designer to map that product onto their design (e.g., to layout a construction product, such as an insulated paneling system, in a building they are designing) and create a 3D model faithfully representing the design with the product so overlaid.

As a result, it is very difficult and highly-labor intensive and prohibitively time consuming for a project designer to evaluate even one construction product, let alone have the ability to meaningfully evaluate construction products provided by multiple suppliers. Therefore, in practice, designers are limited from being able to effectively compare the actual costs and potential impacts on a particular product on a project by lack of technology that enables: rigorous evaluation of a construction project in a construction project, optimization of how the construction product can be used in the construction project, and objective comparison of construction product alternatives with respect to quantity, cost, and other variables examples of which are described herein.

To address the foregoing challenges of using offsite construction, the inventors have developed a construction software platform that allows construction products to be registered with the platform, for example, by their suppliers. The construction software platform groups registered construction products into product categories, each of which is associated with a respective schema which specifies various attributes of the products in the category. Once the products are registered with the platform, a project designer can utilize the platform to evaluate one or more of the registered construction products as part of a construction project.

Accordingly, one benefit of the construction software platform developed by the inventors is that it provides a common environment in which different construction products provided by different suppliers can be reviewed and evaluated. Importantly, with respect to the evaluation, the construction software platform provides functionality to map construction products onto a project without requiring developers to write customized software code every time a new construction product is registered with the platform, which is a key improvement relative to the conventional approach of writing highly-customized software code for every product and every product supplier.

Multiple aspects of the construction software platform enable mapping products to projects without requiring custom code development. One aspect is that the inventors have developed product category schemas (already mentioned above) which standardize the way in which information about products in those categories is stored and made accessible to the construction software platform. The product category schemas allow for the specification of various types of information including product arrangement attributes, which specify information about how a construction product can be arranged as part of a product design (e.g., as part of a construction project). Another aspect is that the inventors have developed configurable computational pipelines associated with product categories (or groups of product categories) that can be dynamically configured based on information about a specific product to create, for the specific product, a software pipeline to map that specific product to a construction project. In particular, in some embodiments, information stored in a schema for a product (e.g., the product arrangement attributes) may be used to dynamically configure a computational pipeline for mapping that product to a project.

These and many other aspects of the technology developed by the inventors is described herein. It should be appreciated that the technology described herein can be applied to any suitable construction project (whether offsite or onsite) and, for example, to any construction projects involving assembly of prefabricated parts and/or products.

Aspects of Registering Construction Products with a Construction Software Platform

As described herein, the inventors have developed a construction software platform that allows one or more construction products to be registered with the platform. The registered products, in turn, may be evaluated by other users (e.g., project designers) of the platform.

Accordingly, some embodiments provide for a technique for registering one or more construction products with a construction software platform. The technique includes: (A) obtaining, via at graphical user interface (e.g. a GUI generated by the construction software platform), information about a first construction product to be registered with the construction software platform, the information indicating a first construction product category for the first construction product; (B) obtaining a schema associated with the first construction product category (see e.g., a category schema for the SIPs product category shown in Table 1), the schema specifying multiple input attributes of products in the first construction product category; (C) requesting, via the graphical user interface, input specifying first construction product values for one or more of the multiple input attributes (e.g., such that the information requested is based in part on information for filling in values of one or more attributes specified in the schema); (D) receiving, via the graphical user interface, information specifying at least some (e.g., all) of the values requested at (C); (E) generating, using the information obtained at (A) and (D), a schema instance of the schema for the first construction product, the schema instance specifying values of at least some (e.g., all) of the multiple input attributes for the first construction product; and (F) storing, in a schema datastore, the schema instance generated for the first construction product in association with an identifier of the first construction product. In this way, schema instances may be generated for products registered with the construction software platform and stored for subsequent use (e.g., during evaluation of one or more of these products in a construction project).

A product category schema may have input attributes and output attributes. Examples of such attributes are provided herein. For example, in some embodiments, the multiple input attributes include one or more input attributes selected from the group consisting of: one or more product dimension attributes (e.g., width, height, length, thickness, ranges thereof, etc.), one or more product component attributes (e.g., one or more constituent materials), one or more product arrangement attributes, one or more product pricing attributes (e.g., cost of overall product, cost of modified version of product, cost of product component, etc.), one or more product quantity attributes (e.g., number of product instances used in a design), one or more product environmental attributes (e.g., whether a product include carbon, amount of carbon used to produce the product, etc.), one or more product performance attributes (e.g., sound/thermal insulation/transmittance values, fire resistance, heat/electric energy consumption/requirement, etc.), and/or one or more product material attributes (e.g., color, finish, material, texture, transparency, etc.). As such, (D) may include receiving information specifying values of at least some (e.g., all) of these input attributes.

As described herein, values of a product's, “product arrangement” attributes may be used for configuring a computational pipeline to yield software for mapping the product to a construction project. The product arrangement attributes specify information about how a construction project can be arranged as part of a product design. A product arrangement attribute may specify a value for how to handle an aspect of laying out one or more instances of the product in a product arrangement (e.g., relative to one or more other product instances, other products in the construction design, relative to the product itself). In turn, such a value may correspond to a pre-existing piece of software code (a “code portion”) that can be used to generate a product arrangement from one or more instances of the product in accordance with the layout strategy specified by the product arrangement attribute.

It should be appreciated that a “code portion” may be pre-existing in some embodiments or, in other embodiments, dynamically generated, for example, by using large language models and/or any other suitable code generation technology. For example, in some embodiments, a “code portion” may be generated by combining (e.g., using a directed acyclic graph) multiple portions of pre-existing code to form a new code portion. As another example, in some embodiments, a “code portion” may be generated (with or without using already existing code). A large language model may be used to facilitate generating code in both of these examples. More generally, the software programs and code portions referred to herein may be pre-existing, dynamically generated, or in part pre-existing and in part dynamically generated, as aspects of the technology described herein do not depend on when the software programs and/or code portions are created.

For example, the product arrangement attributes may include a “corner handling” attribute, which can take on values each specifying how corners are to be handled for the product when generating a product design from the product (e.g., how to handle geometry of insulated panels when they form a corner). Each such value of the “corner handling” attribute may correspond to a pre-existing or dynamically generated piece of software code that can be used to generate a product arrangement from multiple instances of the product (e.g., how to layout multiple insulated panels) in accordance with the layout strategy specified by the corner handling attribute.

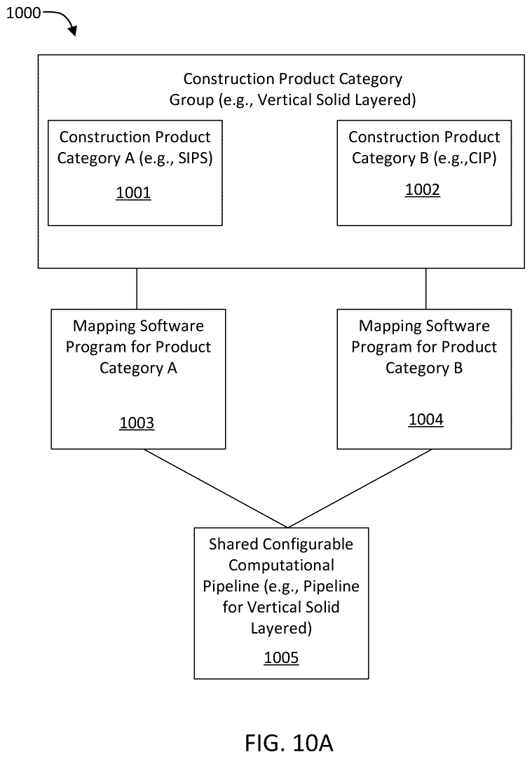

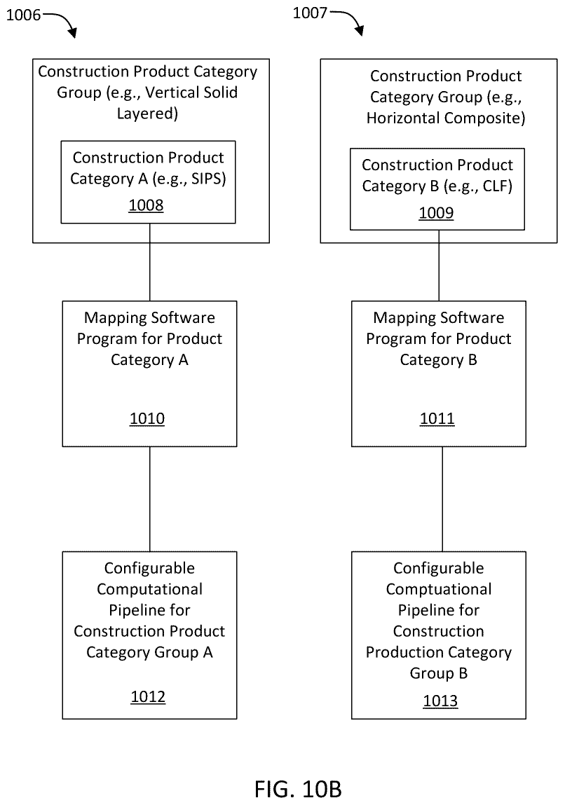

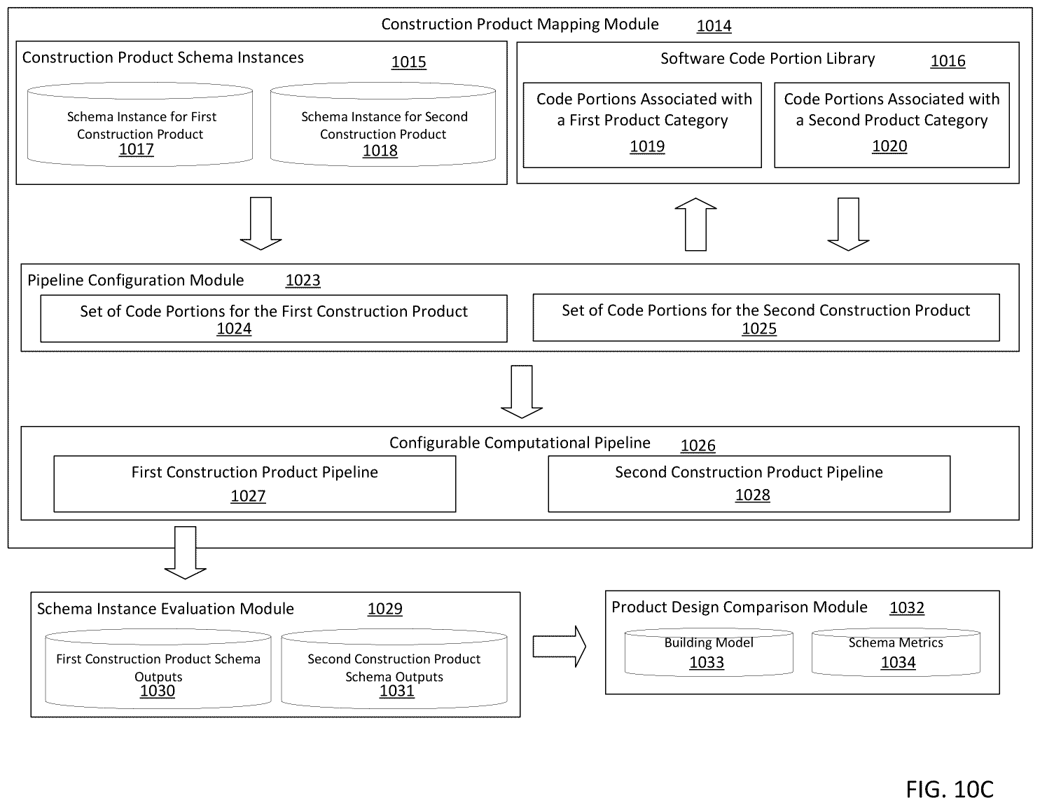

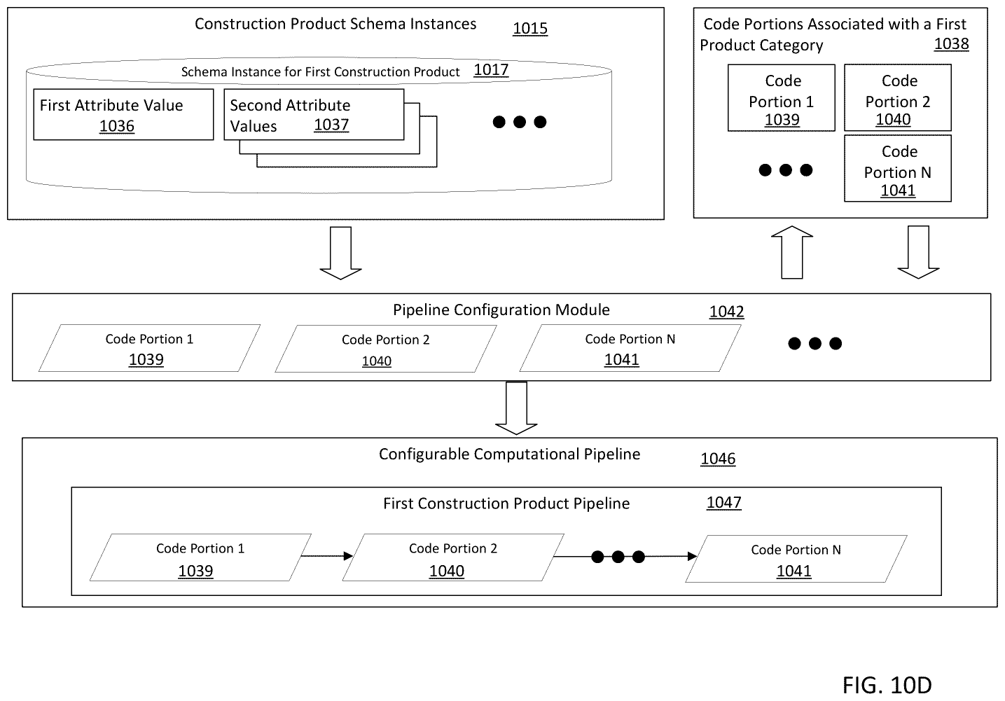

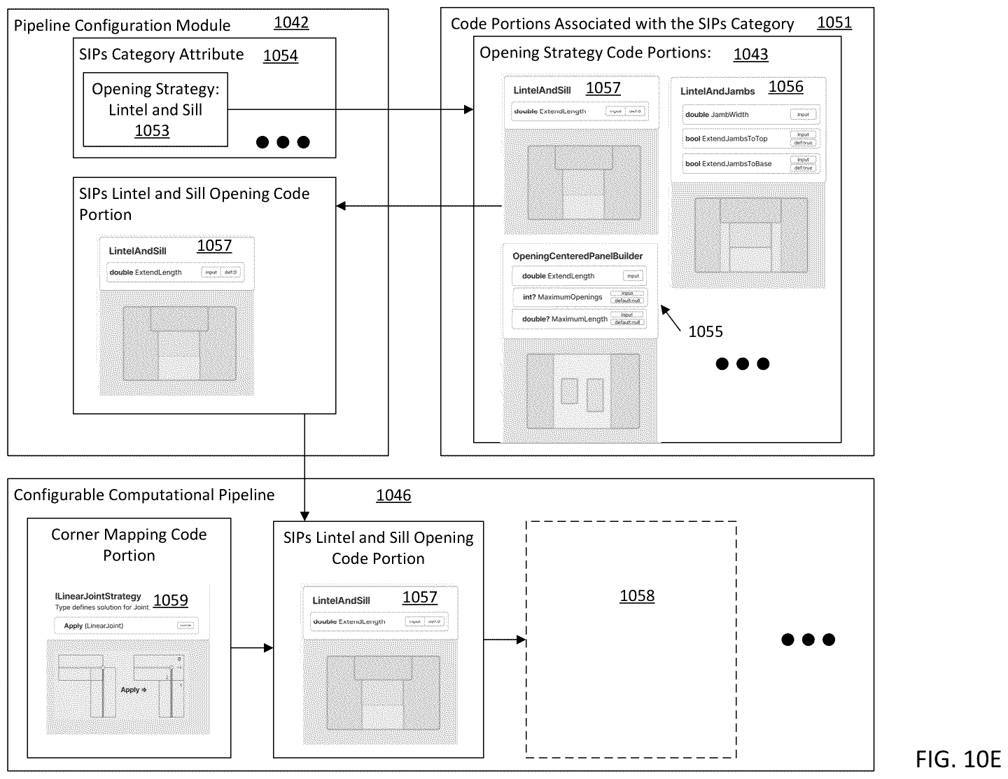

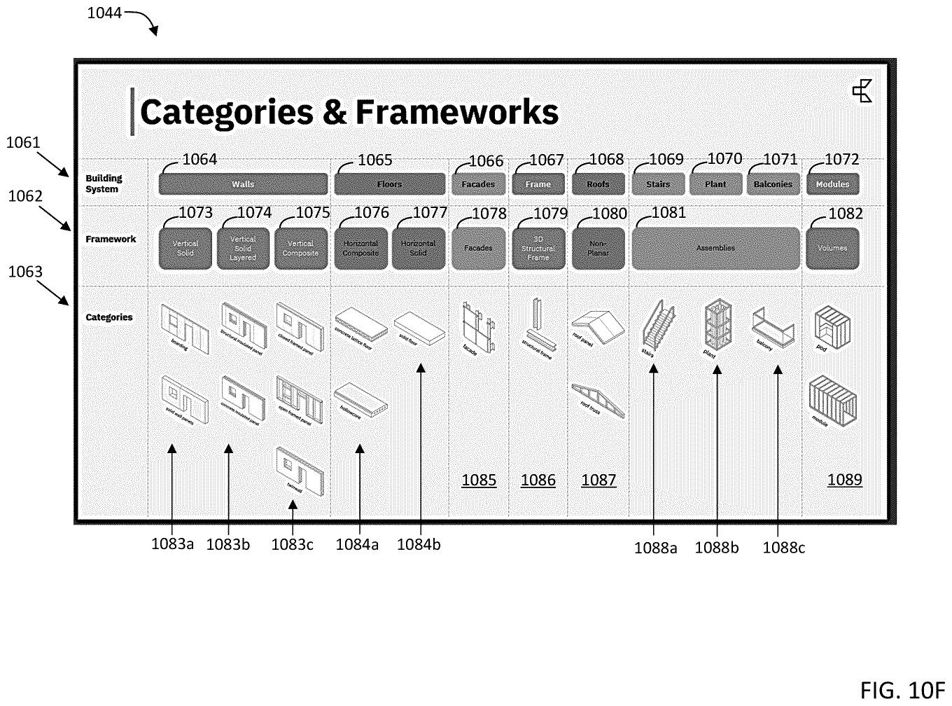

As another example, the product arrangement attributes may include an “opening handling” attribute whose value indicates different strategies for creating an opening in a product (e.g., an opening in a structure insulated panel). Each such value of the “opening handling attribute” may correspond to a pre-existing or dynamically generated piece of software code (a code portion) that can be used to generate a product arrangement from one or more instances of the product (e.g., how to create an opening in an arrangement of one or more insulated panels) in accordance with the layout strategy specified by the opening handling attribute. In this example, the construction software platform may include code portions for different opening strategies including, for example as described with reference to FIG. 10E, a code portion for creating an opening using an opening centered panel builder, a code portion for creating an opening using a lintel and jambs, and a code portion for creating an opening using a lintel and sill.

Examples of product arrangement attributes include, but are not limited to, a design handling attribute, a corner handling attribute, an opening handling attribute, a horizontal connection attribute, a vertical connection attribute, a base connection attribute, a vertical alignment attribute, and a horizontal alignment attribute, an adjacency constraint attribute, a patterning strategy attribute, a layer build up attribute, a directional layout attribute, an interface strategy attribute, a perimeter framing attribute, a zone region framing attribute, an opening framing attribute, a hollow zone attribute, a variable space sizing attribute, an edge treatment attribute, and an edge cut attribute.

As described herein, products may be grouped into product categories and information for individual products may be gathered during registration using a product category schema. Examples of constructions product categories include, but are not limited to, boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, and whole-building system.

### Mapping Products to Construction Projects

Construction products registered with the construction software platform may be added to a construction project by a user of the software platform (e.g., a project designer) so that the user may evaluate the construction product within the project and/or compare the construction product with one or more alternative construction products.

Accordingly, in some embodiments, the construction software platform may be used to perform: (A) obtaining an initial construction project model for the construction project (e.g., obtaining one or more files specifying a model for the project including spatial elements, materials, and/or shapes); (B) obtaining a selection of a first construction product for evaluating its use in the construction project, the first construction product being in a first construction project category (e.g., by receiving, via a GUI, a selection of the first construction product category; presenting, via the GUI a listing of the one or more construction products in the first construction product category including the first construction product; receiving, via the GUI, the selection of the first construction product); (C) identifying, using the first construction product category, a first mapping software program for mapping the first construction product to the initial construction project model; (D) executing the first mapping software program to map the first construction product to the initial construction project model to obtain an updated construction project model (e.g., a three-dimensional (3D) model including the initial construction project model and one or more instances of the first construction product arranged thereon); and (E) outputting the updated construction project model.

In some embodiments, obtaining an initial construction project model comprises obtaining one or more files specifying the model. The file(s) may be in any suitable format, as aspects of the technology described herein are not limited in this respect. For example, obtaining the initial construction project model may comprise obtaining a model file selected from the group consisting of an Industry Foundation Classes (IFC) model file, a Revit (RVT) file, an RFA file, a STEP file, a DWG file, a JSON file, and/or a drawing exchange format (DXF) file. Additionally or alternatively, a model file or specification can be obtained from one or more data sources such as, for example, GeoJSON, TESTFIT, AUTODESK FORMA, and AUTODESK DESIGN EXCHANGE. Additionally or alternatively, a model file or specification can be obtained from an Autodesk Construction Cloud. These are illustrative and non-limiting examples of model files. In some embodiments, a model may be specified using one or more files, but in other embodiments, there may not be any file involved and data organized in another way (e.g., full or partial data obtained via an integration or API or data stream) may specify a model. Alternatively, a combination of data (not in files) and files may be used to specify a model, as aspects of the technology described herein are not limited in this respect.

In some embodiments, outputting the updated construction product model comprises outputting the 3D model of the initial construction project model with the product design arranged thereon. The 3D model may be output in any suitable 3D format including, but not limited to, IFC, GLB, GLTE, DWG, DXF, STEP, OBJ, STL, GEOJSON, and JSON. These are illustrative and non-limiting examples of 3D models. An output model may be specified in one file, multiple files, directly in one or more databases, etc. In some embodiments, the updated construction product model is not limited to being a 3D model and may, for example, include construction project data without geometry or vice versa.

In some embodiments, the GUI may be an interface presented to a user via an Internet browser application or an application program executing on a device of the user.

As described herein, the mapping software to be used for mapping a particular construction product to a construction project model may be selected based on the construction product category in which the particular product construction product falls or on the particular construction product itself. Accordingly, in some embodiments, the construction software platform comprises multiple mapping software programs each of the multiple mapping software programs for mapping construction products in a respective construction product category to construction project models and being stored in association with information identifying the respective construction product category or product. And, in some embodiments, identifying the first mapping software program comprises selecting, as the first mapping software program and from among the multiple mapping software programs, a mapping software program that is stored in association with information identifying the first construction product category or product.

In some embodiments, the act of executing the first mapping software program to map the first construction product to the initial construction project model comprises: generating a product design comprising an arrangement of one or more instances of the first construction product with respect to the initial construction project model. The product design may specify positioning of the one or more instances (e.g., individual panels) of the first construction product (e.g., an insulated panel) with respect to one another (e.g., how insulated panels are arranged relative to one another) and/or with respect to the initial construction project model (e.g., how insulated panels are arranged relative to the building or other parts such as flooring, etc.). The product design may specify the types of product instances used, their orientation and/or size, patterns of their layout, any aspect of their geometry, and the like.

In some embodiments, the product arrangement generated by the mapping software may reflect one or more product design rules, which may be encoded in an instance of the product category schema for the product being mapped. As such, the design rules may be reflected in values of attributes in the schema instances. The design rules may indicate various how product instances may be arranged including, but not limited to, sizes of the construction product instances (e.g., sizes of the panels used), types of the construction product instances (e.g., whether standard, bespoke, jamb, lintel, sill, infill, or other type of panel is used), corner junctions in the product (e.g., overlap, gap, post, l-shaped), openings (e.g., openings in walls, which may be resolved in various ways such as lintel & sill, custom panel, lintel over panels, lintel over jambs, lintel & sill & jambs, supported lintel & short jambs, full height jambs, centered lintel, etc.), vertical and/or horizontal connections (e.g., between panels) which can be of many types (e.g., male/female, tongue/groove, recessed, single spline, double spline, i-joist spline, none, external connectors, in-face connectors, etc.), base connections (e.g., which in the case of panels may be resolved as single base plate, double base plate, bespoke base rail, plinth and base plate, etc.), vertical divisions (which may vary over no joint, alternate joint, continuous joint, etc.), vertical alignment (e.g., no alignment, strict alignment, flexible alignment), adjacency rules and/or placement patterns (e.g., certain types of panels can or cannot be placed next to others, type A must/cannot be placed next to type B, patterns such as after types A-B-A, place type C, etc.), build-up of material layers (e.g., such as having/omitting a topping layer, assigning type of layer, for example, solid, hollowed, lattice, profile, pre-tensioned, deck profile, etc.), and directionality of product layout (e.g., unidirectional, bidirectional, multidirectional, radial, with perimeter, etc.).

It should be appreciated that the construction software platform can map multiple construction products to a project (e.g., to an initial construction product model) at a time; it is not limited to evaluating only one product at a time. Accordingly, in some embodiments, the techniques further involve obtaining (e.g., through the GUI) a selection of a second construction product for evaluating its use in the construction project, the second construction product being in a second construction project category; and identifying, using the second construction product category or the second construction product d mapping software program, different from the first mapping software program, for mapping the second construction product to the initial construction project model, wherein the executing comprises executing the first mapping software program to map the first construction product to the initial construction project model and the second mapping software program to map the second construction product to the initial construction project model to obtain the updated construction project model.

The construction products may be mapped iteratively or concurrently. As such, a first product can be mapped to the initial construction project model to get an updated construction project model and a second product can be mapped to the updated construction project model to get a further updated construction project model. Alternatively, both the first and second products can be mapped to the initial construction project model to update the updated construction project model, as aspects of the technology described herein are not limited in this respect.

Various aspects of the first construction product may be represented as attribute values in a schema instance for the first construction product, with the schema instance being an instance of a product category schema for the product category to which the first construction product belongs. The schema may include attributes shared by construction products in the construction product category. The mapping software may use values of at least some of the attributes in the schema instance to map the first construction product to the construction project (e.g., the initial construction project model). If any of these values are modified, the product may be remapped.

In some embodiments, the first construction product category is associated with a configurable computational pipeline, and wherein executing the first mapping software program comprises: (a) identifying, using at least some of the values of the at least some attributes (e.g., product arrangement attributes) for the first construction product as specified in the schema instance, a first set of one or more software code portions to use for mapping the first construction product to the initial construction project model; (b) configuring the first configurable computational pipeline to use the first set of one or more software code portions; and (c) executing the first configurable computational pipeline to obtain the updated construction project model.

### Optimization

A construction product can vary in a number of ways. For example, a construction product may be manufactured in different sizes (e.g., different lengths, widths, heights, thickness, etc.). A construction product may be made using different types of materials. A construction product may be configured to connect to other construction products in different ways. A supplier of the construction product may provide information about the different versions of the construction product that the supplier can provide (e.g., manufacture) and the associated costs. In some embodiments, these variations may be specified in a schema instance for the construction product upon registration of the construction product with the construction software platform. When this product is being considered by a project designer for a project, depending on the choices available, a particular selection with respect to a characteristic of the product made by the project designer may lead to a respective particular design with its own associated costs and other parameters (time to manufacture, implications on other product selections, environmental characteristics of resulting design, etc.).

The construction software platform developed by the inventors facilitates evaluating such different construction product options and, for example, comparing them to one another. In particular, the platform allows a project designer to select one or more construction product attributes (e.g., length, width, material type, etc.) and one or more objectives (e.g., cost, quantity of product, etc.) and performs an optimization to identify one or more product designs across the selected construction product attribute(s) with respect to the specified objective(s). One or more evaluated (e.g., top) designs may be presented and/or compared.

The category product schema guides and facilitates implementation of this process in the construction software platform. In particular, in some embodiments, the project designer can select any of multiple input attributes—in the category schema instance for the product being evaluated—that can take on different values and have the construction software platform optimize over the selected attributes with respect to one or more designer selected objectives (which may be one or more output attributes specified by the schema instance). As the product supplier can specify ranges of possible values for product attributes (e.g., ranges of lengths, list of different materials, etc.) through the category schema, those specified ranges can be explored (e.g., “sampled”) using optimization techniques implemented as part of the construction software platform developed by the inventors.

Accordingly, some embodiments provide for optimization techniques to evaluate use of one or more construction products in a construction project, the one or more construction products including a first construction product in a first construction product category. The method including, using at least one computer hardware processor to perform: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including; for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product (e.g., presenting, via a GUI, a listing of at least some of the one or more of the multiple input attributes, and receiving, via the GUI, the selection of the at least one of the one or more of the multiple input attributes over whose possible values to optimize use of the first construction product); at least one of the multiple output attributes to serve as at least one objective with respect to which to optimize the use of the first construction product; (C) identifying one or more product designs, using an optimization technique (e.g., a multi-objective optimization technique) and a first mapping software program for mapping the first construction product to a construction project model, to evaluate use of the first construction product over values of the selected input attributes with respect to the at least one objective defined using the selected at least one output attribute; and (D) outputting information about the identified one or more product designs (e.g., outputting values of one or more of the output attributes determined for each of the one or more product designs so that the product designs may be compared and/or otherwise evaluated).

In some embodiments, the multiple input attributes include one or more attributes selected from the group consisting of: one or more product dimension attributes, one or more product component attributes, one or more product arrangement attributes, one or more product pricing attributes, one or more product quantity attributes, one or more product environmental attributes, one or more product performance attributes, one or more product material attributes.

In some embodiments, the multiple output attributes include one or more attributes selected from the group consisting of: one or more attributes indicating quantity of product instances used in product design pricing attributes, one or more attributes indicating cost of materials used in product design.

In some embodiments, the multiple input attributes include a first input attribute, and the schema instance specifies at least one continuous range of possible values for the first input attribute. In some embodiments, the multiple input attributes include a first input attribute, and the schema instance specifies a discrete set of possible values for the first input attribute.

In some embodiments, presenting and receiving attributes through the GUI further includes, presenting, via the GUI, a listing of at least some of the multiple output attributes; and receiving, via the GUI, the selection of the at least one of the multiple output attributes to serve as the at least one objective with respect to which to optimize the use of the first construction product, receiving, via the graphical user interface, the selection of the at least one of the multiple output attributes to serve as the at least one objective with respect to which to optimize the use of the first construction product.

In some embodiments, the multi-objective optimization technique may be a multi-objective genetic optimization technique. For example, the multi-objective genetic optimization technique may be a non-dominated sorting genetic algorithm (NSGA), a generalized differential evolution (GDE) algorithm, or a multi-objective evolutionary algorithm based on decomposition (MOEA/D) algorithm, which are described herein.

In some embodiments, identifying one or more product designs described in (C) further includes: generating P populations of input values, each of the P populations of input values specifying an initial set of input values for the selected input attributes, wherein P is an integer greater than 1 that represents the number of the populations; generating multiple product designs by, for each particular population of the P populations, executing the first mapping software program configured with the particular population of the input values to obtain a respective product design; scoring the generated multiple product designs using the at least one objective with respect to which to optimize use of the first construction product to obtain a plurality of scores; and generating a new set of P populations of input values from the P populations of input values and the plurality of scores.

### Configurable Computational Pipelines

As described herein, the inventors have developed configurable computational pipelines associated with product categories (or groups of product categories) that can be dynamically configured based on information about a specific product to create, for the specific product, a software pipeline to map that specific product to a construction project. In some embodiments, information stored in a schema for a product (e.g., the product arrangement attributes) may be used to dynamically configure a computational pipeline for mapping that product to a project.

Accordingly, some embodiments provide for a method for evaluating use of one or more construction products in a construction project, the one or more construction products including a first construction product in a first construction product category. The method includes: (A) obtaining a first schema instance of a first schema associated with the first construction product category, the first schema comprising attributes shared by construction products (e.g., the construction products belonging to construction product categories) in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping including: (i) identifying, using the one or more values for the one or more product arrangement attributes specified by the first schema instance, a first set of one or more software code portions to use for mapping the first construction product to the initial construction project model; (ii) configuring the first configurable computational pipeline to use the first set of one or more software code portions; and (iii) executing the first configurable computational pipeline to obtain the updated construction project model; and (C) outputting the updated construction project model. In some embodiments, a configurable computational pipeline may specify a (full or partial) order in which software code portions may execute. For example, a configurable computational pipeline may specify a linear sequence in which the software code portions may execute or a partial ordering by using a directed acyclic graph (DAG) data structure.

In some embodiments, the construction product categories belong to construction product category groups, and each of the construction product category groups is associated with a respective configurable computational pipeline for mapping construction products in the construction products category group to construction project models. In some embodiments, the construction product category groups include a first construction product category group associated with the first configurable computational pipeline, where the first construction product category group includes the first construction product category and a second construction product category, the second construction product category including a second construction product, the method further including: (a) obtaining a second schema instance of a second schema associated with the second construction product category, the second schema comprising second attributes shared by construction products in the second construction product category, the second schema instance specifying values of at least some of the second attributes for the second construction product including one or more values for one or more product arrangement attributes; (b) mapping the second construction product to the initial construction project model by using a second mapping software program comprising the first configurable computational pipeline associated with the first construction product category group, the mapping including: (i) identifying, using the one or more values for the one or more product arrangement attributes specified by the second schema instance, a second set of one or more software code portions to use for mapping the second construction product to the initial construction project model, wherein the second set of one or more software code portions includes at least one software code portion not in the first set of one or more software code portions; (ii) configuring the first configurable computational pipeline to use the second set of one or more software code portions; and (iii) executing the first configurable computational pipeline.

In some embodiments, the construction product category groups includes: a first construction product category group associated with the first configurable computational pipeline; and a second construction product category group associated with a second configurable computational pipeline different from the first configurable computational pipeline. In some embodiments, where the second construction product category group includes a second construction product category, wherein the second construction product category includes a second construction product, where the method further includes obtaining a second schema instance of a second schema associated with the second construction product category, the second schema comprising second attributes shared by construction products in the second construction product category, the second schema instance specifying values of at least some of the second attributes for the second construction product including one or more values for one or more product arrangement attributes, and where mapping the first construction product to an initial construction project model described above in (B), includes mapping the first construction product and the second construction product to the initial construction project model to obtain an updated construction project model by using the first mapping software program which comprises the first configurable computational pipeline and a second mapping software program which comprises the second configurable computational pipeline, the mapping including: (i) identifying, using the one or more values for the one or more product arrangement attributes specified by the second schema instance, a second set of one or more software code portions to use for mapping the second construction product to the initial construction project model; (ii) configuring the second configurable computational pipeline to use the second set of one or more software code portions; and (iii) executing the second configurable computational pipeline.

In some embodiments, the first schema instance specifying the one or more values for the one or more product arrangement attributes selected from the group consisting of a design handling attribute, a corner handling attribute, an opening handling attribute, a horizontal connection attribute, a vertical connection attribute, a base connection attribute, a vertical alignment attribute, and a horizontal alignment attribute.

In some embodiments, the first construction product category is selected from the group consisting of: boarding, solid wall panels, structural insulated panels, concrete insulated panels, closed framed panels, open framed panels, twin wall, concrete lattice floor, hollow core, solid floor, façade, structural frame, roof panel, roof truss, stairs, plant, balcony, pod, and module.

As described herein, a configurable computational pipeline may partially or fully specify an order in which the different software code portions in the pipeline may execute. In some embodiments, the pipeline may specify that order using a directed acyclic graph (DAG), which ensures that the code portions are executed in an appropriate sequence (taking into account any dependencies between the portions), but also which provides the flexibility of allowing at least some of the software code portions to execute in parallel.

Relatedly, a different directed acyclic graph may be used to facilitate mapping multiple construction products to a construction project. When multiple products are selected to be mapped, the logic for mapping these products may be assembled into a computational graph that provides the flexibility to execute the mappings in parallel or have some depend on others, and/or add as many other products as desired.

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

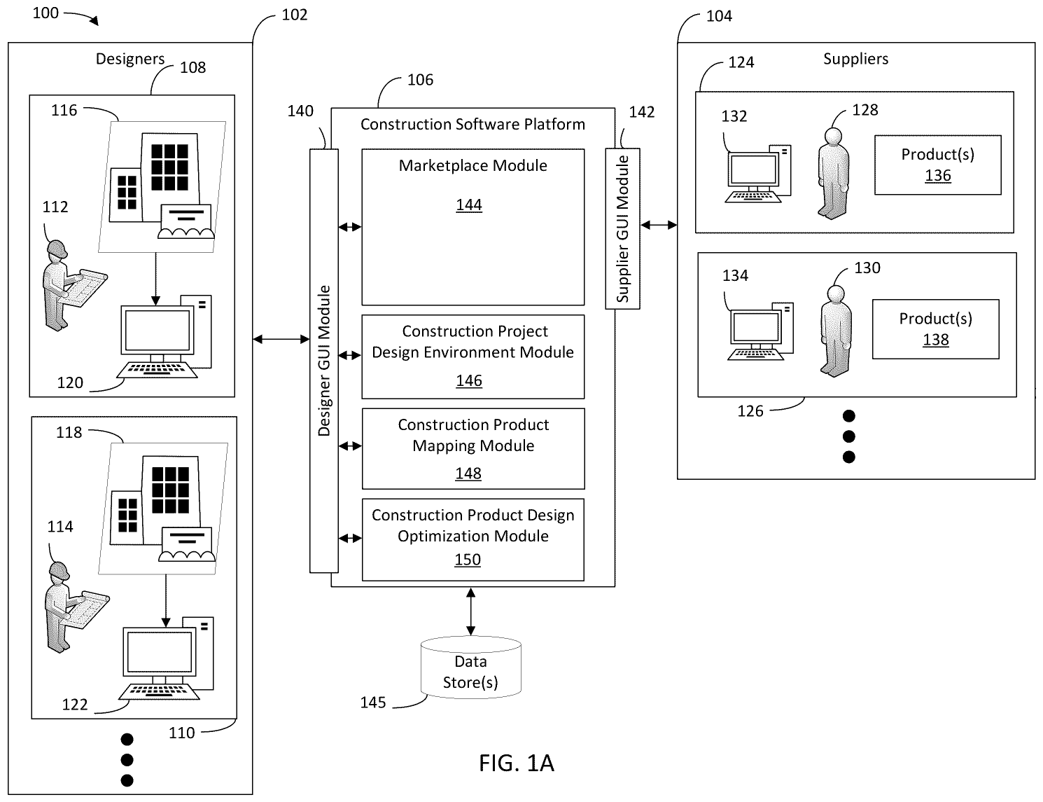

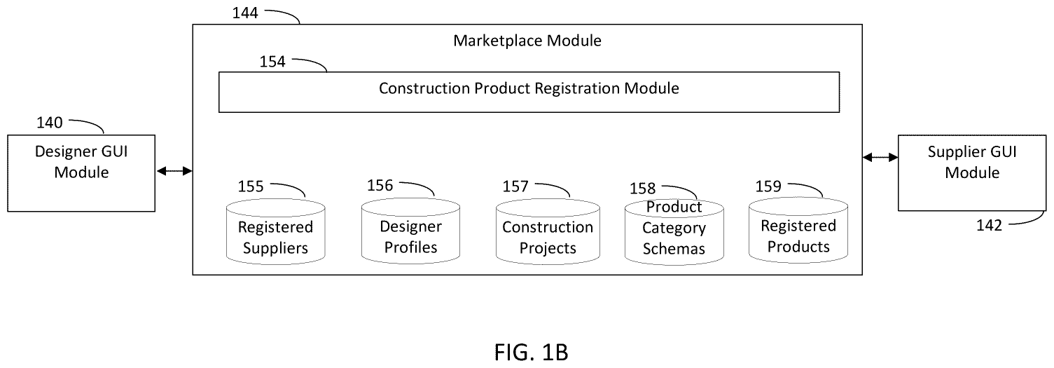

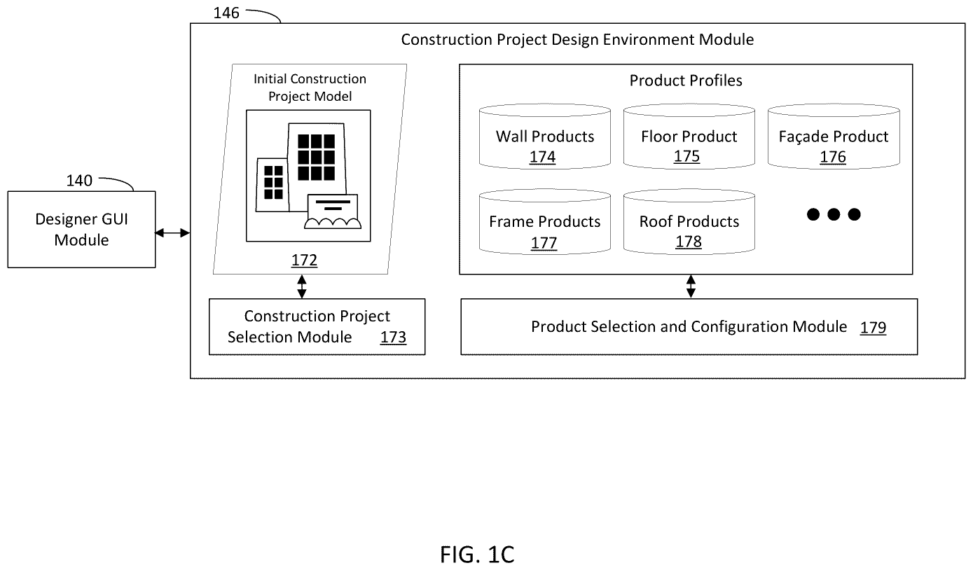

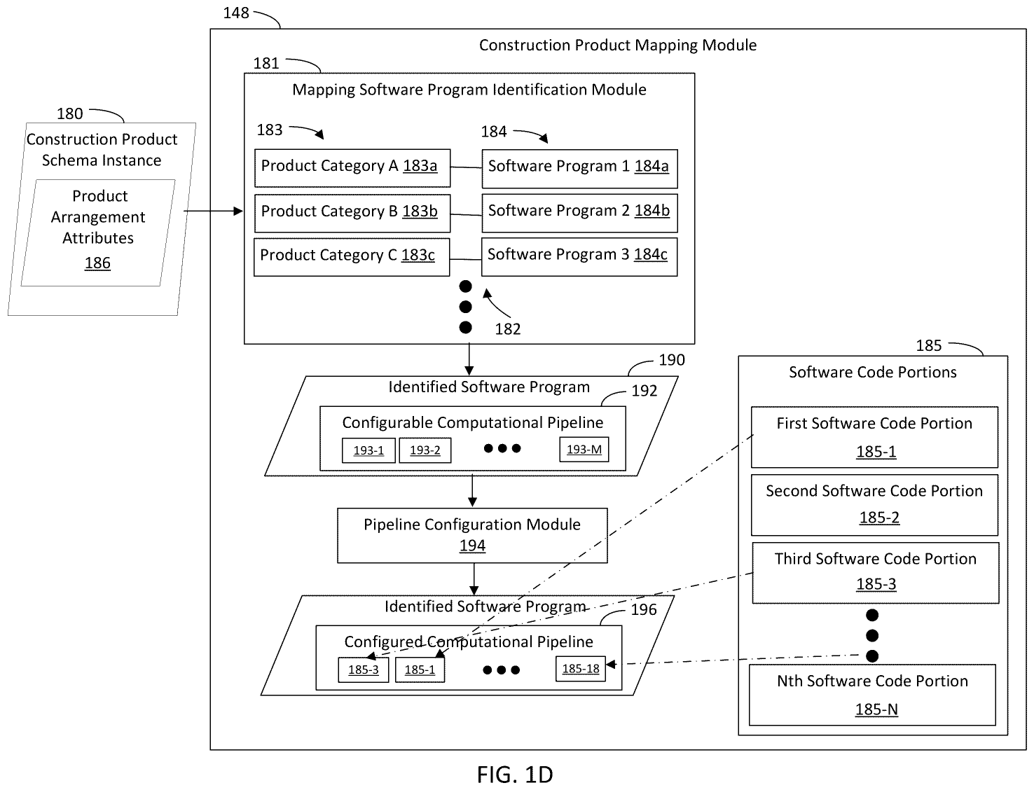

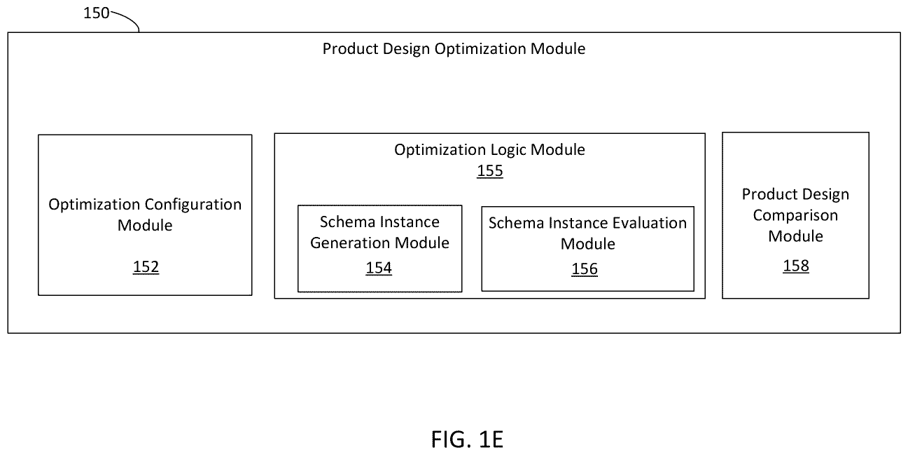

FIG. 1A is a block diagram of an illustrative construction software platform 106 and an environment 100 in which the illustrative construction software platform 106 may be used, in accordance with some embodiments of the technology described herein. As shown in FIG. 1A, construction software platform 106 includes designer GUI module 140, supplier GUI module 142, marketplace module 144, construction project design environment module 146, construction product mapping module 148, and construction product design optimization module 150. Each particular one of these modules (as well any other module described herein) contains processor executable instructions that, when executed by at least one computer hardware processor, cause the at least one computer hardware processor to perform the functionality described with respect to the particular module.

Additionally, the construction software platform 106 may store any suitable information (e.g., product category schemas and/or instances thereof, product schemas and/or instances thereof, code portions, configurable computational pipelines, supplier information, designer information, construction projects, etc.) in data store(s) 145, which may include one or more datastores of any suitable type (e.g., one or more databases of any suitable type, one or more files, one or more cloud storage instances, etc.). Data stores(s) 145 may include any of the data stores shown in FIGS. 1A-1E.

As shown in FIG. 1A, one or more suppliers 104 may register one or more construction products with the construction software platform 106. To this end, suppliers may provide information about their products to the construction software platform 106 through one or more interfaces and, for example, via one or more graphical user interfaces which may be generated by construction software platform 106 and presented to the suppliers. In turn, the suppliers may input information about their construction products into the generated GUI(s). For example, in some embodiments, supplier GUI module 142 may generate one or more graphical user interfaces through which suppliers can provide information about their products. In the example of FIG. 1A, suppliers 124 and 126 may wish to register their construction product(s) 136 and 136 with the platform. To this end, a user 128 (at supplier 124) may register product(s) 136 by using computing device 132 to access one or more GUIs generated by supplier GUI module 142 and provide information about the product(s) 136 through the GUIs. Similarly, a user 130 (at supplier 126) may register product(s) 138 by using computing device 134 to access one or more GUIs generated by supplier GUI module 142 and provide information about the product(s) 138 through the GUIs. The GUIs may be presented to the users 128 and 130 via an Internet browser or another application program, for example. The information provided via the supplier GUI module 142 may be stored for subsequent use.

The construction software platform 106 may also be used by one or more project designers 102 to create one or more project designs. A project designer may interact with the construction software platform 106 using any suitable interface(s) and, for example, may interact with the construction software platform 106 using one or more GUIs generated by GUI module 140. For example, a project designer 112 at designer 108 may wish to evaluate one or more construction products to use in construction project 116 that project designer 112 is developing. The project designer may use computing device 120 to interact with construction software platform 106, via GUIs generated by designer GUI module 140, to upload an initial construction project model and use the construction project design environment provided by construction software platform 106 (with the code to generate such an environment part of construction project design environment module 146) to evaluate use one or more construction products (e.g., a construction product registered with platform 106 by one of the suppliers 104) in the construction project by using functionality provided by the platform 106 to map the construction product(s) onto the initial construction project model. Similarly, project designer 114 at designer 110 may wish to evaluate one or more construction products to use in construction project 118 that project designer 114 is developing. The project designer may use computing device 122 to interact with construction software platform 106, via Gus generated by designer GUI module 140, to upload an initial construction project model and use the construction project design environment provided by construction software platform 106 to evaluate use of one or more construction products in the construction project.

In some embodiments, the marketplace module 144 may be configured to allow one or more suppliers 104 to register one or more construction products. To this end, as shown in FIG. 1B, marketplace module 144 may include construction product registration module 154 that is configured to receive (e.g., via supplier GUI module 142) information about a construction product. In some embodiments, the construction product registration module 154 may be configured to gather information about a construction product being registered with the platform and may prompt a user (e.g., a user at a supplier) to provide certain information about the construction product.

For example, in some embodiments, during registration of a particular construction product, the construction product registration module 154 may receive information indicating a particular category for the particular construction product (e.g., in response to prompting a user to provide that information or otherwise). The construction product registration module 154 may access, in from among product category schemas 158, a product category schema for the particular category. The product category schema may include attributes shared by construction products in the particular category. The construction product registration module 154 may request (e.g., via a GUI generated by supplier GUI module 142) that the user registering the particular product identify one or more values for one or more respective attributes in the product category schema. As a result, the construction product registration module may be configured to collect information about a product based on attributes in the schema for the category into which the product falls.

Once the information about a product is collected that information may be stored for subsequent use. In some embodiments, information about a registered product may be stored as part of registered products datastore 159. That information may include attribute values provided for product category attributes in the category schema for the category in which the registered product falls. In some embodiments, the attribute values may be stored in a category schema instance for the product. Whereas a category schema for a category (see e.g., Table 1 for an example of a category schema for the SIPs category) specifies attributes shared by construction products in the category, a category schema instances specifies values for the attributes for a specific construction product in the category (see e.g., Table 2 for an example of a category schema instance for the SIPs category with attribute values filled in for a particular SIPs) product. Category schemas and category schema instances may be stored using any suitable data structure(s) and/or any suitable format, as aspects of the technology described herein are not limited in this respect. In some embodiments, the category schemas and category schema instances may be stored in JavaScript Object Notation (JSON) format. Further examples of information stored about a product are shown in Table 5 and Table 6.

Also, as shown in FIG. 1B, marketplace module 144 may be configured to collect information about suppliers, project designers, and construction projects created by one or more suppliers (e.g., providing a demonstration for how their construction product may be implemented as part of a construction project or design) and/or project designers (e.g., providing a demonstration of a design that the project designer has designed and/or can build).

In some embodiments, information about suppliers may be stored in registered suppliers datastore 155. Information about a supplier stored in datastore 155 may indicate one or more construction products offered by the supplier (e.g., this may allow project designers to search for/browse for construction products by supplier), reviews for the supplier, contact information for the supplier, and/or any other suitable information, as aspects of the technology described herein are not limited in this respect.

In some embodiments, information about project designers can be stored in designer profile datastore 156. Information about a project designer stored in datastore 156 may indicate one or more construction projects designed by the project designer, including information about construction products used in these construction projects, reviews for the designer, contact information for the designer, and/or any other suitable information, as aspects of the technology described herein are not limited in this respect.

In some embodiments, information about construction projects may be stored in construction projects datastore 157. One or more construction projects in the datastore 157 may be accessible only to the project designers working on the construction projects (e.g., they may be “private”). On the other hand, a project designer may indicate that the construction projects can be accessible by one or more others (e.g., one or more specific other individuals or more generally be accessible publicly). Thus, one or more constructions projects stored in datastore 157 may be accessible by multiple individuals and/or publicly.

A construction project stored in datastore 157 may include numerous types of information. For example, a construction project may include: an initial construction project model, an updated construction project model that reflects the incorporation of one or more construction product(s) incorporated into the construction project, information about any construction product(s) either incorporated into the construction project and/or evaluated for use as part of the construction project, alternative product designs that can be used as part of the construction project, information about manufacturing and/or assembling the project (e.g., cost, timelines, construction product(s) involved, detailed 3D CAD and/or other 3D models specifying the exact design to be manufactured and/or assembled, etc.), and/or any other suitable information, as aspects of the technology described herein are not limited in this respect.

Returning back to FIG. 1A, the construction project design environment module 146 may be configured to allow one or more project designers (and/or any other suitable type of user of construction platform 106) to evaluate use of one or more construction products in a construction project. To that end, as shown in FIG. 1C, module 146 may allow a project designer to select a construction project using construction project selection module 173, select one or more construction products to apply to the selected construction project using product selection and configuration module 179, optionally configure one or more of the selected construction products, and once the product(s) are selected (and, optionally, configured), request that the construction software platform map the selected construction product(s) to the construction project.

In some embodiments, a project designer may select a construction project using construction project selection module 173. This may be done in any suitable way. For example, the module 173 may allow the project designer to select a previously-created construction project that the project designer (or other designer) was working on. For example, the project designer may select a project from a list of construction projects. As another example, the module 173 may allow the project designer to create a new project and to load, into the new project, an initial construction project model 172. That initial construction project model 172 may be of any suitable type and format (e.g., an IFC file), examples of which are provided herein.

In some embodiments, a project designer may select one or more construction products to add to the construction project. In some embodiments, the project designer may select any construction product registered with the construction software platform 106. For example, the project designer may select from among registered wall product(s) 174, floor product(s), façade product(s), frame product(s) 177, and/or roof product(s) 178, by way of example and not limitation.

In some embodiments, a project designer may select one or multiple products to evaluate as part of a construction project. When selecting multiple products, at least some of the multiple products may be in different product categories (e.g., flooring and insulated panels), though it is possible to have two or more products be in the same product category. Selected products may be mapped to the initial construction project model to obtain an updated construction project model, in accordance with some embodiments. In some cases, all of the selected products are mapped together to the initial construction project model. For example, flooring and insulated paneling products are selected and mapped to the initial construction project model together such that the updated model includes both types of products. In other cases, only some of the selected products may be mapped to the initial construction project model at any one time. For example, two alternative flooring products may be selected by the project designer, and each of these flooring products may be mapped to the initial construction project model separately from one another. In turn, the project designer can evaluate the suitability of the two flooring products comparatively with respect to one another.

In some embodiments, a project designer may wish to evaluate one or more construction products more generally than in the context of a specific construction project model. Accordingly, in some embodiments, the construction software platform may provide the project designer with the ability to generate product designs using one or more selected construction product(s) and evaluate them but without mapping them to a 3D model representing the construction project. For example, a project designer may wish to explore and/or evaluate how various insulated panels may combine to create an overall design of walls. To that end, the project designer can select an insulated panel product and use the construction software platform to generate one or more product designs composed of insulated panels.

In some embodiments after one or more construction products are selected, the construction product mapping module 148 may be used to map the selected construction product(s) to the initial construction project model (e.g., initial construction project model 172 of FIG. 1C). Aspects of how this may be done, in some embodiments, are illustrated in FIG. 1D. In particular, FIG. 1D illustrates how a particular construction product P may be mapped to a construction project model.

FIG. 1D shows two aspects of how a construction product P may be mapped by construction product mapping module 148 to a construction project model. The first aspect is that the mapping is performed by product category-specific software. For example, different software programs may be used to map construction products in different product categories. Accordingly, in some embodiments, construction product mapping module 148 includes mapping software program identification module 181, which may be configured to use the product category for a particular product to identify the software program (e.g., the code to call to execute) that, when executed, maps that particular product to the construction project model.

For example, as shown in FIG. 1D, module 181 may include a mapping 182 between product categories 183 and software programs 184. In this example, mapping 182 maps product categories A, B, and C (183a, 183b, and 183c in FIG. 1D) to respective software programs 1, 2, and 3 (184a, 184b, and 184c in FIG. 1D). The mapping 182 may be stored in any suitable way and/or in any suitable format, as aspects of the technology described herein are not limited in this respect.

Thus, when a project designer selects a particular construction product in a product category, then the construction software platform 106 identifies, using the product category of the selected construction product and the mapping 182, the software program to use for mapping the selected construction product to the construction project model. In the illustrated example, that software program may be identified to be mapping software program 190.

In some embodiments, when products in different product categories are selected (e.g., a product in category A and a product in category B), then multiple software programs may be identified for mapping these products to the construction project model (e.g., software program 1 and software program 2) and executed to perform the mapping. When multiple products in the same underlying product category are chosen, the same software program may be selected to map each of them (though, as described herein, that same software program may be configured differently in each case prior to executing based on attribute values specific to the individual construction products selected).

In some embodiments, the identified software program selected may be fully configured and may be executed. For example, software code for mapping a particular construction may have been previously written and can simply be accessed and used. This may be the case, for example, when a particular construction product requires very specific and/or unique logic that may not apply in other circumstances and/or the code has already been developed. In such a situation, the identified software program selected may be executed and need not rely on the configurable computational pipeline technology described herein.

However, in other embodiments, the software identified for a construction product (based on the construction product category in which the product falls) may include a configurable computational pipeline associated with the product category (or a group of product categories that include the product category). For example, as shown in FIG. 1D, identified software program 190 may include configurable computational pipeline 192. That configurable computational pipeline may then be configured or adapted to the construction product based on values of certain category schema attributes for that construction product. This is the second aspect of how a product is mapped to a construction project model, as illustrated in FIG. 1D.

As described herein, in order to arrive at a scalable construction software platform, the inventors recognized that it is important to avoid having to write customized mapping code for every construction product registered with the platform. The inventors recognized that, while there are differences among individual construction products, products in a same product category have many similarities with respect to how they may be arranged within a product design. Accordingly, the inventors have developed a plurality of configurable computational pipelines that implement mapping logic for mapping products in product categories (or groups of product categories).

Accordingly, the construction software platform may store a respective configurable computational pipeline for each product category or group of product categories. When a particular product is to be mapped, the appropriate configurable computational pipeline is selected based on the category of the particular product and is subsequently configured based on attribute values of the particular product. A configurable computational pipeline may indicate a sequence of processing steps for mapping products in a particular category to the construction project model. The pipeline may be configurable in the sense that there may be multiple options for performing one or more of the steps in the sequence (or graph) of processing steps and the pipeline may be configured to use specific processing logic for each of one or more of the processing steps when applied to a particular product. As described herein, in some embodiments, the order of execution of acts part of the configurable computational pipeline may be specified in accordance with a graph, for example, a directed acyclic graph.

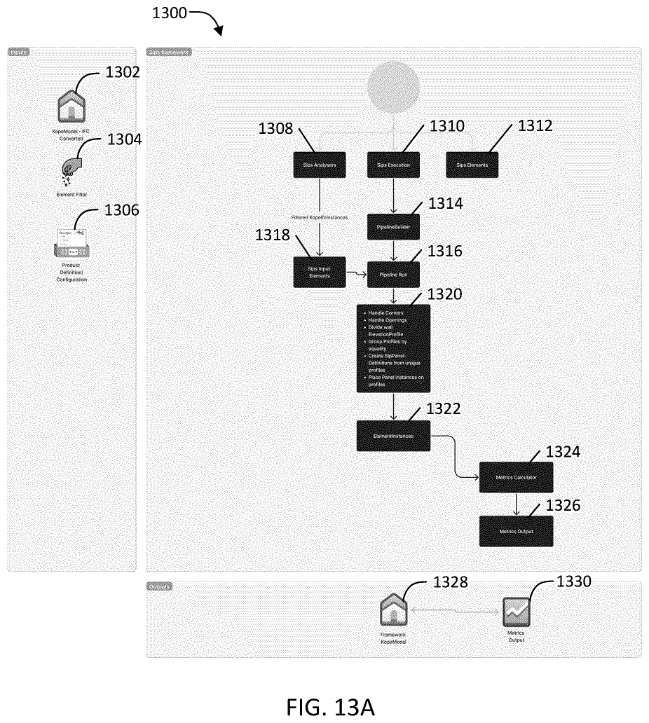

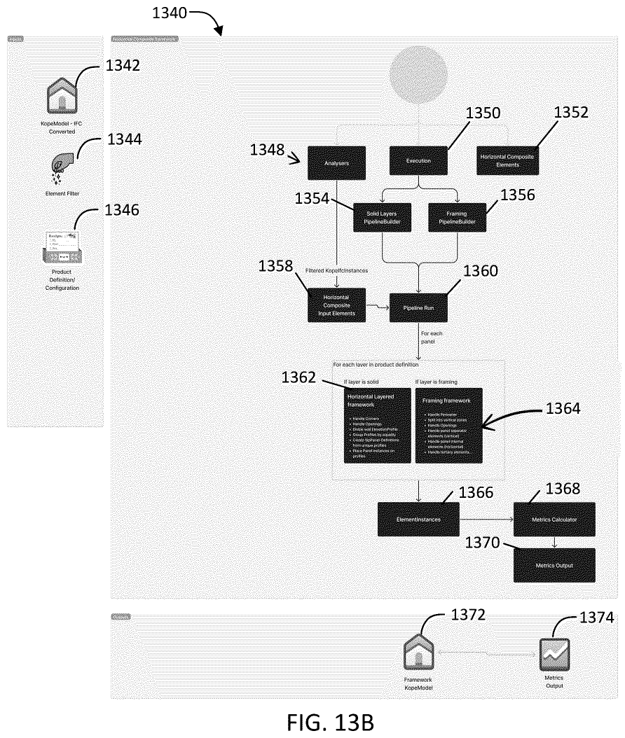

As one example, the construction software platform may store a configurable computational pipeline for mapping insulated panel products to construction project models (which may include both structured insulated panels and concrete insulated panels). In this example, when a project designer selects a structured insulated panel product, the software identified for mapping the product to a construction project model includes the configurable computational pipeline for mapping insulated panel products. In turn, the pipeline indicates a sequence of processing steps for mapping insulated panels to the construction project model and may be configured to use specific processing logic for each of one or more of the processing steps depending on the particular insulated panel product used. For example, the configurable computational pipeline may specify that, first, logic for handling panel corners is to be executed, then logic for handling openings is to be executed, then the walls in the project are to be divided according to elevation profiles, etc. (see e.g., the example of FIG. 13A). However, there may be a number of options for how each of the pipeline steps is to be performed. For example, there may be multiple ways in which corners could be handled and so the configurable computational pipeline may be configured to use a specific way to handle corners (e.g., in the way that is specified by the supplier of a particular insulated panel product).

Accordingly, in some embodiments, construction product mapping module 148 comprises pipeline configuration module 194 used for configuring configurable computational pipelines. A configurable computational pipeline may specify a sequence of steps to be performed and the module 194 may identify a piece of software code (which may be referred to as a “code portion” herein) to use for performing a particular step in the sequence. The module 194 may identify a code portion to use for performing a particular step in the sequence from among a repository of software code portion 185 (shown in FIG. 1D as including software code portions 185-1, 185-2, 185-3, . . . , and 185-N, where N is any suitable integer).

For example, in the illustrative example of FIG. 1D, identified software program 190 includes configurable computational pipeline 192 which specifies a sequence of steps as shown by the sequence of boxes 193-1, 193-2, . . . 193-M. The pipeline configuration module 194 may select code portion 185-3 to use for the step 193-1, code portion 185-1 to use for the step 193-2, and code portion 185-N to use for the step 185-18. Once these code portions are selected, the resulting configured computational pipeline 196 may be executed by the construction software platform.

Accordingly, in some embodiments, the pipeline configuration module 194 may configure a configurable computational pipeline (e.g., pipeline 192) to map a particular product to a construction project model. Module 194 may perform that configuration based on information about the product itself and, in particular, based values of one or more product arrangement attributes of the product in the category schema instance for this product.

In the example of FIG. 1D, the values of product arrangement attributes 186 (part of construction product schema instance 180) may be used by pipeline configuration module to determine which code portions are to be used to perform various steps as part of the configured computational pipeline 196. As a specific example, suppose that the software code portions 185 includes two different pieces of code (185-2 and 185-3) for “corner handling” in the context of insulated panels. The pieces of code represent different strategies for how to handle corners in insulated panel products. For example, code portion 185-2 represents corner handling strategy “A” and code portion 185-3 represents corner handling strategy “B”. Moreover, the product arrangement attributes 186 include a “corner handling” attribute with the value indicating that for the particular product in question, corner handling strategy “B” is to be used. Based on the value of the “corner handling” attribute, the module 194 may select code portion 185-3 to use for handling corners as part of the configured computational pipeline 196. One or more other code portions for the pipeline may be selected based on values of one or more other product arrangement attributes (examples of which are provided herein).

It is in this way, that a configurable computational pipeline associated with a product category (e.g., SIPs) or a group of product categories (e.g., SIPs and insulated concrete panels) that can be dynamically configured based on information about a specific product to create, for the specific product, a software pipeline to map that specific product to a construction project. As shown in this example, information stored in a schema instance for a product (e.g., values of the product arrangement attributes) may be used to dynamically configure a computational pipeline for mapping that product to a project.

FIG. 1E is a block diagram of an illustrative product design optimization module 150 of the illustrative construction software platform of FIG. 1A, in accordance with some embodiments of the technology described herein. As described herein, a construction product can have one or more variations and some of the variants possible may be better suited for a particular construction project than others.

Accordingly, in some embodiments, the construction software platform 106 may be used to evaluate different construction product variants and product designs resulting from the use of such variants. To this end, as shown in FIG. 1E, product design optimization module 150 may include optimization configuration module 152. With respect to a particular construction product, module 152 may allow a project designer to select one or more construction product attributes (e.g., length, width, material type, etc.) whose values may vary and over which to perform optimization. Module 152 may also allow a project designer to select one or more construction product attributes (e.g., cost, quantity) with respect to which to evaluate the resulting product designs.

For example, in some embodiments, a product category schema instance for a product being evaluated may specify one or multiple input attributes that can take on different values (e.g., length, width, etc.) and module 152 may generate a graphical user interface through which a user (e.g., project designer) can select one or more of these input attributes (e.g., length) for optimization. The product category schema instance may further specify one or more multiple output attributes and module 152 may generate a graphical user interface through which the user can select one or more of the output attributes (e.g., cost, number of panels, etc.) as optimization objectives.

After module 152 facilitates selection of one or more input attributes over which to optimize a product design and of one or more the output attributes specifying the objective(s) of the optimization, the optimization logic module 155 may perform the optimization using a suitable optimization algorithm. The optimization algorithm may be a multi-objective optimization algorithm, for example, a multi-objective genetic optimization algorithm, examples of which are provided herein.

For example, in some embodiments, the schema instance generation module 154 may “sample” the value(s) of the one or more input attributes selected for optimization. As one specific example, suppose that for, a particular product, the values for length could be between 3 and 4 feet and the values for width could be between 1 and 2 feet. Then, the schema instance generation module 154 may select (e.g., by sampling at random) length and width values in these ranges. The sampled value(s) taken together with the values of other attributes of the product specified in the schema instance define a particular variant of the construction product under consideration. The quality of that construction product variant may be evaluated by schema instance evaluation module 156, which may map the product variant (defined by the schema instance with the sampled value(s)) to the construction project (the mapping being performed as described herein) and calculate the “quality” of the product variant with respect to one or more of the identified objectives (e.g., total cost, number of panels, etc.). Of course, this process may be repeated multiple times—for every set of one or more value(s) sampled by the module 154.

In some embodiments, when a genetic optimization technique is utilized, the set of sampled schema instances (each having a particular combination of values for the attributes over which optimization is being performed) may be considered a population with P members. The genetic optimization technique may be performed for multiple generations N. At each generation, the old population of P members may be used to generate a new population of P members by modifying the existing population of schema instances may be modified based on their respective scores and rules associated with the particular genetic algorithm used, as described herein.

As part of the optimization process, the various designs generated may be compared and the results of the comparison may be shown to users. That functionality may be performed by product design comparison module 158.

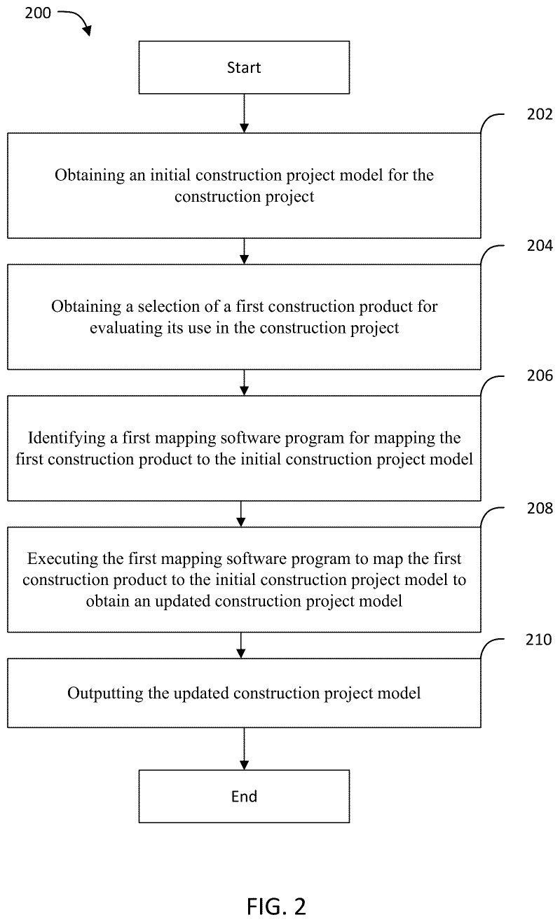

FIG. 2 illustrates a flowchart of process 200 for using a construction software platform to evaluate one or more construction products in a construction project, in accordance with some embodiments of the technology described herein. Process 200 may be executed by any suitable computing device(s), as described herein.

Process 200 starts at act 202, by obtaining an initial construction project model for the construction project, in accordance with some embodiments of the technology described herein. In some embodiments, obtaining the initial construction project model involves receiving input from a designer. For example, the input from the designer may include the initial construction project model itself. As another example, the input from the designer may include information associated with the initial construction project model such that the construction software platform may retrieve the initial construction project model from a datastore (e.g., a database, a computer, a URL, and/or any other suitable source).

In some embodiments, the designer may provide the input using a designer computing device, as described herein in connection with FIG. 1A. In some embodiments, the designer may select an initial construction project model through the designer GUI module. For example, an initial construction project model, which is associated with the designer profile 166, described in connection with FIG. 1B above, may be selected from a list of construction project models associated with the designer's profile.

In some embodiments, obtaining the initial construction project model includes receiving an initial construction project file using at least one communication network. For example, the initial construction project file may be received from the designer through the at least one communication network (e.g., received through an internet protocol over an internet connection). As another example, the initial construction project file may be received from a database in response to a fetch request (e.g., a request processed through an API) through the at least one communication network. The communication network may be any suitable communication network, as described herein. Here, in some embodiments, the initial construction project file may be a file. In other embodiments, a construction project may be specified using data organized in any other suitable way (e.g., not using a file), as aspects of the technology described herein are not limited in this respect.

In some embodiments, obtaining the initial construction project model includes obtaining one or more construction files. Together, the one or more construction files specify a model including spatial elements, materials, and/or shapes. For example, the one or more construction files may specify separate portions of a construction project. The one or more construction files may be organized by respective systems, such as a first file for structural components, a second file for electrical components, a third file for plumbing components, etc. Additionally, or alternatively, the one or more construction files may specify separate areas of a construction project, such as a first file for a first floor of a structure and a second file for a second floor of a structure. As another example, the one or more construction files may be organized by different phases of construction, corresponding to an order in which the pieces are planned to be assembled. In some embodiments, building materials may be included in a first construction file while the arrangement of spatial elements may be included in a second construction file. In some embodiments, the one or more construction files may organize a construction project in other ways, as aspects of the technology described herein are not limited in this respect.

In some embodiments, obtaining the initial construction project model includes obtaining an Industry Foundation Classes (IFC) model file. In some embodiments, obtaining the initial construction project model includes obtaining a Revit model file. In some embodiments, obtaining the initial construction project model may include obtaining a model file of another format, as aspects of the technology described herein are not limited in this respect. In some embodiments, the initial construction project model is a collection of data and/or elements sourced from a database and/or online service.

Next, process 200 proceeds to act 204 by obtaining a selection of a first construction product for evaluating its use in the construction project, in accordance with some embodiments of the technology described herein. Construction products are grouped in construction project categories, as described herein. Accordingly, the first construction product is in a first construction project category.

Obtaining the selection of the first construction product includes using a GUI to obtain the selection, in accordance with some embodiments of the technology described herein. The GUI facilitates presenting options to a designer and receiving corresponding selections from among those options from the designer. In some embodiments, the selection of the first construction product is obtained through a GUI by receiving a selection of the first construction product category, presenting a listing of one or more construction products in the first construction product category including the first construction product, and receiving the selection of the first construction product.

In some embodiments, receiving a section of the first construction product category through a GUI includes presenting to a designer a group of categories from which to select the product category. The group of categories may include all categories associated with the construction software platform. Alternatively, the group of categories may include a subset of the categories associated with the construction software platform. For example, the group of categories may be organized by building system, as described further in connection with FIG. 10F below.

In some embodiments, presenting a listing of one or more construction products in the first construction product category, including the first construction product, through a GUI includes presenting to the designer the one or more construction products-which have been previously associated with the designer profile. For example, a supplier may have previously grouped products available through the construction software platform into a collection associated with their profile. Accordingly, following the selection of a construction product category through the GUI, the GUI may then present the listing of one or more construction products which the designer has associated with their profile and that are in the selected construction product category. As another example, presenting a listing of one or more construction products in the first construction product category may include presenting the one or more construction products grouped by supplier profile. For example, a supplier may provide multiple construction products in the first construction product category. Accordingly, the presentation of the one or more construction products to the designer may be grouped according to supplier. As another example, the designer may select an ordering of one or more construction products by selecting a product attribute by which to rank the products in ascending or descending order. As yet another example, the presenting the listing of one or more construction products in a first construction product category may include receiving a selection of one or more search criteria from the designer and returning the listing of one or more construction products in the first construction product category based on the one or more search criteria. The search criteria may be used to identify products using the marketplace module described in FIG. 1B above.

In some embodiments, the listing of one or more construction products in the first construction product category may be presented as a drop-down list of products. In some embodiments, the one or more construction products in the first construction product category may be presented as an array of options. The array of options may include pictures or schematic diagrams of each option of the array of options as thumbnail images. In some embodiments the one or more construction products in the first construction product category may be presented in any other suitable display manner, as aspects of the technology described herein are not limited in this respect.

In some embodiments, receiving the selection of the first construction product through the GUI includes receiving a single construction product from the listing of the one or more construction products in the first construction product category. In some embodiments, the selection of the first construction product may be followed by receiving a second construction product selection from the listing of the one or more construction products in the first construction product category. For example, multiple products may be selected by the designer from the one or more construction products in the first construction product category displayed on the GUI.

In some embodiments, the GUI is an interface presented to a designer through an Internet browser application or an application program executing on a device of the designer. Accordingly, the selection of the product category may be received through a designer GUI module, in accordance with some embodiments described herein. The designer GUI modules may be a dedicated module for interfacing between the software construction platform and designers' computer systems. For example, the designer GUI module may be designer GUI module 140, as described above in connection with FIG. 1. In some embodiments, other designer GUI module configurations may be used, as aspects of the technology described herein are not limited in this respect.

Next, process 200 proceeds to act 206 by identifying a first mapping software program for mapping the construction product to the initial construction project module, in accordance with some embodiments of the technology described herein. The construction software platform may include multiple mapping software programs. Each of the multiple mapping software programs may be configured to map construction products in a respective construction product category to a construction project model. In some embodiments, the multiple mapping software programs may be stored in association with information identifying the respective construction product category and/or information a construction product. Thus, in some embodiments, a mapping software program may be identified using a construction product category or the construction product (or both).

In some embodiments, identifying the first mapping software program comprises selection of the first mapping software program from among the multiple mapping software programs. The selection of the mapping software program is stored in association with information identifying the first construction product category (or, in some embodiments, the first construction product).

Next, process 200 proceeds to act 208 by executing the first mapping software program to map the first construction product to the initial construction project model to obtain an updated construction project model, in accordance with some embodiments of the technology described herein.

In some embodiments, executing the first mapping software program to map the first construction product to the initial construction product model includes generating a product design that includes an arrangement of one or more instances of the first construction product with respect to the initial construction project model. Arranging the one or more instances of the first construction product may include multiple arrangement operations.

In some embodiments, the product design specifies positioning of the one or more instances of the first construction product with respect to one another and with respect to the initial project model. Positioning of the one or more instances of the first construction product may include placing one or more instances of the first construction product at a specific position with respect to the initial project model. For example, the first construction product may be a wall construction product. Accordingly, positioning the one or more instances of the wall construction product includes placing one or more instances of the wall product at positions of the initial project model that specify wall elements.

In some embodiments, the product design specifies paneling of the one or more instances of the first construction product with respect to one another and with respect to the initial project model. Paneling of the one or more instances of the first construction product may include placing multiple instances of the first construction product adjacent to one another such that the instances of the first construction product span a portion of the initial project model corresponding to an element of the initial project model. For example, the first construction product may be a wall panel construction product. Accordingly, paneling multiple instances of the wall panel construction product may include placing the multiple instances of the wall panel construction product to span a wall element of the initial project model such that together the multiple instances of the wall panel construction product correspond to the parameters (e.g., length, width, and/or depth) of the wall instance. In some embodiments, paneling of the one or more instances of the first construction product may include specifying a degree of overlap between adjacent instances of the one or more instances of the first construction product. In some embodiments, paneling of the one or more instances of the first construction product may include specifying a spacing between adjacent instances of the one or more instances of the first construction product.

In some embodiments, the product design specifies scaling of the one or more instances of the first construction product with respect to one another and with respect to the initial project model. Scaling of the one or more instances of the first construction product may include changing a dimension of the one or more instances of the first construction product. For example, scaling of the one or more instances of the first construction product may include changing a length and or width of the one or more instances of the first construction product. The dimension of the one or more instances may be scaled continuously or discretely depending on the schema instance of the first construction product.

In some embodiments, the product design specifies modification of the one or more instances of the first construction product with respect to one another and with respect to the initial project model. Modification of the one or more instances of the first construction product may include modifying an attribute of the construction product. For example, modification of the one or more instances of the first construction product may include adding an opening for a window in accordance with the initial project model. For adding an opening to an instance of a construction product, the construction software platform may identify instances which are placed at a location that includes an opening in the initial project model. Upon identifying that the instance is placed at the location that includes an opening, the instance of the construction product may be modified to include an opening in accordance with the initial project model.

Next, process 200 proceeds to act 210 to output the updated construction project model, in accordance with some embodiments of the technology described herein. The updated construction project model may be output in any suitable form to provide review and or analysis of the updated construction project model. In some embodiments, the updated construction project model is output as a three-dimensional model of the initial construction project with the design arranged thereon. In some embodiments, the updated construction project model is a 3D model that includes the initial construction project model and one or more instances of the first construction product arranged thereon. In some embodiments, the output includes the arrangement of the construction product without including the initial construction project model.

In some embodiments, the updated construction project model may be encoded as one or more files in any suitable file format(s). The updated construction project model may be used by the construction software platform to provide a rendering of the updated construction project to a designer through a designer GUI module, such as designer GUI module 140 described above in connection with FIG. 1A.

Following the conclusion of act 210, process 200 ends. Following the conclusion of process 200 the construction product evaluation may continue through obtaining a selection of a second construction product to be evaluated for its use in the construction project. The selection of the second construction product may proceed in accordance with the process of obtaining the selection of the first construction product, described in act 204. Although process 200 is described as using a GUI to receive input from a designer, it should be appreciated that process 200 is not limited to implementations including a GUI.

It should be appreciated that although one or more acts of example process 200 (as well as acts of other processes examples provided herein) may involve receiving one or more inputs and/or providing one or more outputs via a GUI, in some embodiments, one or more such acts may be performed via an application programming interface (API), as aspects of the technology described herein are not limited in this respect.

In some embodiments, following the conclusion of process 200, the designer may elect for additional outputs to be produced. For example, the designer select to generate component drawings based on the updated construction model. Accordingly, upon selection to generate component drawings, a component drawing module may generate drawings of the components based on the updated construction model. Component drawings may be PDF or DWG formats. For each panel in the updated construction project model, a drawing is created with multiple views of the panel placed on it (e.g., top, left, right, front, back, under views). The drawing may include automatically placed dimension annotations for both overall size, features (outline shape) and penetrations. In some embodiments, a general arrangement (GA) drawing may be created. The general arrangement drawing may be PDF or DWG formats. The general arrangement drawing shows the entire generated design in context in floor plan, elevation, or sectional views. Other types of drawings may be generated including but not limited to assembly drawings, installation drawings, etc. In some embodiments, schedules, timelines, bill materials and/or other deliverables may be generated. For example, the schedule and bill materials may be generated using the metrics produced for the updated construction model. The format of the schedules and bill materials may be Excel, CSV, or JSON formats. The drawings schedule and bill of materials may be exported in multiple formations so users can import them into their own workflows. In some embodiments, proprietary BIM may be used such as RVT, TestFit, Revit etc. formats. The updated construction model may be converted to proprietary formats. In some embodiments, open 3d formats may be used such as GLB, GLTE, OBJ, STL, STEP, FBX etc. The updated construction model may be converted to the other open 3D formats. In some embodiments, other formats may be used herein, as aspects of the technology described herein are not limited in this respect.

Similarly, after obtaining the second construction product, a second mapping software program may be identified, using the second construction product category, in accordance with the process of identifying the first mapping software program, described in act 206.

After identifying the second mapping software program, the second mapping software program may be executed to map the second construction product to the initial construction project, in accordance with the process of executing the first mapping software program, described in act 208. In some embodiments, the second mapping software program maps the second construction product to the construction project model output after the first construction project mapping. In this way the second product is applied to an intermediate construction project file (e.g., the initial construction project file which includes a mapping of the first construction product to the construction project file) to obtain a final updated construction project model. In some embodiments, the second mapping software program maps the second construction product to the initial construction project model without the mapping of the first construction product included.

In some embodiments, the second product process is executed sequentially after the competition of the first product process. For example, following the competition of process 200, the second product is obtained, the second mapping software program identified, and the second mapping software executed.

Additionally or alternatively, although described as occurring sequentially, with the second product being obtained, the second mapping software program identified, and the execution of the second mapping software each occurring after the completion of process 200, the second construction product process may be included as part of process 200. For example, when obtaining a selection of a first construction product in act 204, a second construction product may be obtained along with the first construction product. Similarly, the identifying of the first mapping software program and the identifying of the second software mapping program may occur sequentially (e.g., one after another) or may occur in parallel.

In some embodiments, multiple construction products may be selected resulting in the identification of multiple respective mapping software programs. Depending on the category of each of the multiple construction products, the respective mapping software programs may be, for products in the same category, a same or a different mapping software program, relative to mapping software programs identified for the other of the multiple construction products. In some embodiments, the multiple mapping software programs may be executed sequentially in the order in which the construction products were received. In some embodiments, the multiple mapping software programs may be executed in parallel. In some embodiments, the multiple mapping software programs may be executed in a set order associated with the category of each respective construction product.

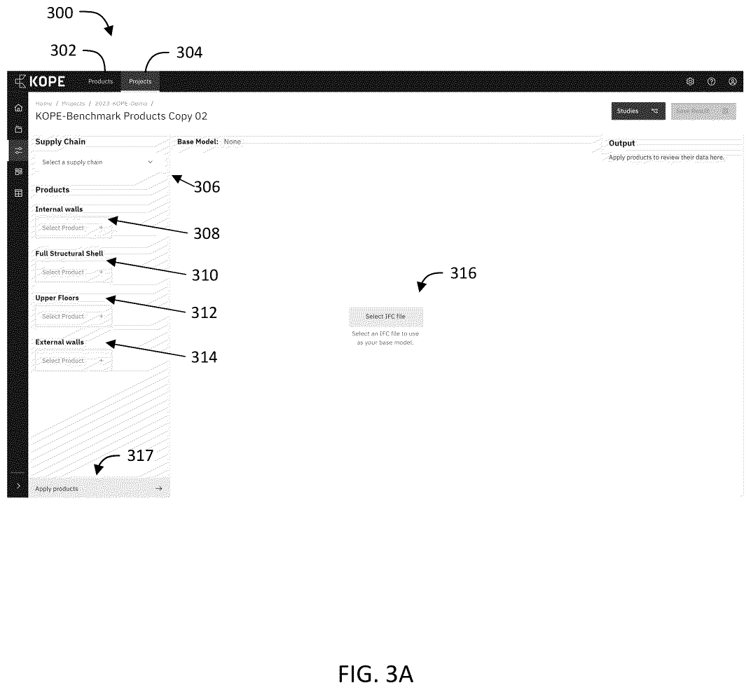

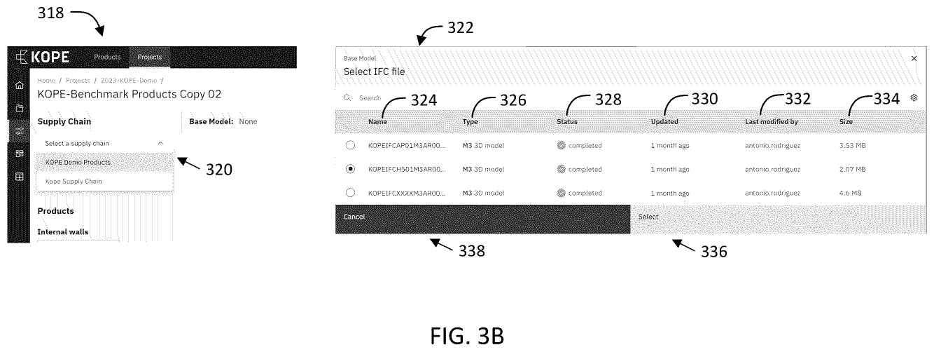

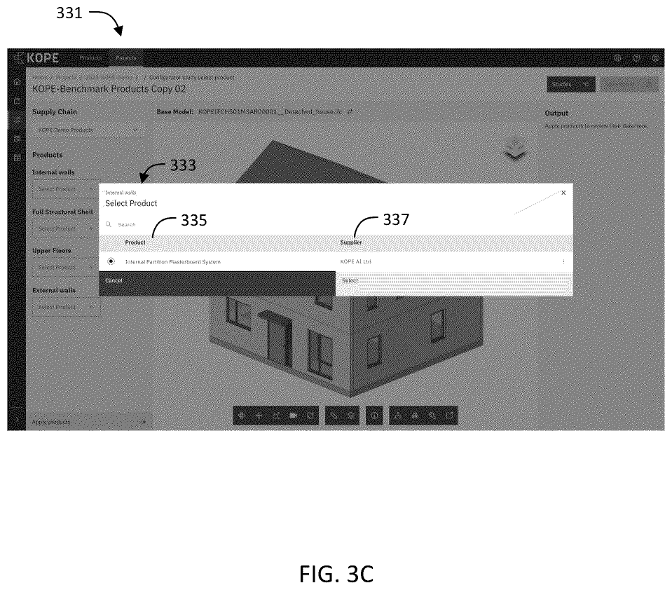

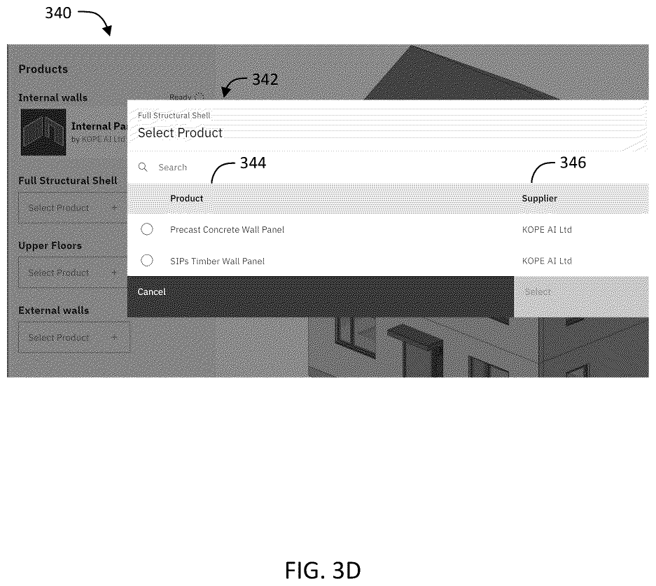

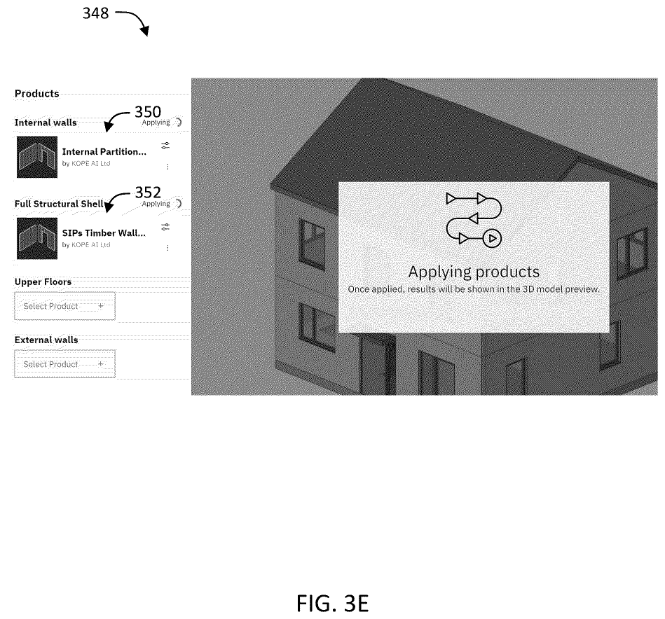

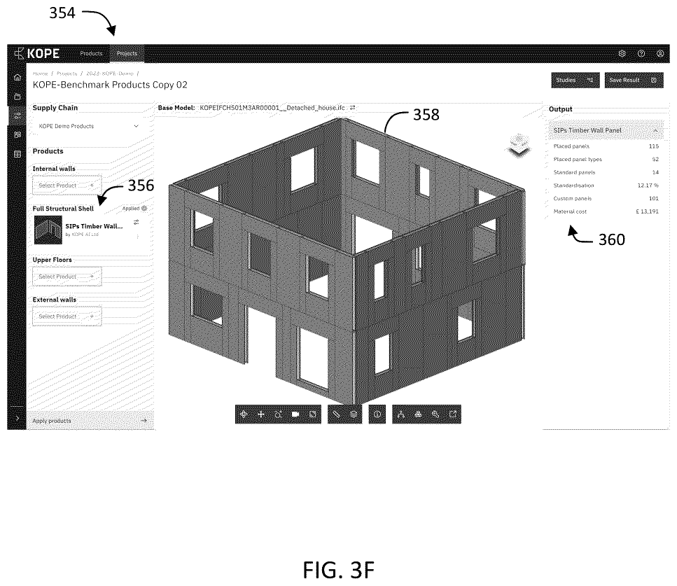

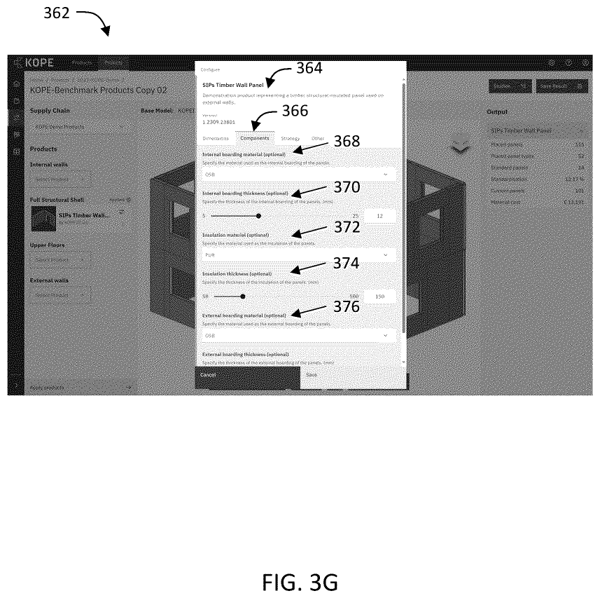

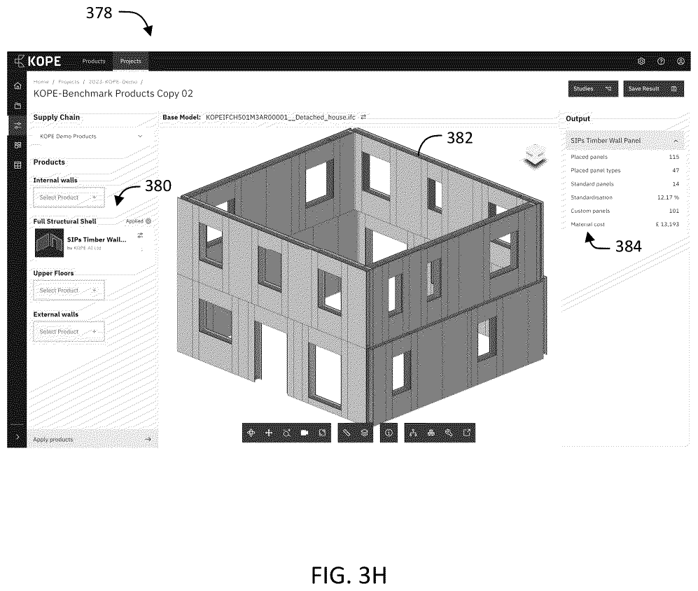

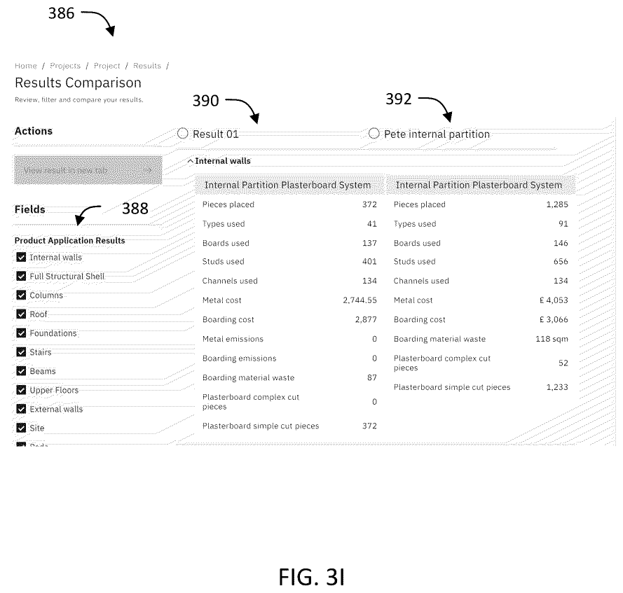

FIG. 3A illustrates an example of a GUI 300 for obtaining an initial construction project model for a construction project, in accordance with some embodiments described herein. GUI 300 includes a products tab 302 and a projects tab 304. Project tab 304 is selected, displaying a GUI for interfacing with a construction project design environment. As shown in FIG. 3, GUI 300 includes dropdown elements 306, 308, 310, 312, and 314 for making selections. Dropdown element 306 may be used to select a collection of construction products. Navigation elements 308, 310, 312, and 314 may be used to select products which are associated with the collection of construction products. Navigation element 308 may be used to select an internal wall product. Navigation element 310 may be used to select a full structural shell product. Navigation element 312 may be used to select an upper floor product. Navigation element 314 may be used to select an external wall product. GUI 300 includes a navigation element 316 for opening a selection window for selecting an initial construction project file. In some embodiments, additional dropdown elements may be included as aspects of the technology described herein are not limited in this respect.

FIG. 3B illustrates an example a GUI 318 for selecting a collection of products associated with a designer profile and a GUI 322 for selecting an initial construction project model for a construction project design environment, in accordance with some embodiments of the technology described herein. The GUI 318 illustrates an expanded dropdown list 320, expanded in response to a designer selecting the dropdown element 306. The expanded dropdown list 320 shows two different collections of products associated with a designer profile.

In some embodiments, GUI 322 is a window provided to the designer by the GUI in response to the designer selecting navigation element 316. GUI 322 shows a list of initial construction project model files presented to the designer for selection. The list of initial construction project model files include file properties 324, 326, 328, 330, 332, and 334 associated with respective properties of the initial construction project model files. File property 324 corresponds to the name of the initial construction project model files. File property 326 corresponds to the type (e.g., file format) of the initial construction project model files. File property 328 corresponds to the status (e.g., whether the file is complete or in progress) of the initial construction project model files. File property 330 corresponds to the time since the last updates were made to the initial construction project model files. File property 332 corresponds to the last user (e.g., supplier or designer) who modified the initial construction project model file. File property 334 corresponds to the size of the initial construction product model files.

In some embodiments, the GUI allows for a designer to select one or more initial construction project model files. For example, GUI 322 allows a designer to select any number of initial construction project model files from the available files. Upon selecting one or more initial construction project model files to be added to the construction project design environment, the designer may select control element 336 to confirm the selection of one or more initial construction project model files. Alternatively, the designer may select control element 338 to cancel the selection of one or more initial construction project model files.

FIG. 3C illustrates an example of a GUI 331 for selecting a product associated with a first product category from a collection of products associated with a designer profile, in accordance with some embodiments of the technology described herein. As shown in FIG. 3C, a window 333 is provided to the designer in response to selection of navigation element 308, corresponding to a first construction product category. Window 333 allows a designer to select any number of construction product schema instances corresponding to available products included in the list and associated with the category and or a group of categories corresponding to navigation element 308. For example, as shown in FIG. 3C a list of products in the internal walls category is displayed in window 333. The list of products includes product property 335 and product property 337. Product property 335 corresponds to the name of the construction product. Product property 337 corresponds to the supplier of the construction product. The list shown in window 333 includes only a single product. When a product is selected the product schema instance corresponding to the selection may be selected for use in the construction product design environment.

FIG. 3D illustrates an example of a GUI 340 for selecting a product associated with a second product category from a collection of products associated with a designer profile, in accordance with some embodiments of the technology described herein. As shown in FIG. 3D, the window 342 is provided to the designer in response to selection of navigation element 310 corresponding to a second construction product category. Window 342 allows the designer to select any number of construction product schema instances from the available product schema instances corresponding to available products included in the list and associated with the category and or a group of categories corresponding to navigation element 310. For example, as shown in FIG. 3D a list of products in the full structural shell category is displayed in window 342. The list of products includes product property 344 and product property 346. Product property 344 corresponds to the name of the construction product. Product property 346 corresponds to the supplier of the construction product. The list shown in window 340 includes two products a precast concrete wall panel and a SIPs timber wall panel.

FIG. 3E illustrates an example GUI 348 for executing a configurable computational pipeline for mapping two products with default values to an initial construction project model, in accordance with some embodiments of the technology described herein. Following the selections shown in FIG. 3B, FIG. 3C, and FIG. 3D—the selected products may be applied to the selected initial construction project model by selecting control 317 to initiate mapping of the products. Once the execution has initiated, GUI 348 may be displayed to the designer to show the selections of products from perspective product categories which are being mapped to the initial construction project model. For example, as shown in window 348, an internal partition product is selected for the internal walls category 350 and a SIPs timber wall product is selected for the full structural shell category 352. In some embodiments, where the designer has not specified parameters for the selected products, the mapping is executed using default values associated with the product and category schema instances.

FIG. 3F illustrates an example GUI 354 for viewing the updated construction project model resulting from the mapping shown in FIG. 3E, in accordance with some embodiments of the technology described herein. After mapping of selected products has been executed to produce the updated product construction model, the output 3D results 358 is shown in a center panel of the GUI. The mapped products are shown as applied in the left panel 356 of the GUI to indicate which product has been mapped to the initial construction product model. A summary of results, representing the output attributes that correspond to the category of the mapped product, are shown as a panel 360 positioned on the right of the GUI.

FIG. 3G illustrates an example GUI for specifying input attributes for a construction product associated with a construction product category, in accordance with some embodiments of the technology described herein. Upon selection of a construction product, the attributes may be specified for use in the mapping of the construction product to the initial construction product model. As shown in FIG. 3G a window 364 showing the product attributes is presented to a designer for their selection. The product attributes may be grouped according to dimension attributes, component attributes, modification strategy attributes, and/or other attributes. Window 364 illustrates product attributes for a SIPs timber wall panel product. Tabs corresponding to the different groupings of product attributes are included within the window which illustrates component attribute tab 366 as selected. Within product attribute tab 366, product attributes 368, 370, 372, 374, and 376 are included. Product attribute 368 corresponds to an internal boarding material component of the SIPs timber wall panel. Product attribute 370 corresponds to in internal boarding thickness of the SIPs timber wall panel. Product attribute 372 corresponds to an insulation material of the SIPs timber wall panel. Product attribute 374 corresponds to insulation thickness. Product attribute 376 corresponds to an external boarding material.

In some embodiments, the product attributes may be selected using a dropdown selection menu. In some embodiments, the product attributes may be selected using sliders for adjusting a value of the product attribute. In some embodiments, a combination of control elements may be used for selecting product attributes. In some embodiments, other control elements may be used, as aspects of the technology described herein are not limited in this respect.

FIG. 3H illustrates an example GUI 378 for viewing the updated construction project model resulting from the mapping configured in FIG. 3G, in accordance with some embodiments of the technology described herein. After the mapping of selected products has been executed using the specified product attributes, illustrated in FIG. 3G, to produce the updated product construction model—the output result 382 is shown in a center panel of GUI. The mapped of products are shown as applied in the left panel 380 of the GUI to indicate which product has been mapped to the initial construction product model. A summary of results, representing the output attributes that correspond to the category of the mapped product, are shown as a panel 384 positioned on the right side of the GUI.

FIG. 3I illustrates, an example GUI 386 for viewing the output attributes for products mapped to the construction project model, in accordance with some embodiments of the technology described herein. GUI 386 illustrates product categories in a left panel 388 of the GUI. For a selected product category, GUI 386 shows the results associated with the output attributes corresponding to the selected product category for each product which was mapped to the initial construction product model belonging to the selected category. For example, for the internal wall category, the values of the output attributes for a first internal partition plasterboard system product 390 and the values of the output attributes for a second internal partition plasterboard system 392 and displayed in respective columns of GUI 386.

In some embodiments, the output attributes include both category product attributes associated with the category schema and product specific attributes associated with a product schema. In some embodiments, the output attributes include only the category product attributes associated with the category schema.

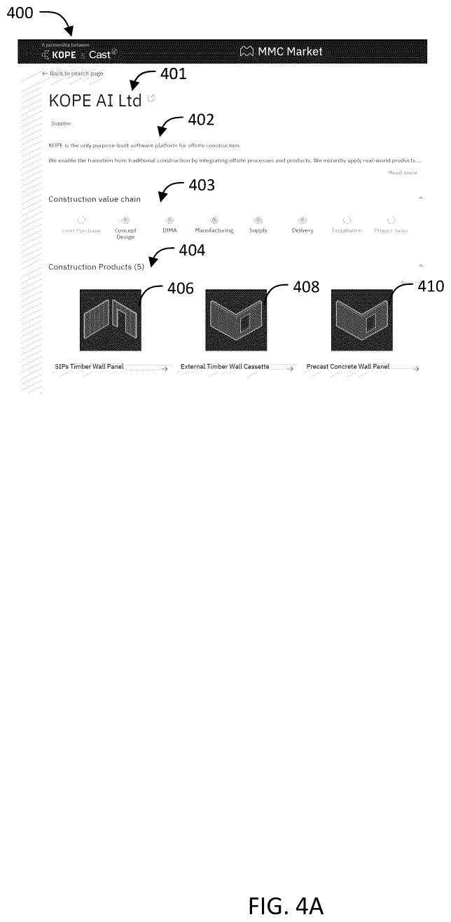

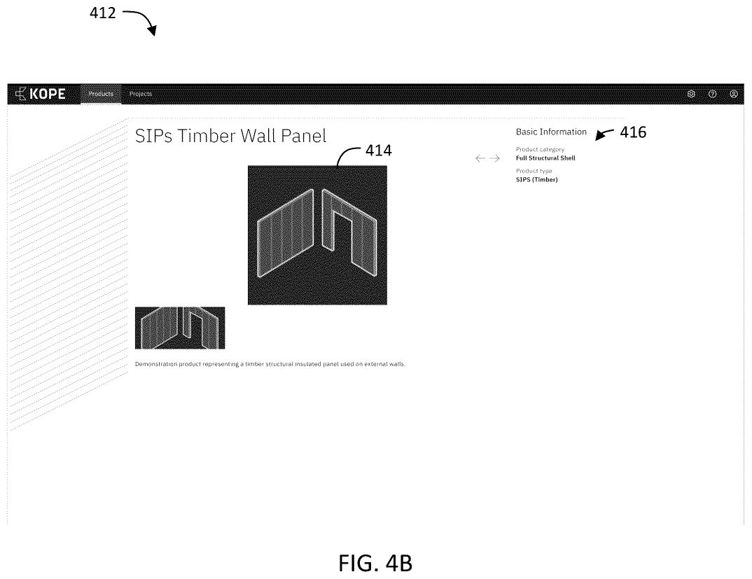

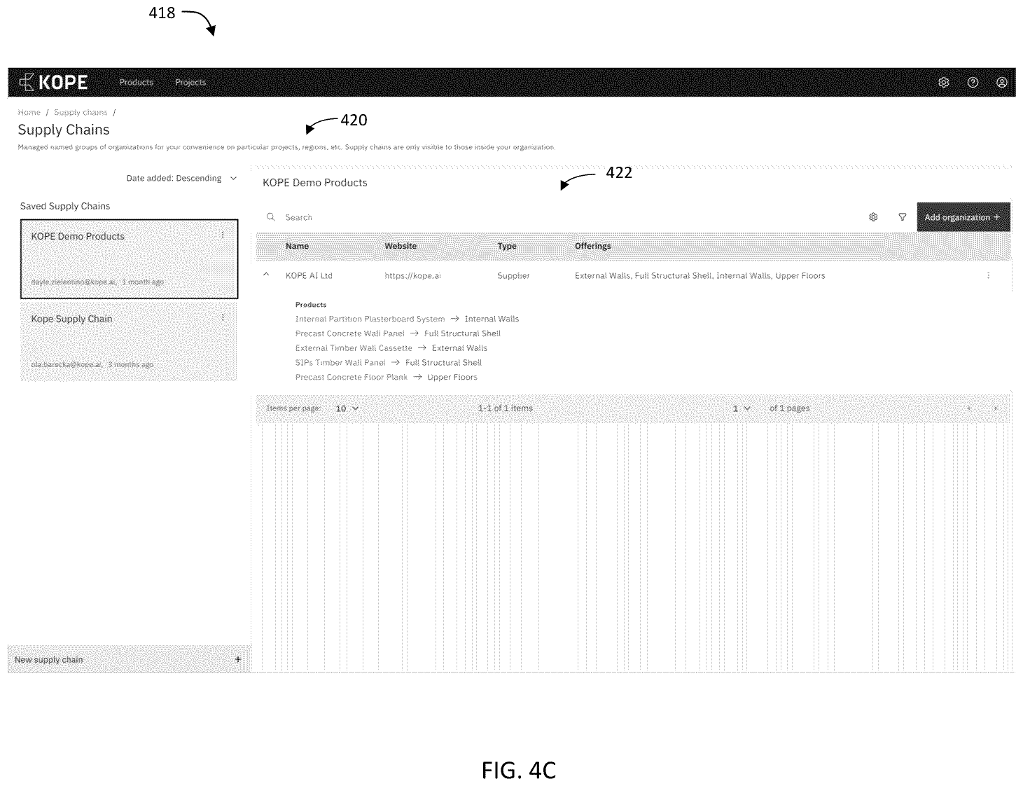

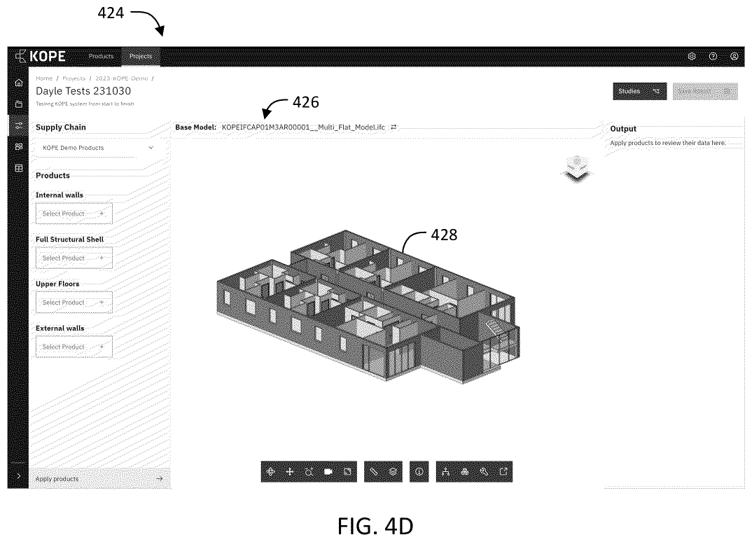

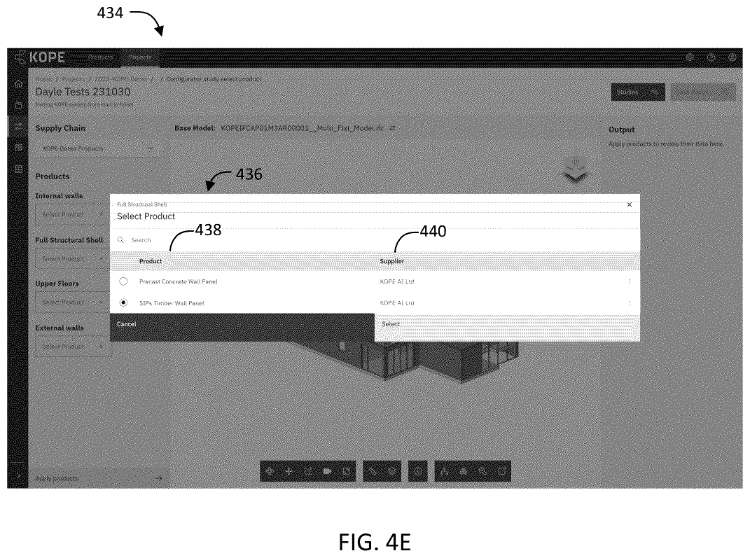

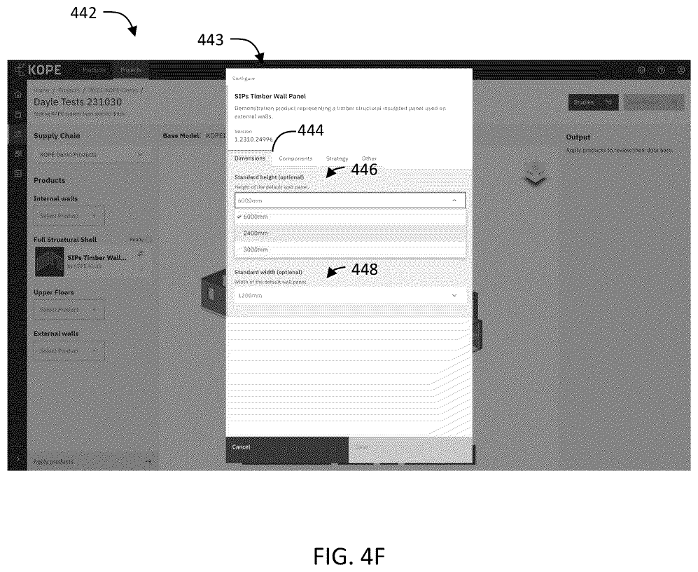

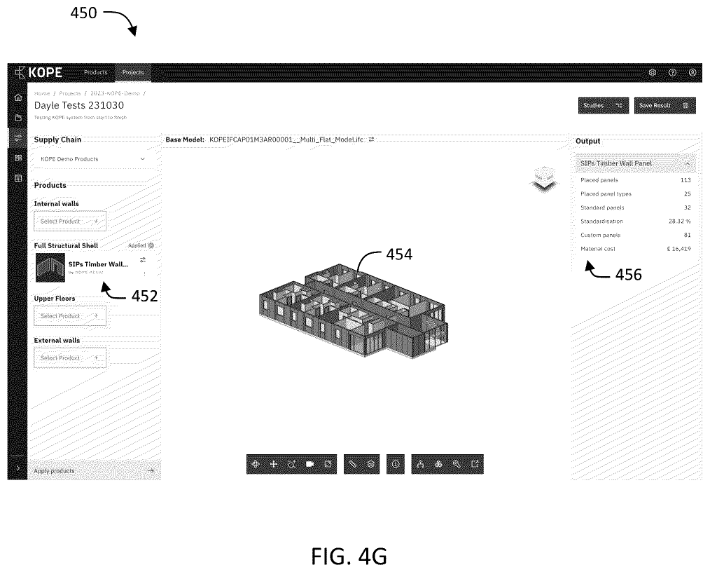

FIG. 4A illustrates an example GUI 400 for a supplier profile, in accordance with some embodiments of the technology described herein. As shown in FIG. 4A, the supplier profile includes supplier name 401, supplier description 402, supplier services 403, and a list of construction products offered by the supplier 404. Supplier name 401 and supplier description 402 provide designers with details about the supplier's company. In connection with planning an offsite construction project, different suppliers may offer different types of services with regard to the products they offer. For example, an offsite construction project may include purchasing land for the final assembly of products in accordance with a construction build plan, designing the construction build plan, design for manufacture and assembly (DfMA) of products, manufacturing of products, supplying of products, delivery of products, installation of products, and sale of a completed project. Different companies may offer different degrees of these services. Accordingly, when planning and offsite construction project knowing which services are offered by which companies may be important in project optimization. As shown in FIG. 4A, a visual representation of the supplier services 403 offered by a particular supplier profile is included in GUI 400. In some embodiments, a visual representation of the supplier services 403 is shown as a sequence of supplier services ordered according to the sequence of typical project progression for an offsite construction project. The sequence of supplier services is shaded to indicate whether the supplier offers a particular service. In some embodiments, other visual representations and/or ordering of supplier services may be used as aspects of the technology described herein are not limited in this respect. The list of construction products offered by the supplier 404 includes five products, three of which are displayed on GUI 400. As shown in FIG. 4A, SIPs timber wall panel product 406, external timber wall cassette product 408, and precast concrete wall panel product 410 are shown on GUI 400.

FIG. 4B illustrates an example GUI 412 for a construction product, in accordance with some embodiments of the technology described herein. As shown in FIG. 4B, a product 414 is displayed by GUI 412 as a product profile page. The product profile page may be used in connection with a marketplace module, such as the marketplace module described in connection with FIG. 1B above. The product page shown in FIG. 4B includes product information 416 such as the product category and product type. In some embodiments, additional information associated with the product may be provided on the product page, as aspects of the technology described herein are not limited in this respect.

FIG. 4C illustrates an example GUI 418 for a collection of products associated with a designer profile, in accordance with some embodiments of the technology described herein. The collection of products may include products that a designer associated with a particular collection which may be organized according to the designer's preference. For example, the products in a collection may be products which are being considered for use for a particular offsite construction project. As shown in FIG. 4C, the collection of products is displayed as a list by the GUI, the list having a series of attributes 420 and products 422. In some embodiments, the products may be organized by supplier. Accordingly, the series of attributes may relate to supplier details, such as the name, website, type of profile in the marketplace, and product offerings. The listing of products 422 may be organized by the product category. In some embodiments, other collection of products may be organized in other ways, as aspects of the technology described herein are not limited in this respect.

FIG. 4D illustrates an example of a GUI 424 for selecting an initial construction project model, in accordance with some embodiments of the technology described herein. GUI 424 shows a construction project design environment corresponding to a selected initial construction project design file 426 which has been associated with the construction project design environment. A 3D model 428 of the initial construction project design model is shown in the center panel of GUI 424.

FIG. 4E illustrates an example of a GUI 434 for selecting a product from a collection of products associated with a designer profile, in accordance with some embodiments of the technology described herein. In response to a designer selecting a product category for which to apply a product, window 436 is presented to the supplier including a listing of products for the selected product category. The listing of products includes product name 438 and supplier of the product 440.

FIG. 4F illustrates an example of a GUI 442 for optionally configuring product attributes for a product which has been selected for mapping to an initial construction project model, in accordance with some embodiments of the technology described herein. Upon selecting a product for mapping to an initial construction project model, a supplier may optionally configure input product attributes to specify product attributes to be used in the mapping. As shown in window 443, tab 444 corresponds to product input attributes for the dimensions of the product is selected. Within tab 444, options for the height of the product are displayed in an expanded drop-down menu 446 providing discrete options for the product height. An option for the width of the product is displayed in collapsed dropdown menu 448, which could be expanded by the supplier to display discrete options for the product width. Whether or not the product attribute selection provides for discrete or continuous selection of product attributes may be set by the supplier during the creation of the product profile through selection of the attributes from the product category associated with the category schema for the product. Therefore, in some embodiments, sliders for continuous selection of values for the input attributes for the product may be shown in window 443. In some embodiments, the designer may not specify product attributes to be used in the mapping, in which case default values may be used.

FIG. 4G illustrates an example GUI 450 for viewing the updated construction project model resulting from the mapping of selected products to the initial construction project model, in accordance with some embodiments of the technology described herein. The results of the mapping are displayed as a 3D model 454 in a center panel including the selected products with the updated construction project model and output results for the output attributes associated with the category of the mapped product are shown in panel 456 in a right panel of GUI 450. The mapped products are shown in a left panel 452 of GUI 450.

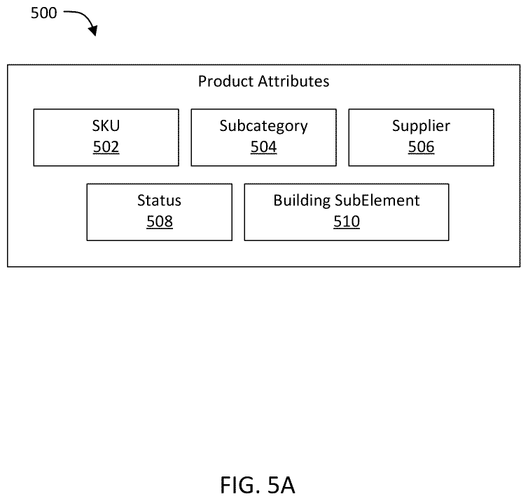

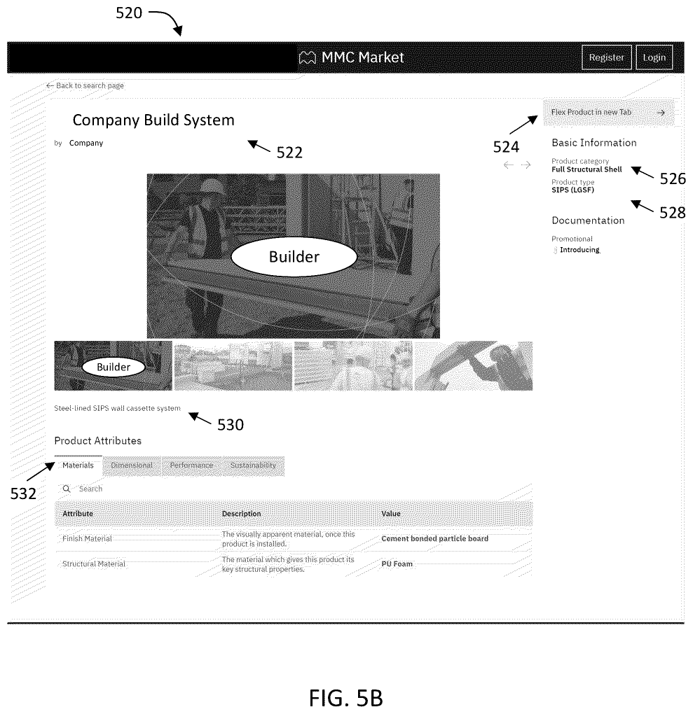

FIG. 5A illustrates product attributes that are associated with a specific product from a product category, in accordance with some embodiments of the technology described herein. Product attributes 500 include stock keeping unit (SKU) 502, subcategory 504, supplier 506, status 508, and building sub-element 510. SKU 502 is a product identification number which may be used both by designers and suppliers for inventory management and the shipping of products from suppliers to designer during the shipping and construction phase of a project. Subcategory 504 may be used to group the product with a sub collection of products from the product category, the sub collection of products having a common schema specifying common attributes (e.g., input attribute and output attributes) shared by each product in the sub collection of products but not necessarily shared with every product in the general product category. In some embodiments, some product categories may include subcategories while others may not. In some embodiments, no product categories may include a subcategory. Product attribute 506 specifies the supplier of the product. Product attribute 508 indicates status of the product. For example, the status of the product may indicate whether the product is currently available for order. As another example, the status of the product may indicate whether the product is ready to ship. As yet another example, the status of the product may indicate that a product is not currently available. Building sub-element 510 specifies a category of building element that the current product is targeting. For example, floors, walls, ceilings, columns, roofs—as described herein.

FIG. 5B illustrates an example GUI 520 illustrating a product and product attributes, in accordance with some embodiments of the technology described herein. As shown in FIG. 5B, GUI 520 includes the product name 522, product description 530, product attributes 532, product category 526, and product type 528. In some embodiments, the GUI may include a navigation button 524 for showing an adjustable product configuration which allows the designer to modify attributes of the product and see a visualization of the product.

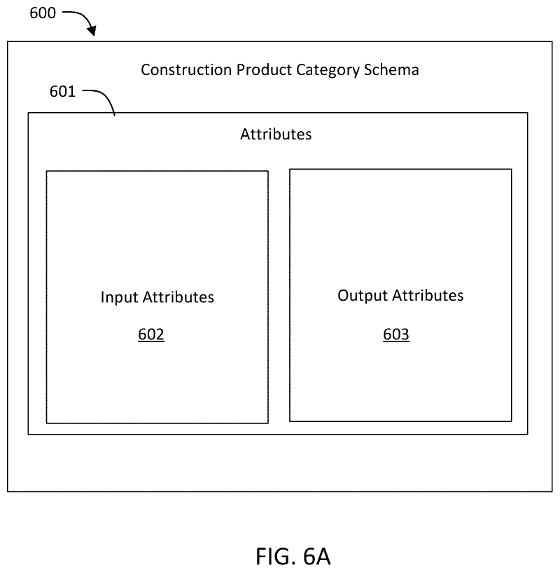

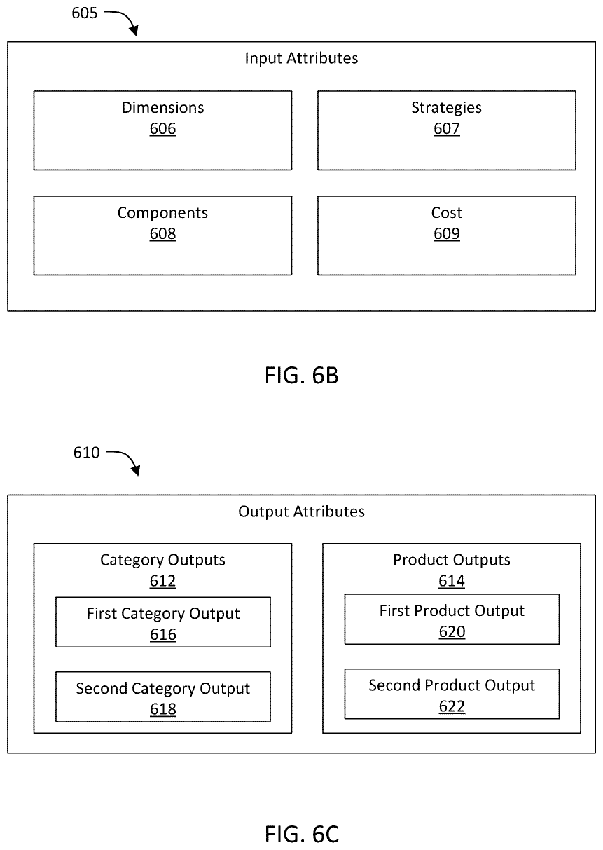

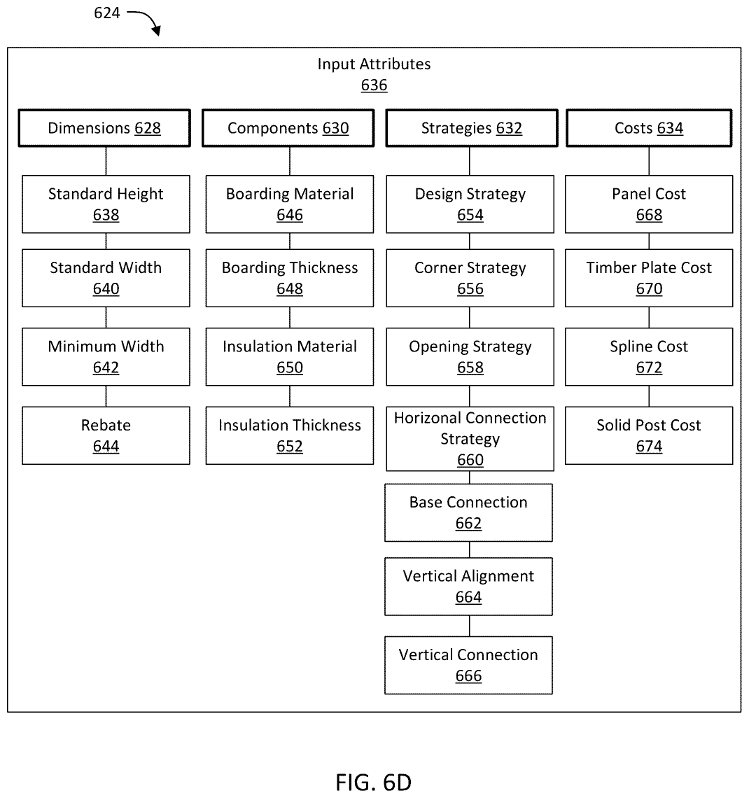

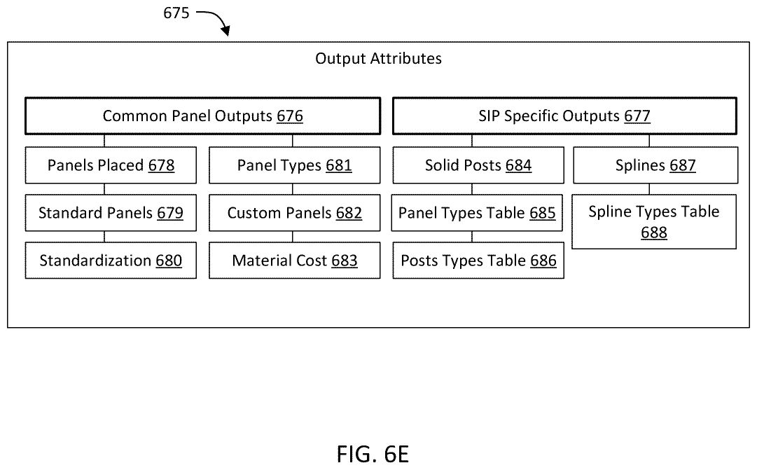

FIG. 6A illustrates attributes for a construction product category schema, in accordance with some embodiments of the technology described herein. Construction product category schema 600 includes attributes 601. Attributes 601 are the attributes which are included with each product in the construction product category. Attributes 601 include input attributes 602 and output attributes 603.

Input attributes describe the ways that the product may be constructed. FIG. 6B illustrates groupings of input attributes, in accordance with some embodiments of the technology described herein. As shown in FIG. 6B, the groupings of input attributes include dimensions 606, strategies 607, components, 608, and cost 609.

Output attributes describe characteristics associated with the mapping of the product to the initial construction project model. FIG. 6C illustrates output attributes 610 associated with the product, in accordance with some embodiments of the technology described herein. Output attributes 610 includes category outputs 612 and product outputs 614. Category outputs 612 represents outputs which are shared by all the products in the product category group. For example, category outputs may include first category output 616 and second category output 618. Each product listed in a product category will, after mapping, have a value for the first category output 616 and the second category output 618. Product outputs 614 include first product output 620 and second product output 622. The product outputs include attributes which are not necessarily shared across products in a product category but nonetheless describe the specific product such that, after mapping, a product has a value for first product output 620 and second product output 622.

FIG. 6D illustrates examples of input attributes for a SIPs schema, in accordance with some embodiments of the technology described herein. SIPs schema 624 includes input attributes 636. In some embodiments input attributes 636 are grouped into groupings of input attributes. For example, in the illustrated example of FIG. 6D, input attribute 636 are grouped into dimensions 628, components 630, strategies 632, and costs 634.

Dimensions 628 include standard height 638, standard width 640, minimum width 642, rebate 644. Standard height 638 is the selected panel height to be used in the application and may include a list of integers. For example, values usually cover a range between two meters and six meters with different steps in between for the same supplier. As another example, values may go up to 15 meters. The increments may be specified by the supplier and thus may be configured in accordance with the building capabilities of the supplier for the particular product. In some embodiments, other standard heights may be used as aspects of the technology described herein are not limited in this respect.

Standard width 640 is the selected panel width to be used in the application and may include a list of integers. For example, values usually cover a range around 1200 mm, such as 1220 mm, 1200 mm, or 1150 mm. As another example, these values may cover a range around 2770 mm. The increments may be specified by the supplier and thus may be configured in accordance with the building capabilities of the supplier for that particular product. In some embodiments, other panel widths may be used as aspects of the technology described herein are not limited in this respect.

Minimum width 642 is the minimum width dimension buildable with a panel. The available minimum width dimensions may range from 100 mm to 500 mm in steps of 50 mm. For example, a common value is 200 mm. In some embodiments, other minimum width dimensions may be used as aspects of the technology described herein are not limited in this respect.

Rebate 644 is the recess of the internal insulation layer compared to the external boarding. The recess values may range from 10 mm to 100 mm in steps of 10 mm. For example, a common value is 50 mm. In some embodiments, other recess values may be used as aspects of the technology described herein are not limited in this respect.

Components 630 include boarding material 646, boarding thickness 648, insulation material 650, and insulation thickness 652. Boarding material 646 is the material used as external boarding on both sides of the panel. Options may include oriented strand board (OSB), cement bonded particle board (CBPB), or magnesium oxide (MgO). For example, OSB is a common boarding material. In some embodiments, other boarding materials may be used as aspects of the technology described herein are not limited in this respect.

Boarding thickness 648 is the thickness of the external boarding layers. The boarding thickness may include a list of integers ranging between 11 mm and 18 mm. For some suppliers, the boarding thickness attribute may be limited to a single boarding thickness. For other suppliers, the supporting thickness attribute may include multiple options for the boarding thickness. In some embodiments, other supporting thicknesses may be used as aspects of the technology described herein are not limited in this respect.

Insulation material 650 is the material used on the internal insulation layer. Options may include expanded polystyrene (EPS), polyurethane (PUR), or polyisocyanurate (PIR). For example, EPS is a common insulation material. In some embodiments, other insulation materials may be used as aspects of the technology described herein are not limited in this respect.

Insulation thickness 652 is the thickness of the internal insulation layer. The thickness of the internal insulation layer may be a list of integers ranging between 50 mm and 300 mm. The increments may be specified by the supplier and may be configured in accordance with the building capabilities of the supplier for the particular product. In some embodiments, other insulation thicknesses may be used as aspects of the technology described herein are not limited in this respect.

Strategies 632 include design strategy 654, corner strategy 656, opening strategy 658, horizontal connection strategy 660, base connection strategy 662, vertical alignment strategy 664, and vertical connection strategy 666. Design strategy 654 specifies whether the panels are designed in large complex pieces or in smaller pieces. Design strategy 654 specifies wall elevation and a maximum wall width. Maximum wall width may correspond to the width of the jamb panels and may be thinner than the standard panels.

Corner strategy 656 specifies how panels meet at wall corners. Corner strategy 656 includes corner overlap, corner panel, and corner gap. Corner strategy 656 will be based on the dimensions and the shape of the corner panel. For example, the corner strategy may consider whether the corner panel is square or L-shaped as well as the dimensions that will be used to apply a corner strategy. In some embodiments, other strategies may be included with the corner strategies in place of or in addition to those listed, as aspects of the technology described herein are not limited in this respect.

Opening strategy 658 describes how panels behave around wall openings. Opening strategy 658 includes lintel and sill, lintel over jambs, and custom panel. The different opening strategies may be used to modify a SIPs panel such that the modified SIPs panel includes a door and/or window. In some embodiments, other strategies may be included with the opening strategies in place of or in addition to those listed, as aspects of the technology described herein are not limited in this respect.

Horizontal connection strategy 660 describes how panels connect to adjacent panels. Horizontal connection strategy includes single spline, double spline, and male-female strategies. In some embodiments, other strategies may be included with the horizontal connection strategies in place of or in addition to those listed, as aspects of the technology described herein are not limited in this respect.

Base connection strategy 662 describes how panels connect to the base underneath the panel. Space connection strategy 662 includes sole and base plate, double base plate, and rail. For example, when rail is selected, the profile of the rail may need to be specified (e.g., the placement of the rail relative to the panel) or omitted completely such that the rail placement does not interfere with the mapping. In some embodiments, other strategies may be included with the base connection strategies in place of or in addition to those listed, as aspects of the technology described herein are not limited in this respect.

Vertical alignment strategy 664 describes the vertical placement of panels. Vertical alignment strategy 664 includes strict, flexible, none. For example, during the mapping of panels to the initial construction project model, the degree of flexibility and the vertical placement of the panels may provide flexibility in the height of panel placement such that various product mappings may be considered with varying degrees of flexibility regarding the vertical alignment of the panels. In some embodiments, other strategies may be included with the vertical alignment strategies in place of or in addition to those listed, as aspects of the technology described herein are not limited in this respect.

Vertical connection strategy 666 describes how panels vertically connect to adjacent panels. Vertical connection strategy 666 includes full height, multiple panels and height, and alternate heights. For example, when using alternate heights, the minimum or maximum overlap between horizontal joints may be an additional input parameter for determining the vertical connections. In some embodiments, other strategies may be included with the vertical connection strategies in place of or in addition to those listed, as aspects of the technology described herein are not limited in this respect.

Costs 634 include panel cost 668, timber plate cost 670, spline cost 672, solid post cost 674. Panel cost 668 describes the material cost for a standard SIP panel. Timber plate cost 670 describes the material cost for each meter of timber plate. Spline costs 672 describes the material cost for each meter of spline. Solid post cost describes the material cost for every meter of solid timber post. In some embodiments, other strategies may be included with the cost strategies in place of or in addition to those listed, as aspects of the technology described herein are not limited in this respect.

FIG. 6E illustrates examples of output attributes for a SIPs schema, in accordance with some embodiments of the technology described herein. Output attributes 675 include common panel outputs 676 associated with the product category schema and SIP specific outputs 677 associated with the product schema.

Common panel outputs 676 associated with the product category schema includes the number of panels placed 678, the number of standard panels 679, the standardization 680, the panel types 681, the custom panels 682, and the material cost 683. The number of panels placed 678 corresponds to the number of SIPs panels used in the project. The number of standard panels 679 corresponds to the number of SIPs panels used as manufactured, without any extra cuts required. The standardization 680 describes the ratio between the number of standard SIPs panels used and the total on the project. Panel types 681 describes the number of unique SIPs panels used in the project. Custom panels 682 describes the number of SIPs panels that need to be cut in shape or size to adapt to the updated construction project model. Material costs 683 corresponds to the cost of materials projected for the project, not including costs such as transportation and/or installation.

SIP specific outputs 677 associated with the product schema include solid posts 684, panel tyles table 685, posts types table 686, splines 687, and spline types table 688. Solid posts 684 describe the number of solid posts used in the project in accordance with structural requirements for the building. Panel types table 685 describes each of the panel types mapped to the construction project model which may be displayed in a table. In some embodiments, the table will include the ID of each panel, count of each panel type, with associated with the panel, height associated with the panel, thickness associated with the panel, and type of shape of the panel. Although described as being displayed in a table, in some embodiments, other display formats may be used, as aspects of the technology described herein are not limited in this respect. Post types table 686 describes, in a table, each of the post types mapped to the construction project model. In some embodiments, the table will include the ID of each post, the count of each post type, the width associated with each post, the length associated with each post, the thickness associated with each post, and the type of shape associated with each post. Although described as being displayed in a table, in some embodiments other display formats may be used, as aspects of the technology described herein are not limited in this respect. Splines 687 describes the number of splines used in the project to facilitate panel connections for the construction project model. Spline types table 688 describes each of the spline types mapped to the construction project model which may be displayed in a table. In some embodiments, the table will include ID of each spline, count of each spline type, the with associated with each spline, the length associated with each spline, the thickness associated with each spline, and the shape associated with each spline. Although described as being displayed in a table, in some embodiments other display formats may be used, as aspects of the technology described herein are not limited in this respect.

In some embodiments, the category schema may be implemented using JSON. For example, a SIPs schema expressed as a JSON schema is show in Table 1 below.

In some embodiments, an instance of a category schema which include attribute values specified for one or more attributes of the category schema is implemented using JSON. For example, an instance of a SIPs schema with values filled in for one or more attributes is shown in Table 2.

TABLE 2
Example of SIPS Schema with Attribute Values

| | |
|---|---|
| 1 | { |
| 2 | “GeometryRequired”: |
| 3 | [ |
| 4 | { |
| 5 | “name”: “centerline”, |
| 6 | “type”: “line” |
| 7 | }, |
| 8 | { |
| 9 | “name”: “elevationProfile”, |
| 10 | “type”: “profile” |
| 11 | } |
| 12 | ], |
| 13 | “Inputs”: |
| 14 | { |
| 15 | “Dimensions”: |
| 16 | { |
| 17 | “Standard height”: [ 2000, 2400 ], |
| 18 | “Standard width”: [ 1200 ], |
| 19 | “Minimum width”: |
| 20 | { |
| 21 | “min”: 100, |
| 22 | “max”: 500, |
| 23 | “multipleOf”: 50 |
| 24 | }, |
| 25 | “Rebate”: |
| 26 | { |
| 27 | “min”: 10, |
| 28 | “max”: 100, |
| 29 | “multipleOf”: 10 |
| 30 | } |
| 31 | }, |
| 32 | “Components”: |
| 33 | { |
| 34 | “Boarding material”: “OSB”, |
| 35 | “Boarding thickness”: [ 11, 15, 18 ], |
| 36 | “Insulation material”: “EPS”, |
| 37 | “Insulation thickness”: [ 100, 125, 150, 200, |
| | 250 ] |
| 38 | }, |
| 39 | “Strategies”: |
| 40 | { |
| 41 | “Design”: “Wall Elevation”, |
| 42 | “Corner”: “Corner overlap”, |
| 43 | “Opening”: “Lintel and Sill”, |
| 44 | “Horizontal connection”: “Single spline”, |
| 45 | “Base connection”: “Rail”, |
| 46 | “Vertical alignment”: “Strict”, |
| 47 | “Vertical connection”: “Full height only” |
| 48 | }, |
| 49 | “Cost”: |
| 50 | { |
| 51 | “Panel cost”: |
| 52 | { |
| 53 | “Unit”: “USD”, |
| 54 | “Value”: 300 |
| 55 | }, |
| 56 | “Timber plate cost”: |
| 57 | { |
| 58 | “Unit”: “USD”, |
| 59 | “Value”: 10 |
| 60 | }, |
| 61 | “Spline cost”: |
| 62 | { |
| 63 | “Unit”: “USD”, |
| 64 | “Value”: 20 |
| 65 | }, |
| 66 | “Solid post cost”: |
| 67 | { |
| 68 | “Unit”: “USD”, |
| 69 | “Value”: 50 |
| 70 | } |
| 71 | } |
| 72 | } |
| 73 | } |

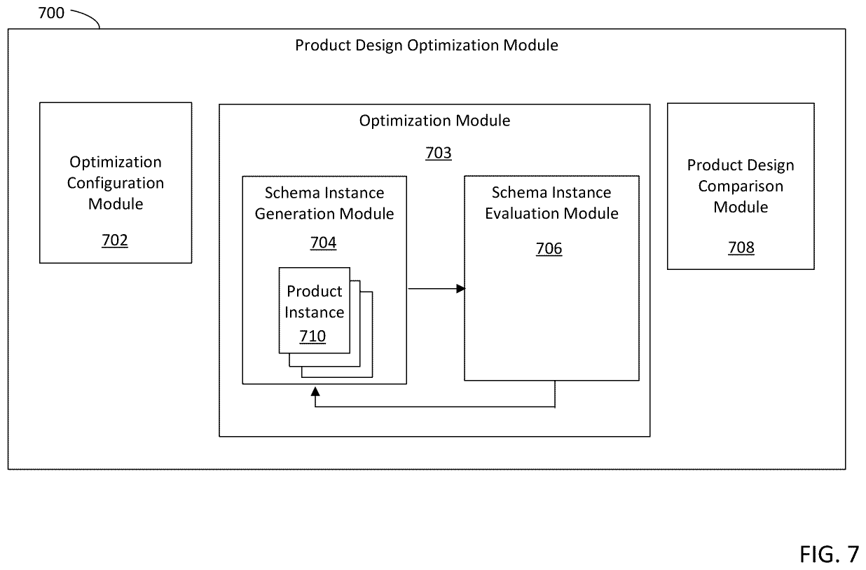

FIG. 7 illustrates product design optimization module 700, in accordance with some embodiments of the technology described herein. Product design optimization module 700 includes optimization configuration module 702, optimization module 703, product design comparison module 708. Optimization module 703 includes schema instance generation module 704 and schema instance evaluation module 706. In some embodiments, optimization configuration module 702, schema instance generation module 704, schema instance evaluation module 706, and product design comparison module 708 may be configured as described in FIG. 1E with reference to product design optimization module 150, which includes corresponding optimization configuration module 193, schema instance generation module 194, schema instance evaluation module 195, and product design comparison module 196.

In some embodiments, optimization module 703 uses a multi-objective optimization solver. As described in connection with FIG. 1E above, the multi-objective optimization solver may be a genetic algorithm. In some embodiments, schema instance generation module 704 generates a population of product instances 710 (e.g., a group of product instances) based on the schema instance. Population of product instances 710 is generated from a schema instance by generating randomized values for input attributes in accordance with the schema instance. The schema instance for a product includes the category input attributes and input from the builder associated with the product. For example, the builder specifies values for the category attributes which are specific to the builder's product and production capabilities. In some embodiments, the product instance further includes input attributes associated with the product schema, which are similarly based on input provided by the builder of the product to indicate the production options for the product.

In some embodiments, the multi-objective optimization solver is a multi-objective optimization using nondominated sorting in genetic algorithms (NSGA). The multi-objective optimization using nondominated sorting in a genetic algorithm is described in Srinivas, N. and Deb, K. “Multiobjective function optimization using nondominated sorting genetic algorithms.” Evolutionary Computation, vol. 2, no. 3, pp. 221-248, Fall 1995, which is incorporated by reference herein in its entirety.

In some embodiments, the multi-objective optimization solver is a multi-objective evolutionary non-dominated Sorting Genetic Algorithm II (NSGA-II). The NSGA-II is described in Deb, K., Pratap, A., Agarwal, S. and Meyarivan, T. “A fast and elitist multiobjective genetic algorithm: NSGA-II. IEEE Transactions on Evolutionary Computation.” April 2002, Vol. 6 (2), pp. 182-197, which is incorporated by reference herein in its entirety.

In some embodiments, the multi-objective optimization solver is an evolutionary many-objective optimization algorithm using a reference-point-based nondominated sorting approach (NSGA-III). The NSGA-III is described in Deb, K. and Jain H. “An Evolutionary Many-Objective Optimization Algorithm Using Reference-Point-Based Nondominated Sorting Approach, Part I: Solving Problems With Box Constraints.” IEEE Transactions on Evolutionary Computation, vol. 18, no. 4, which is incorporated by reference herein in its entirety.

In some embodiments, the multi-objective optimization solver is a generalized differential evolution (GDE3) algorithm. The GDE3 algorithm is described in Kukkonen, S. and Lampinen, J. “GDE3: the third evolution step of generalized differential evolution.” IEEE Congress on Evolutionary Computation, September 2005, Vol. 1, pp. 443-450, which is incorporated by reference herein in its entirety.

In some embodiments, the multi-objective optimization solver is a multi-objective evolutionary algorithm based on decomposition (MOEA/D). The MOEA/D is described in Li, H. and Zhang, Q. “MOEA/D: A Multiobjective Evolutionary Algorithm Based on Decomposition.” IEEE Transactions on Evolutionary Computation, vol. 11 (6), which is incorporated by reference herein in its entirety.

In some embodiments, the designer may provide input values for the input attributes by specifying, from the available input attribute values that a builder has specified for their product, one or more values which may be used in the construction project model. For example, the designer may specify a specific value for input attributes. In this instance, the population of product instances will each be generated to have that specified value for the respective input attribute. With regard to the other input attributes which are not fixed to a specific value, the population of product instances will use a default value. As another example, the designer may specify ranges for one or more of the input attributes. Accordingly, the population of product instances will be generated based on randomized values from among the specified range of values provided by the designer for the product. With regard to any unconstrained product inputs, the population of product instances is generated using a default value(s) specified by the builder for the schema instance.

In some embodiments, the number of product instances to be generated for the population of product instances may be a numeric value specified by the designer. In some embodiments, the number of product instances to be generated for the population of product instances may be a numeric value which is a default value associated with optimization module 703. In some embodiments, the number of product instances to be generated for the population of product instances may be a numeric value selected based on the number of unfixed input attributes.

The population of product instances 710 is applied to a construction project model to generate respective instances of the construction project model. The respective instances of the construction project model are evaluated by the schema instance evaluation module 706. The schema instance evaluation module determines the values for the output attributes associated with each product instance from the population of product instances 710. The schema instance evaluation module evaluates and ranks the outputs based on the values for the output attributes. In some embodiments, schema instance evaluation module 706 may receive input from the designer regarding particular product attributes which should be considered to rank the respective instances of the construction project model for the purposes of optimization. For example, number of panels may be indicated as an output attribute which should be optimized by optimization module 703. The indication to optimize the number of panels may further specify whether the number of panels should be optimized to maximize the number of panels used or to minimize the number of panels used. As another example, the cost associated with producing the product for the construction project may be indicated as an attribute with which to minimize during optimization of the construction project model by the optimization module 703.

After evaluating and ranking the outputs produced from the first population of product instances, a new population of product instances is generated by combining inputs (e.g., introducing mutations into the genetic algorithm) that were associated with the highest ranked outputs. The generation of populations of product instances followed by evaluation of the population of product instances may be repeated iteratively according to an integer number of iterations (e.g., a number of generations for a genetic algorithm). In some embodiments, the number of iterations may be selected by the designer. In some embodiments, the number of iterations may be a predetermined number of iterations associated with the optimization module. In some embodiments, the number of iterations may be based on the convergence of the outputs towards an optimized solution.

In some embodiments, the number of iterations may be treated as an upper limit such that if it is determined that the output is not changing by at least a threshold amount between iterations (e.g., generations) then the optimization will conclude prior to the upper limit of iterations.

In some embodiments, product design comparison module 708 may then be used to compare optimizations of the construction project model based on different products for which the model was optimized. For example, the optimized construction project model generated based on a first product may be compared to the optimized construction project model generated based on a second product to determine which product would minimize the cost of the construction project.

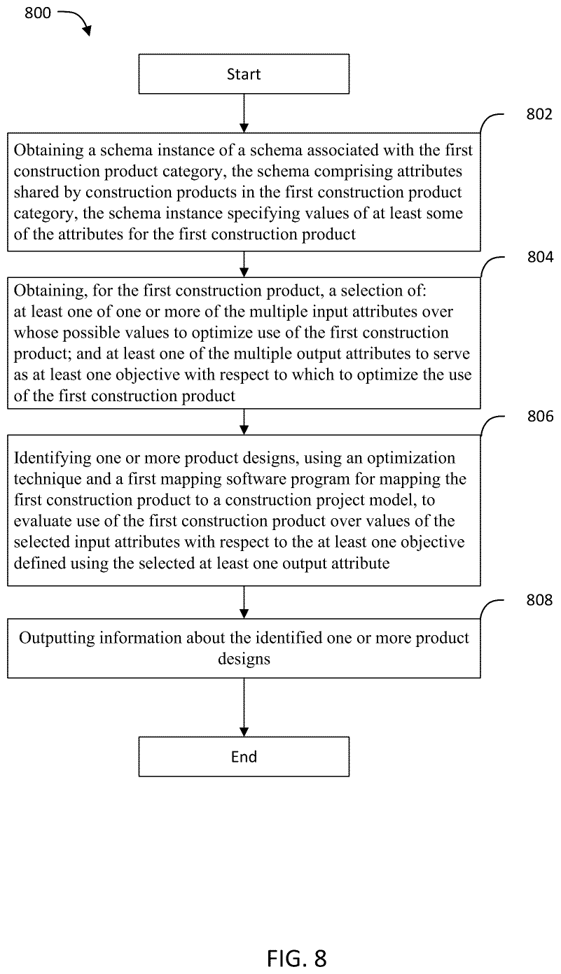

FIG. 8 illustrates a flowchart of process 800 for using optimization to evaluate use of one or more construction products in a construction project, in accordance with some embodiments of the technology described herein. Process 800 may be executed by any suitable computing device(s), as described herein.

Process 800 starts at act 802, by obtaining a schema instance of a schema associated with the first construction product category, the schema including attributes shared by construction products in the first construction product category, the schema instance specifying values of at least some of the attributes for the first construction product. The attributes associated with the construction product category include multiple input attributes and multiple output attributes.

In some embodiments, the construction product category is a boarding, solid wall panels, structural insulated panels, concrete insulated panels, closed framed panels, open framed panels, twin wall, concrete lattice floor, hollow core, solid floor, façade, structural frame, roof panel, roof truss, stairs, plant, balcony, pod, or module category.

In some embodiments, the input attributes include product dimension attributes, product component attributes, product arrangements attributes, and product pricing attributes. The product dimension attributes describe the size of the product. For example, the dimension attributes include height, width, and length attributes. The product component attributes include components and/or subcomponents associated with the construction and/or assembly of the product. The product arrangement attributes include layers (e.g., for multilayered products), rules governing how the product is arranged with respect one or more other instances of the product, parameters related to the arrangement of the product with respect to one or more other instances of the product and/or with respect to elements of the construction model. The product pricing attributes described options impacting the cost of the product.

In some embodiments, the input attributes include quantity attributes, cost attributes, environmental/sustainability attributes, performance metrics attributes, material aspects attributes. For example, environmental/sustainability attributes may include embodied carbon, emissions, and/or lifecycle carbon. For example, performance metrics attributes may include sound, thermal insulation, transmittance values, fire resistance, and/or heat/electric energy consumption/requirements. For example, material aspects attributes may include color, finish, material, texture, and/or transparency. In some embodiments, other input attributes and/or groups of input attributes may be included with the category schema, as aspects of the technology described herein are not limited in this respect. Input attributes are discussed further in connection with FIG. 6A-6E.

In some embodiments, the schema instance specifies values of at least some of the attributes for the first construction product includes multiple input attributes. The multiple input attributes include a first input attribute, and the schema instances specifies at least one continuous range of possible values for the first input attribute. In some embodiments, the continuous range of possible values may be limited to a set manufacturing limit. For example, a set manufacturing limit may limit the continuous range of possible values to values corresponding to the nearest inch. As another example, a set manufacturing limit may limit the continuous range of possible values to values corresponding to the nearest inch. Other manufacturing limitations may be imposed on the continuous range of possible values, as aspects of the technology described herein are not limited in this respect.

In some embodiments, the schema instance specifies values of at least some of the attributes for the first construction product includes multiple input attributes. The multiple input attributes include a first input attribute, and the schema instances specifies at least one a discrete set of possible values for the first input attribute. In some embodiments, the discrete set of possible values may be a set of values including a maximum value, a minimum value, and an increment step size between the maximum value and the minimum value. The step size may be linear or non-linear as aspects of the technology described herein are not limited in this respect. In some embodiments, the discrete set of possible values may be a set of values specifically enumerated by a builder of the product.

In some embodiments, the output attributes include attributes shared by products in the category. For example, in a panel category, the output attributes may include number of panels. In some embodiments, the input attributes may also be used as output attributes. For example, output attributes may include quantity attributes, cost attributes, environmental/sustainability attributes, performance metrics attributes, material aspects attributes. In some embodiments, other output attributes and/or groups of output attributes may be included with the category schema, as aspects of the technology described herein are not limited in this respect. Output attributes are discussed further in connection with FIG. 6A-6E.

Next, process 800 proceeds to act 804 by obtaining, for the first construction product, a selection of: at least one or more of the multiple input attributes over whose possible values to optimize use of the first construction product; and at least one of the multiple output attributes to serve as at least one objective with respect to which to optimize the use of the first construction product, in accordance with some embodiments of the technology described herein.

In some embodiments, obtaining a selection of attributes over which to optimize includes presenting a listing of at least some of the one or more of the multiple input attributes, and receiving the selection of the at least one or the one or more multiple input attributes over whose possible values to optimize use of the first construction product. The presenting and receiving of the multiple input attributes may be executed via a GUI, such as the GUIs described herein.

In some embodiments, obtaining a selection of attributes over which to optimize includes presenting a listing of at least some of the multiple output attributes and receiving the selection of the at least one of the multiple output attributes to serve as at least one objective with respect to which to optimize the use of the construction product. The presenting and receiving of the output attributes over which to optimize may be executed via a GUI, such as the GUIs described herein.

Next, process 800 proceeds to act 806 by identifying one or more product designs, using an optimization technique and a first mapping software program for mapping the first construction product to a construction project model, to evaluate use of the first construction product over values of the selected input attributes with respect to the at least one objective defined using the selected at least one output attribute, in accordance with some embodiments of the technology described herein. In some embodiments, performing act 806 may include performing process 200.

In some embodiments, the optimization technique is a multi-objective genetic optimization technique. For example, the optimization technique may be a NSGA, NSGA-II, NSGA-III, GDE3, MOEA/D technique, as described herein. In some embodiments, other optimization techniques may be used, as aspects of technology described herein are not limited in this respect.

In some embodiments, the optimization technique is a multi-objective genetic optimization technique that includes generating P populations of input values, each of the P populations of input values specifying an initial set of input values for the selected input attributes, wherein P is an integer greater than 1 that represents the number of the populations; generating multiple product designs by, for each particular population of the P populations, executing the first mapping software program configured with the particular population of the input values to obtain a respective product design; scoring the generated multiple product designs using the at least one objective with respect to which to optimize use of the first construction product to obtain a plurality of scores; and generating a new set of P populations of input values from the P populations of input values and the plurality of scores. In some embodiments, generating each instance of the population P may be executed in parallel and in isolation from the other instances, such that the overall process receives and compiles the results from the execution of the independent populations instances.

Next, process 800 proceeds to act 808 by outputting information about the identified one or more product designs, in accordance with some embodiments of the technology described herein. In some embodiments, outputting information about the identified one or more product designs includes outputting values of one or more of the output attributes determined for each of the one or more product designs.

Following act 808, process 800 concludes.

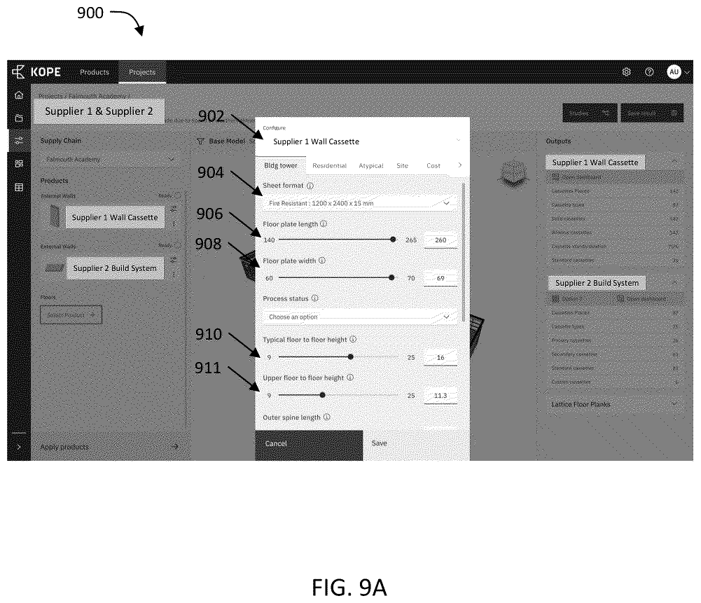

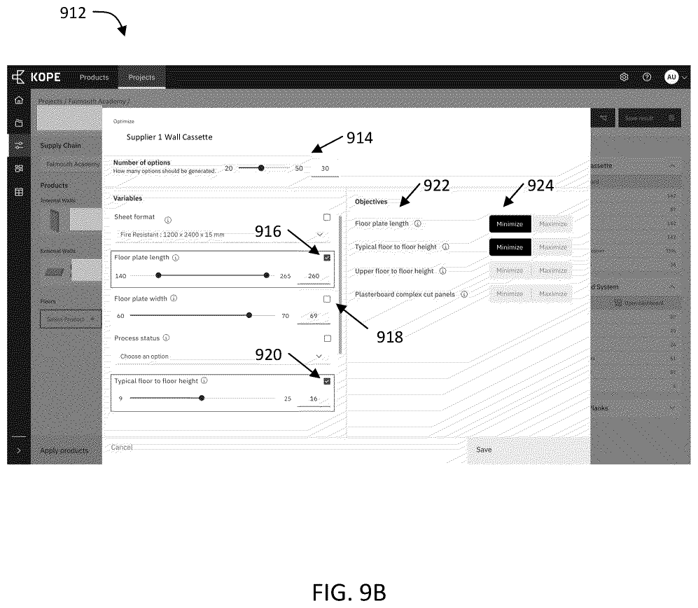

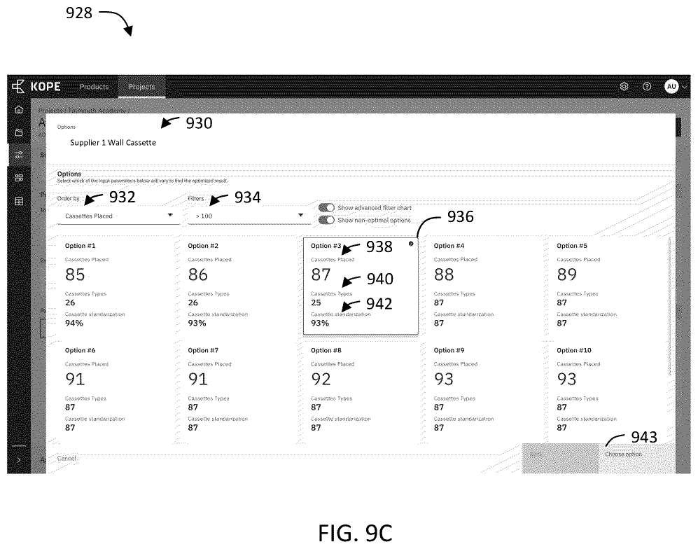

FIG. 9A illustrates GUI 900 for specifying values for inputs not used in the optimization process, in accordance with some embodiments described herein. GUI 900 includes a window for selecting one or more multiple input attributes for product 902. Product type attribute 904 specifies the type of panel. In the illustrated example, a fire-resistant sheet with standard dimensions of 1200 mm by 2400 mm by 15 mm is selected. The floor plate length input attribute is selected by slider 906 to specify a range of values over which the floor plate length may vary. The floor plate width input attribute is selected by slider 908 to specify a range of values over which the floor plate width may vary. The typical floor to floor height attribute is selected by slider 910 to specify a range of values over which the floor-to-floor height may vary. The upper floor to floor height input attribute is selected by slider 911 to specify a range of values over which the upper floor to floor height may vary.

FIG. 9B illustrates GUI 912 for obtaining a selection of one or more attributes for use as an objective with respect to which to optimize the construction product, in accordance with some embodiments described herein. As shown in FIG. 9B, GUI 912 includes control elements for selecting parameters for the optimization process. Population slider 914 specifies the number of product instances to be generated in the population of product instances for use by the optimization model. To select which product attributes over which to optimize, checkboxes are included in GUI 912. Upon selecting the checkbox corresponding to a particular product attribute, that product attribute is added as an input attribute to vary/optimize. In some embodiments, selection of a particular product attribute will add the product attribute to an optimization list. In the illustrated example of FIG. 9B, the floor plate length and typical floor to floor height are each selected as product attributes for optimization through the selection of check box 916 and 920, respectfully. Floor plate length and typical floor height appear in the list of objectives for optimization 922 while floor plate width objectives Upper floor to floor height and Plasterboard complex cut panels do not have Minimize or Maximize selected using control 924. The list of objectives for optimization 922 further includes control elements to select rules to indicate a particular optimization condition for the product attribute. Optimization list 922 includes control elements 924. For example, control elements 924 may be used to specify whether to seek to maximize or minimize parameters for the optimization. As shown in FIG. 9B, floor plate length and typical floor to floor height are both selected as attributes to seek to minimize during optimization.

FIG. 9C illustrates a GUI 928 for showing a designer the results of the optimization, in accordance with some embodiments of the technology described herein. GUI 928 shows a summary of the output attributes associated with specific product instances generated during the optimization. GUI 928 specifies product 930 for which the optimization was executed. Dropdown selection 932 provides a selection of a product attribute with which to order the product instances. Dropdown selection 934 provides a section of filters to apply to reduce the number of product instances displayed. For each product instance displayed on GUI 928, one or more output attributes are shown. For example, product instance 936 corresponds to the third option shown on GUI 928.

Returning to the discussion of FIG. 9C, dropdown selection 932 is set to the “cassettes placed” attribute. Accordingly, the ten product instances shown are arranged in ascending order of values for the cassettes placed attribute. Product instance 936 includes product attributes 938, 940, and 942 corresponding to cassettes placed, cassette types, and cassettes standardization-respectively. Accordingly, upon review of the output attributes associated with the population of product instances, a designer may select an option for inclusion with the construction project model by selecting the corresponding option and then confirming the selection with control element 943.

FIG. 10A illustrates a mapping between construction product categories and a configurable computational pipeline, in accordance with some embodiments of the technology described herein. As shown in FIG. 10A construction product category A 1001 and construction product category B 1002 are part of the same construction product category group 1000. Based on the construction product category, a mapping software program identifies a configurable computational pipeline 1005 for applying a product instance of the construction product category to an initial construction project model. Upon identifying a product is in product category A, mapping software program for product category A maps software portions associated with product category A to the shared configurable computational pipeline 1005. Similarly, upon identifying a product is in product category B, mapping software program for product category B maps software portions associated with product category B to the shared configurable computational pipeline 1005.

For example, the construction product category group 1000 may be a vertical solid layered group. Accordingly, construction product category A may correspond to the SIPS category and construction product category B may correspond to the CIP category. As shown in FIG. 10A, both the SIPS category and the CIP category are members of the vertical solid layered group. Upon identifying a product is in the SIPS product category, mapping software program for product category A maps software portions associated with the SIPS product category to the shared configurable computational pipeline 1005. Upon identifying a product in the CIP product category, mapping software program for category B maps software portions associated with the CIP product category to the shared configurable computational pipeline 1005.

FIG. 10B illustrates a mapping between construction product categories and multiple configurable computational pipelines, in accordance with some embodiments the technology described herein. As shown in FIG. 10B, construction product category group 1006 includes construction product category A 1008, and a second construction product category group 1007 includes construction product category group B 1009. Mapping software program for product category A 1010 maps software portions associated with product category A to a configurable computational pipeline for construction product category group A 1012. In contrast to the mapping software programs shown in FIG. 10A, mapping software program for product category B 1011 maps software portions associated with product category B to a second configurable computational pipeline for construction product category group B.

For example, construction project group 1006 may be a vertical solid layered group, and construction project group 1007 may be a horizontal composite group. Accordingly, construction product category A may be a SIPS category and construction product category B may be a concrete lattice floor (CLF) category. Upon identifying a product is in the SIPS product category, mapping software program for product category A 1010 maps software portions associated with the SIPS product category to the configurable computational pipeline 1012. Upon identifying a product in the CLF product category, mapping software program for category B 1011 maps software portions associated with the CLF product category to the configurable computational pipeline 1013.

FIG. 10C illustrates construction product mapping module for mapping multiple construction products to a configurable computational pipeline, in accordance with some embodiments of the technology described herein. Construction product mapping module 1014 includes construction product schema instances 1015, software code portion library 1016, pipeline configuration module 1023, and configurable computational pipeline 1026.

Construction product schema instances 1015 includes a schema instance for a first construction product on 1017 and a schema instance for a second construction product 1018. In some embodiments, the schema instances for the first and second product are products which have been identified by a designer for mapping to an initial construction project design. As described herein, the schema instances for the construction products are based on the category schema associated with the construction product and specified parameters from the builder who supplies the product. The specified parameters represent construction options which may be accommodated by the builder's facilities.

Pipeline configuration module 1023, in response to the category of the first construction product 1017 identifies a set of code portions for the first construction product 1024. Additionally, in response to the category of the second construction product 1015, pipeline construction module 1023 identifies a set of code portions for the second construction product 1025. Through communication with the software code portion library 1016, the pipeline configuration module 1023 receives code portions associated with the first product category 1019 for use with the first construction product and code portions associated with a second construct from product category 1020 for use with the second construction product. Pipeline configuration module 1023 configures the first set of code portions 1024 for mapping the first construction product to the initial construction project model and configures the second set of code portions 1025 for mapping the second construction product to the initial construction project model.

Following configuration from the pipeline configuration module 1023, the configurable computational pipeline 1026 includes first construction product pipeline 1027 and second construction product pipeline 1028. In some embodiments, the second construction product pipeline 1028 is configured to apply the second construction product to the output from the first construction product pipeline 1027. Accordingly, the output of the configurable computational pipeline is an updated construction project model.

In some embodiments the second construction product pipeline 1028 is configured to apply the second construction product to the initial construction project model to create an instance of the construction project model separate from the instance created by the 1st construction product pipeline 1027. Accordingly, such a configuration would produce 2 intermediate construction project models, one corresponding to each of the first and second construction products.

The output construction project model(s) from the configurable computational pipeline 1026 are processed by schema instance evaluation module 1027 to generate values for the output attributes associated with the category of the first construction product as specified by the first construction product schema outputs 1030. The output construction project model(s) is further processed to generate values for the output attributes associated with the category of the second construction product as specified by the second construction product schema outputs 1031.

Product design comparison module 1032 includes the building model 1033 and schema metrics 1034. In some embodiments building model 1033 is a three-dimensional model of the building including the first construction product and the second construction product as applied to the initial construction project model to generate the updated construction project model. Schema metrics 1034 include the output attributes determined by schema instance evaluation module 1029.

In some embodiments, the pipeline configuration module may be a software wrapper that organizes the input and output attributes as JSON objects for the configurable computational pipeline. The wrapper may initialize and run the configurable computational pipeline to map the product to the construction project model. An example of a wrapper for configuring and executing a configurable computational pipeline is shown below in Table 3.

TABLE 3
Computation Pipeline Configuration and Execution

| | |
|---|---|
| 1 | namespace kope.Frameworks.LayeredPanels |
| 2 | { |
| 3 | public class LayeredPanelsActivity |
| 4 | { |
| 5 | [kopeActivity] |
| 6 | public static CommonLayeredPanelOutputs SipsPanels( |
| 7 | IActivityContext activityContext, |
| 8 | [FileParameter(“.json”)] |
| 9 | FileInfo kopeModel, |
| 10 | DimensionInputs dimensions, |
| 11 | SipsComponentsInputs components, |
| 12 | StrategiesInputs strategies, |
| 13 | CostInputs cost |
| 14 | ) |
| 15 | { |
| 16 | var model = |
| | KopeModel.FromJson(File.ReadAllText(kopeModel.FullName)); |
| 17 | var framework = new SipsPanelsFramework(strategies, |
| | components, dimensions, cost, activityContext); |
| 18 | var result = framework.Run(model); |
| 19 | return result; |
| 20 | } |
| 21 | } |
| 22 | } |

Table 4 below shows an example of a configured computational pipeline, in accordance with some embodiments of the technology described herein.

TABLE 4
Configurable Computational Pipeline

| | |
|---|---|
| 1 | using kope.Elements; |
| 2 | using kope.Elements.Abstractions; |
| 3 | using kope.Elements.Serialisation.Extensions; |
| 4 | using kope.Frameworks.Core; |
| 5 | using kope.Frameworks.LayeredPanels.Elements; |
| 6 | using kope.Frameworks.LayeredPanels.Elements.Creators; |
| 7 | using kope.Frameworks.LayeredPanels.Models; |
| 8 | using kope.Workflows.SDK; |
| 9 | |
| 10 | namespace kope.Frameworks.LayeredPanels.Sips |
| 11 | { |
| 12 | public partial class SipsPanelsFramework |
| 13 | { |
| 14 | private readonly IActivityContext_activityContext; |
| 15 | private ILayeredPanelCreator_panelCreator; |
| 16 | private object_cornerStrategy; |
| 17 | private object_openingStrategy; |
| 18 | private object_horizontalConnectionsStrategy; |
| 19 | private object_baseConnectionStrategy; |
| 20 | private object_verticalAlignmentStrategy; |
| 21 | private object_verticalConnectionsStrategy; |
| 22 | |
| 23 | public SipsPanelsFramework( |
| 24 | StrategiesInputs strategies, |
| 25 | SipsComponentsInputs components, |
| 26 | DimensionInputs dimensions, |
| 27 | CostInputs cost, |
| 28 | IActivityContext activityContext) |
| 29 | { |
| 30 | _panelCreator = new SipsPanelCreator( |
| 31 | new |
| | PanelLayer(components.BoardingMaterial.ToMaterial( ), |
| | components.Boarding Thickness), |
| 32 | new |
| | PanelLayer(components.InsulationMaterial.ToMaterial( ), |
| | components.Insulation Thickness)); |
| 33 | |
| 34 | _activityContext = activityContext; |
| 35 | ConfigureDefaultStrategies(strategies); |
| 36 | } |
| 37 | |
| 38 | public CommonLayeredPanelOutputs Run(KopeModel |
| | inputModel) |
| 39 | { |
| 40 | var resultModel = new KopeModel( ); |
| 41 | |
| 42 | // Implement logic for the framework here: |
| 43 | // Create input elements for this framework these |
| | elements |
| 44 | // are specefic instances that holds all information needed |
| 45 | // to run the logic. |
| 46 | IEnumerable<ProfileElevationElement> inputElements = |
| | CreateInputElements(inputModel.Instances. Values); |
| 47 | |
| 48 | var panels = HandleCorners(inputElements) |
| 49 | .Then(HandleStructuralBreaks( )) |
| 50 | .Then(HandleMaxwidths( )) |
| 51 | .Then(HandleOpenings( )) |
| 52 | .Then(SubDivide Walls( )) |
| 53 | .Then(HandleHorizontalConnections( )) |
| 54 | .Then(HandleBaseConnections( )) |
| 55 | .Then(HandleVerticalAlignment( )) |
| 56 | .Then(HandleVerticalConnection( )) |
| 57 | .Then(PlacePanelInstancesOnProfiles(_panelCreator)); |
| 58 | |
| 59 | var resultModelFile = new |
| | FileInfo(Path.Combine(_activityContext.CurrentDirectory, |
| | “resultKopeModel.json”)); |
| 60 | File.WriteAllText(resultModelFile.FullName, |
| | resultModel.ToJson( )); |
| 61 | |
| 62 | return new CommonLayeredPanelOutputs |
| 63 | { |
| 64 | ResultModel = resultModelFile, |
| 65 | }; |
| 66 | } |
| 67 | |
| 68 | private IEnumerable<ProfileElevationElement> |
| | CreateInputElements(IEnumerable<IElementInstance> |
| | instances) |
| 69 | => instances.Select(instance => |
| | ProfileElevationElement.FromElementInstance(instance)); |
| 70 | |
| 71 | private void ConfigureDefaultStrategies(StrategiesInputs |
| | strategies) |
| 72 | { |
| 73 | // Based on the desired strategies in the input |
| 74 | // map each strategy to the right implementation (blank in |
| | this example) |
| 75 | |
| 76 | _cornerStrategy = new object( ); |
| 77 | _openingStrategy = new object( ); |
| 78 | _horizontalConnectionsStrategy = new object( ); |
| 79 | _baseConnectionStrategy = new object( ); |
| 80 | _verticalAlignmentStrategy = new object( ); |
| 81 | _verticalConnectionsStrategy = new object( ); |
| 82 | } |
| 83 | |
| 84 | // example of what each of the “Handle” methods would |
| | look like |
| 85 | // each of them basically use the mapped strategy |
| | implementation to further process the elements |
| 86 | private IEnumerable<ProfileElevationElement> |
| | HandleCorners(IEnumerable<ProfileElevationElement> |
| | inputElements) |
| 87 | { |
| 88 | var linearElements = |
| | CreateInputElements(inputElements) |
| 89 | var solvedLinearJoints = |
| | _cornerStrategy.Run(linearElements); |
| 90 | var solvedLinearElements = |
| | solvedLinearJoints.GetLinearElements( ); |
| 91 | |
| 92 | return UpdateInputElements(solvedLinearElements, |
| | inputElements); |
| 93 | } |
| 94 | } |
| 95 | } |

FIG. 10D illustrates a pipeline configuration module 1042 part of the construction product mapping module illustrated in FIG. 10C, in accordance with some embodiments of the technology described herein.

Pipeline configuration module 1042 receives a schema instance for a first construction product 1017 from the construction products schema instances 1015, As described above in connection with FIG. 10C. The received schema instance for the first construction product 1017 includes attributes associated with the product category. In some embodiments, the schema instance may include selections of specific values for the attributes which have been chosen by a designer. For example, the designer may choose a specific value for an attribute. As another example, the designer may choose a range of values for an attribute. In some embodiments, the schema instance may include default values associated with the product category to be used in the absence of designer input. In some embodiments, this schema instance may only permit a fixed value for a particular attribute as specified by the supplier's design capabilities. In the illustrated example of FIG. 10D, the schema instance for the first construction product 1017 includes first attribute value 1036 for a first input attribute and multiple second attribute values 1037 for a second input attribute.

In some embodiments, the attribute values are used as inputs to code portions during mapping by the configurable computational pipeline. In some embodiments, the attribute values may be used to select which code portion of multiple code portions associated with the product category to use in the configurable computational pipeline.

In response to the category of the schema instance for the first construction product 1017, the pipeline configuration module 1042 receives code portions associated with the first product category 1038 from a code portion library, such as the code portion library shown in FIG. 10C. The code portions associated with the first product category 1038 include code portion 1 1039, code portion 2 1040, code portion N 1041. In some embodiments, each code portion associated with the product category will be retrieved by the pipeline configuration module 1042. In some embodiments, a subset of the code portions associated with the product category will be retrieved by the pipeline construction module 1042, the subset corresponding to the code portions for executing a mapping between the product and the initial construction project model.

Pipeline configuration module 1042 receives code portion 1 1039, code portion 2 1040, and code portion N 1041 from the code portions associated with a first product category 1038. In some embodiments, pipeline configuration module 1042 may receive additional code portions corresponding to one or more additional construction products. For example, pipeline configuration module 1042 may receive additional code portions associated with a schema instance for a second construction product.

Pipeline configuration module 1042 configures the code portions for the configurable computational pipeline, in accordance with some embodiments of the technology described herein. Configuring the code portions for the configurable computational pipeline may include configuring an order of execution for the code portions and/or configuring input parameters based on the schema instance attributes for the configurable computational pipeline 1046.

Once configured, configurable computational pipeline 1046 includes a first construction product pipeline 1047 which is associated with the schema instance for the first construction product 1017 and includes the code portions retrieved and configured by the pipeline configuration module 1042. As shown in the illustrated example of FIG. 10D, the pipeline configuration module 1042 has ordered the code portions sequentially starting from code portion 1 1039, proceeding to code portion 2 1040, and further proceeding until concluding with code portion N 1041. In some embodiments, the portions may correspond to respective construction steps. Accordingly, the ordering of the code portions may correspond to the order in which assembly of the construction product should proceed. Therefore, pipeline configuration module 1042 may configure the order of code portions based on a determined sequence of assembly and/or construction steps. The configurable computational pipeline 1046 may include additional construction product pipelines configured to be executed subsequent to the first construction product pipeline 1047. It should be appreciated that the first construction product pipeline 1047 could be a graph (e.g., a directed acyclic graph) and is not limited to a linear sequence of code portions.

FIG. 10E illustrates an example of a pipeline configuration module for mapping code portions associated with an example product category to a configurable computational pipeline, in accordance with the construction product mapping module shown in FIG. 10D. As shown in the illustrated example of FIG. 10E, the product category is a SIPs product category. The pipeline configuration module 1042 receives SIPs category attribute 1054 which specifies that an opening strategy 1053 of lintel and sill should be used in the product mapping of the product to the initial construction project model. Pipeline configuration module 1042, in response to the category of the schema instance, retrieves code portions associated with the product category from a datastore. As shown in the illustrated example of FIG. 10E, the product category is a SIPs category and the pipeline configuration module retrieves code portions associated with the SIPs category 1051. Code portions associated with the SIPs category 1051 include a grouping of code portions corresponding to different strategies for creating an opening in a SIPs panel 1043. The opening strategy code portions 1043 includes a code portion 1055 for creating an opening using an opening centered panel builder, a code portion 1026 for creating an opening using a lintel and jambs, and a code portion 1057 for creating an opening using a lintel and sill.

In response to attribute 1053, specifying a lintel and sill opening strategy, pipeline configuration module 1042 retrieves the SIPs lintel and sill opening code portion 1057. The pipeline configuration module 1042 configures the lintel and sill opening code portion 1057 as part of the configurable computational pipeline. As shown in the illustrated example, pipeline configuration module 1042 configures the SIPs lintel and sill opening code portion 1057 to be executed by the configurable computational pipeline 1046 after a corner mapping code portion 1059 and prior to subsequent code portion 1058, which has yet to be configured.

FIG. 10F illustrates an example mapping between product categories and configurable computational pipelines, in accordance with some embodiments of the technology described herein. The mapping between product categories and the configurable computational pipeline 1044 includes groups of categories 1061, configurable pipelines 1062 associated with one or more categories, and categories 1063. In some embodiments, the groups of categories may be organized by building component. In some embodiments, the groups of categories may be organized by function. In some embodiments, the groups of categories may be grouped according to whether or not they have one or more shared code portions for mapping products from the respective categories to a construction project. As shown in the illustrated example of FIG. 10F, groups of categories include walls 1064, floors 1065, façades 1066, frames 1067, roofs 1068, stairs 1069, plants 1070, balconies 1071, and modules 1072.

The configurable pipelines 1062 include configurable pipelines for vertical solid products 1073, vertical solid layered products 1074, vertical composite products 1075, horizontal composite products 1076, horizontal solid products 1077, façade products 1078, 3D structural frame products 1079, non-planar products 1080, assembly products 1081, and volume products 1082.

The wall group of categories 1064 includes vertical solid products configurable pipelines 1073, vertical solid layered products configurable pipeline 1074, and vertical composite products configurable pipelines 1075. Each of the configurable pipelines include one or more product categories. For example, vertical solid products configurable pipeline 1073 is associated with categories 1083a corresponding to a boarding category and a solid wall panel category. Vertical solid layer products configurable pipeline 1074 is associated with categories 1083b corresponding to a structural insulated panel category and a concrete insulated panel category. Vertical composite products configurable pipeline 1075 is associated with categories 1083c corresponding to a closed framed panel category, open framed panel category, and a twinwall category.

Similarly, the floor group of categories 1065 includes horizontal composite products configurable pipeline 1076, horizontal solid products configurable pipeline 1077. The horizontal composite products configurable pipeline 1076 is associated with a concrete lattice floor category and a hollowcore category. The horizontal solid configurable pipeline 1077 is associated with a solid floor category.

The façades group of categories 1066 is associated with the façades configurable pipeline and the façades group of categories includes the façade category 1085. The frame group of categories 1067 is associated with the 3D structural frame configurable pipeline 1079 and the frame group of categories 1067 includes the structural frame category 1086. The roofs group of categories 1068 is associated with the non-planar configurable pipeline 1080 and the roofs group of categories includes roof categories 1087. Roof category 1087 includes roof panel categories and roof truss categories. The modules group of categories 1072 is associated with volumes configurable pipeline 1082 and the modules group of categories includes module categories 1089. The module categories 1089 include pod categories and module categories.

In some embodiments, a configurable pipeline may be configured to map products from multiple groups of product categories to a construction model. As shown in FIG. 10F, the configurable pipeline for assemblies 1081 may be configured to map products from the stair groups of categories, the plant group of categories, and the balcony group of categories to a construction model. For example, stair category 1088a, plant category 1088b, and balcony category 1088c may each be associated with the configurable pipeline for assemblies 1081, despite being members of the stair groups of categories, the plant group of categories, and the balcony group of categories-respectively.

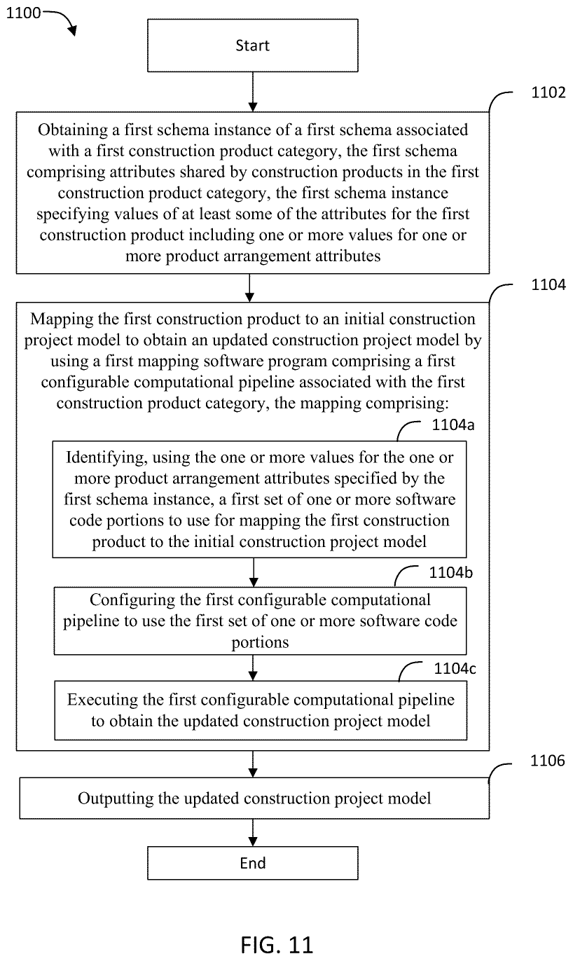

FIG. 11 is a flowchart of an illustrative process 1100 for evaluating use of one or more construction products in a construction project, the one or more construction products including a first construction product in a first construction product category, in accordance with some embodiments of the technology described herein.

Process 1100 starts at act 1102 by obtaining a first schema instance of a first schema associated with a first construction product category, the first schema comprising attributes shared by construction products in the first construction product category, the first schema instance specifying values of at least some of the attributes for the first construction product including one or more values for one or more product arrangement attributes, in accordance with some embodiments of the technology described herein.

In some embodiments, the construction product category is a boarding, solid wall panels, structural insulated panels, concrete insulated panels, closed framed panels, open framed panels, twin wall, concrete lattice floor, hollow core, solid floor, façade, structural frame, roof panel, roof truss, stairs, plant, balcony, pod, or module category.

In some embodiments, the product arrangement attributes include one or more of a design handling attribute, a corner handling attribute, an opening handling attribute, a horizontal connection attribute, a vertical connection attribute, a base connection attribute, a vertical alignment attribute, or a horizontal alignment attribute.

In some embodiments, the product arrangement attributes include one or more of an adjacency attribute, a patterning attribute, a build-up attribute, a directional layout attribute, an interface attribute, a perimeter framing attribute, a zone framing attribute, an opening framing attribute, a hollow zone attribute, a variable space sizing attribute, an edge treatment attribute, or an edge cute attribute. For example, an adjacency attribute may specify which types of produces may be placed next to other types of products. As another example, a patterning attribute may specify non-grid subdivisions and the pattern arrangement of products. As another example, a build-up attribute may specify whether a topping layer is included and/or a type of layer (e.g., solid, hollowed, lattice, profile, pre-tensioned, deck profile). As another example, a directional layout attribute may specify unidirectional, bidirectional, multi-directional, radial, or perimeter layouts. As another example, an interface attribute may specify, how interfaces or connections between two products of the same or different categories are handled. As another example, a perimeter framing attribute specifies how to handle the framing of the perimeter of an area. As another example, a zone framing attribute may specify the framing inside an area. As another example, an opening framing attribute may specify how to handle the framing of an opening. As another example, a hollow zone framing attribute may specify how to handle the shape, layout, and position of hollow zones inside an otherwise solid element. As another example, a variable space sizing attribute may specify how to select the appropriate size of a spacing zone between elements/layers. As another example, an edge treatment attribute may specify how to handle the orientation of a cute of the edge of an element.

Next, process 1100 proceeds to act 1104 by mapping the first construction product to an initial construction project model to obtain an updated construction project model by using a first mapping software program comprising a first configurable computational pipeline associated with the first construction product category, in accordance with some embodiments of the technology described herein.

Construction products belong to construction product categories. In some embodiments, construction product categories belong to construction product category groups. Each of the construction product category groups is associated with a respective configurable computation pipeline for mapping construction products in the construction product category group to construction project models.

In some embodiments, the construction product category groups include a first construction product category group associated with a first configurable computational pipeline. The first construction product category group includes the first construction product category and a second construction product category, where the second construction product category includes a second construction product. Accordingly, a mapping of the second construction product to the construction project model uses a second mapping software program that includes the computational pipeline associated with the first construction product category group.

Act 1104 starts at sub-act 1104a by identifying, using the one or more values for the one or more product arrangement attributes specified by the first schema instance, a first set of one or more software code portions to use for mapping the first construction product to the initial construction project model.

Act 1104 proceeds to sub-act 1104b by configuring the first configurable computational pipeline to use the first set of one or more software code portions.

Act 1104 proceeds to sub-act 1104c by executing the first configurable computational pipeline to obtain the updated construction project model.

Next process 1100 proceeds to act 1106 by outputting the updated construction project model.

Following act 1106, process 1100 concludes.

In some embodiments, code portions are single-purpose code libraries that encode a single domain process, in accordance with some embodiments of the technology described herein. Code portions may be organized into three functional groups, for example, a modeling group, an interface group, and a strategy group.

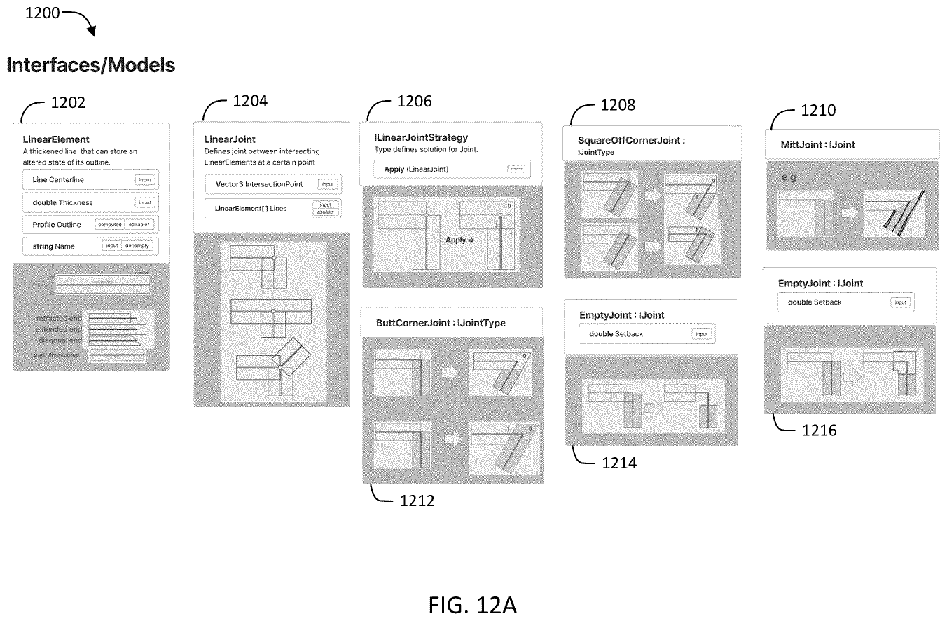

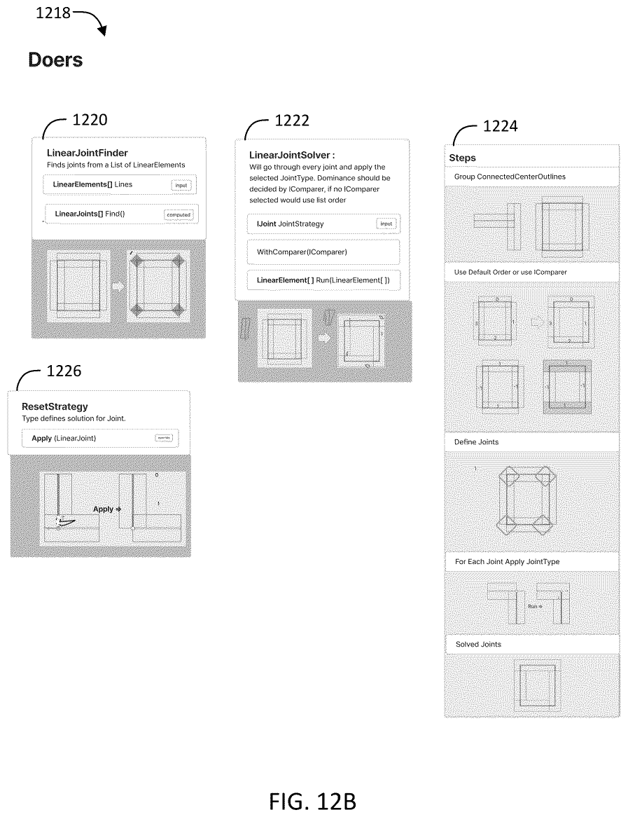

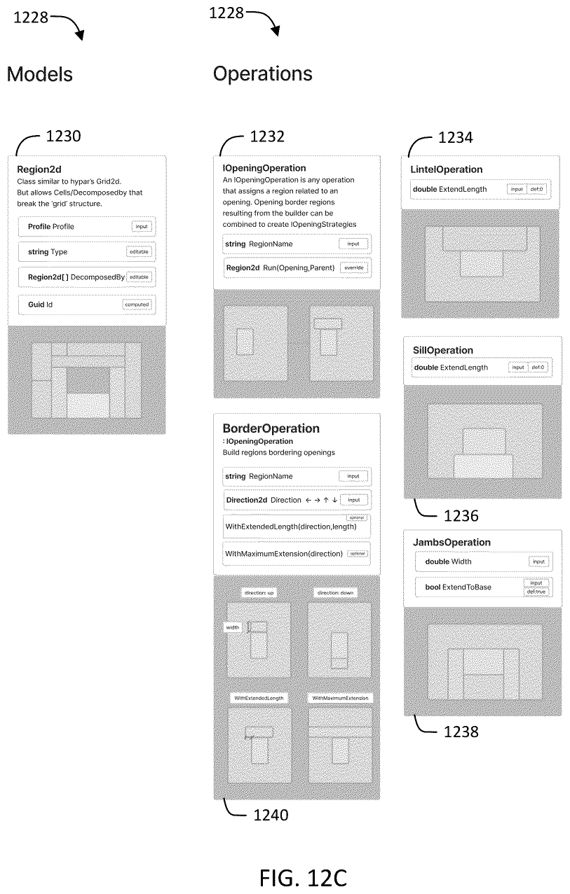

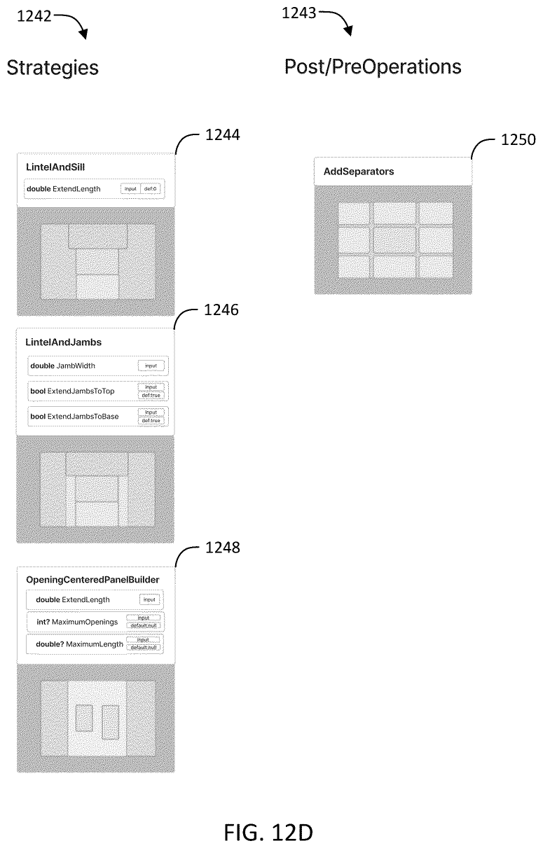

In some embodiments, the modeling group represents the input and output data structures expected by the code portion. Input data is converted to models to be used by other code portions. Having its own data models means this code portion can be used in multiple different frameworks (or other code portions) for different purposes. For example, in the modeling group, a region 2d object (see e.g., 1230 in FIG. 12C) is a base code portion where the code portion generates an outer polygon and a decomposed field represents all the other polygons that fit inside the outer polygon.

In some embodiments, the interface group represents different operations that can be performed on the data models. For example, a base operation in the interface group may add a polygon to the region (see e.g., operation 1232 shown in FIG. 12C). An example of a more specific operation is a BorderOperation (see e.g., operation 1240 shown in FIG. 12C), where the polygon added is bordering the existing interior region. When used for handling openings in a framework, we can define the following additional operations, for example, LintelOperation 1234, SillOperation 1236, and JambsOperation 1238. Such operations may be stored outside the code portion and may be more domain-specific to openings.

In some embodiments, the strategy group of code portions may combine operations into higher-level strategies that can have additional logic, conditions and configurations on how the operations are performed, including in what order. In some embodiments, the strategy group of code portions is located outside the category specific group of code portions. In some embodiments, the strategy group of code portions is located inside the category specific group of code portions. For example, the lintel and sill code portion uses the lintel operation and sill operation to handle openings for products that don't make use of jambs. Examples of such strategies include the LintelAndSill strategy 1244, the LintelAndJambs strategy 1246, and the OpeningCenteredPanelBuilder strategy 1248.

In some embodiments, greater than three functional groups and/or different functional groups may be used in place of or in addition to the groups discussed herein, as aspects of the technology described herein are not limited in this respect. In some embodiments, code portions may be hand-coded. In some embodiments, code portions may be generated programmatically (e.g., using artificial intelligence techniques such as large language models).

FIG. 12A illustrates examples of code portions for processing interfaces and models 1200, in accordance with some embodiments of the technology described herein. Code portions for processing interfaces and models 1200 include linear element 1202, linear joint 1204, linear joint strategy 1206, square off corner joint 1208, miter joint 1210, butt corner joint 1212, empty joint 1214, and empty joint 1216.

Linear element code portion 1202 generates linear elements from elements in an input building model file which have a shape (geometry) that can be represented as a line. For example, a wall can be represented by a line encoding where the footprint of the wall starts and ends. Linear element code portion 1202 may have an input specifying how to position the element relative to a line in the input file. For example, the linear element code portion may treat the line in the input file as a center line for the linear element. Linear element code portion may have additional inputs to specify the thickness of the element, the depiction of the linear element in a building plan, and the name of the element.

Linear joint code portion 1204 generates a joint at an intersection point between linear elements. Linear joint code portion 1204 may include a first input for specifying the location of the intersection point and a second input for specifying the linear elements to join and the joint.

Linear joint strategy code portion 1206 provides a designer with strategies (e.g., options) for specifying how to join linear elements at an intersection point. The linear joint strategies may include selecting a butt corner joint 1212, a square off corner joint 1208, an empty joint with specified setback 1214, a miter joint 1210, or an empty joint 1216 for joining the linear elements at the intersection point.

FIG. 12B illustrates examples of code portions for doing processes in connection with a construction plan 1218, in accordance with some embodiments of the technology described herein. Code portions for doing processing in connection with a construction plan include linear joint finder 1220, reset strategy 1226, linear joint solver 1222, and steps 1224. Linear joint finder code portion 1220 detects joints from a list of linear elements. Reset strategy code portion 1226 resets a strategy for joining linear elements together. Linear joint solver code portion 1222 goes through the identified joint from the build model and applies the selected joint type. The linear joint solver code portion 1222 may receive the joint strategy as an input, optionally may receive a ranking of which linear elements to place first, and may receive a list of the linear elements to join. Steps code portion 1224 may include specify an order in which to execute other code portions. For example, code portion 1224 may include a grouping step, an ordering step, a defining joints step, an applying joints step, and a solved joints step.

FIG. 12C illustrates model and operation code portions associated with mapping products to a construction model, in accordance with some embodiments of the technology described herein. Models 1228 include two-dimensional region code portion 1230, which enables a surface to be subdivided into smaller components. Operations 1229 includes an opening operation 1232, border operation 1240, lintel operation 1234, sill operation 1236, and jambs operation 1238. Opening operation code portion 1232 assigns a region to an opening. Border operation code portion 1240 builds regions bordering openings. Lintel operation code portion 1234 creates a lintel region. Sill operation 1236 creates a sill region. Jambs operation code portion 1238 creates a jamb region.

FIG. 12D illustrates strategies 1242 and post/pre operations 1243 associated with mapping products to a construction model, in accordance with some embodiments of the technology described herein. Strategies 1242 include lintel and sill 1244, lintel and jambs 1246, and opening centered panel builder 1248. Lintel and sill code portion 1244 generates a lintel and sill region. Lintel and jambs code portion 1246 generates a lintel and jamb region. Opening centered panel builder code portion 1248 generates an opening centered panel. Post/pre operations 1243 includes add separations code portions 1250 for adding separator regions.

FIG. 13A illustrates an example of a configurable computational pipeline, in accordance with some embodiments of the technology described herein. Configurable computational pipeline environment 1300 is a SIPS configurable computational pipeline configured to receive an initial construction build plan 1302, selection of products 1304, and attributes of the products to apply 1306 as inputs. Configurable computational pipeline environment 1300 includes SIPs analyzer 1308, SIPs execution 1310, and SIPs products 1312.

SIPs analyzer 1308 analyzes the initial construction build model and generates a representation of the initial construction build model 1318 for use with the mapping code portions. SIPs elements 1312 may store SIPs schemas and/or code portions associated with the mapping of SIPs products to a construction build model.

SIPs execution 1310 provides code portions associated with the SIPs category to a pipeline configuration module 1314. The configured pipeline is executed by pipeline execution module 1316 on the representation of the initial construction build model 1318 for use with the mapping code portions.

In the illustrated example of FIG. 13A, the configured computational pipeline includes code portions to handle corners, handle openings, divide walls elevation profiles, group profiles by equality, create SIP panel-definitions from unique profiles, and place panel instances on profiles. In some embodiments, the configurable computational pipeline may execute the code portions in the listed order. In some embodiments, the order may be overwritten by the designer. In some embodiments, other orders may be used as aspects of the technology described herein are not limited in this respect.

After execution of the configurable computational pipeline, a collection of product instances which represent the instances generated in the mapping of the product to the construction build model are output 1322. A metrics calculator 1324 analyzes the output 1322 to generate metrics output 1326. In some embodiments, metrics outputs 1326 are the category output attributes for the product category.

The outputs produced by the SIPs computational pipeline environment 1300 include the updated construction model 1328 and metrics output 1330. In some embodiments, metrics output 1330 may include metrics output 1326. In some embodiments, metrics output 1330 may include metrics output 1326 and the metrics output from other configurable computational pipelines aggregated together.

FIG. 13B illustrates a second example of a configurable computation pipeline, in accordance with some embodiments of the technology described herein. Configurable computational pipeline environment 1340 is a horizontal composite (HC) configurable computational pipeline configured to receive an initial construction build plan 1342, selection of products 1344, and attributes of the products to apply 1346 as inputs. Configurable computation pipeline environment 1340 includes HC analyzer 1348, HC execution 1350, and HC products 1352.

HC analyzer 1348 analyzes the initial construction build model and generates a representation of the initial construction build model 1342. The configurable pipeline is executed by HC execution module 1360 on the representation of the initial construction build model 1358 for use with the mapping code portions.

In the illustrated example of FIG. 13B, the configured computational pipeline includes two pipelines, a first pipeline for handling solid layers 1362 and a second pipeline for handling framing layers 1364. Accordingly, for each panel, separate pipelines are executed for different layers of the panel. The first pipeline for handling solid layers 1362 includes code portions to handle corners, handle openings, divide wall elevation profiles, group profiles by equality, create panel definitions from unique profiles, and place panel instances on profiles. The second pipeline for handling framing layers 1364 includes code portions to handle perimeters, split into vertical zones, handle openings, handle panel vertical separator elements, handle panel horizontal separator elements, and handle tertiary elements.

After execution of the configurable computation pipeline, a collection of product instances which represent the instances generated in the mapping of the product to the construction build model are output 1366. A metrics calculator 1368 analyzes the output 1366 to generate metrics output 1370. In some embodiments, metrics outputs 1370 are the category output attributes for the product category.

The outputs produced by the HC computational pipeline environment 1340 include the updated construction model 1372 and metrics output 1374. In some embodiments, metrics output 1374 may include metrics output 1370. In some embodiments, metrics output 1374 may include metrics output 1370. In some embodiments, metrics output 1374 may include metrics output 1370 and the metrics output from other configurable computational pipelines aggregated together.

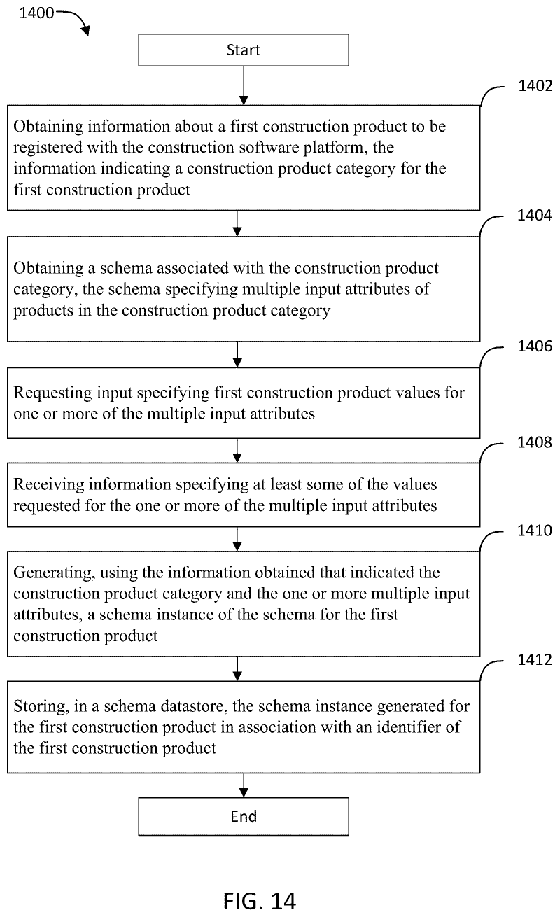

FIG. 14 is a flowchart of an illustrative process 1400 for registering one or more construction products with a construction software platform, in accordance with some embodiments of the technology described herein.

Process 1400 starts at act 1402 by obtaining information about a first construction product to be registered with the construction software platform, the information indicating a construction product category for the first construction product, in accordance with some embodiments of the technology described herein.

In some embodiments, the construction product category is a first construction product category and the first construction product category is selected from the group consisting of: boarding, solid wall panels, structural insulated panels, concrete insulated panels, closed framed panels, open framed panels, twin wall, concrete lattice floor, hollow core, solid floor, façade, structural frame, roof panel, roof truss, stairs, plant, balcony, pod, and module.

Next, process 1400 proceeds to act 1404 by obtaining a schema associated with the construction product category, the schema specifying multiple input attributes of products in the construction product category, in accordance with some embodiments of the technology described herein.

In some embodiments, the multiple input attributes include one or more input attributes selected from the group consisting of: one or more product dimension attributes, one or more product component attributes, one or more product arrangement attributes, and one or more product pricing attributes.

In some embodiments, the one or more product component attributes include product arrangement attributes selected from the group consisting of a design handling attribute, a corner handling attribute, an opening handling attribute, a horizontal connection attribute, a vertical connection attribute, a base connection attribute, a vertical alignment attribute, and a horizontal alignment attribute.

Next, process 1400 proceeds to act 1406 by requesting input specifying first construction product values for one or more of the multiple input attributes, in accordance with some embodiments of the technology described herein.

Next, process 1400 proceeds to act 1408 by receiving information specifying at least some of the values requested for the one or more of the multiple input attributes, in accordance with some embodiments of the technology described herein.

In some embodiments, the multiple input attributes include one or more input attributes selected from the group consisting of: one or more product dimension attributes, one or more product component attributes, one or more product arrangement attributes, and one or more product pricing attributes. Accordingly, receiving information specifying at least some of the values requested for the one or more of the multiple input attributes includes receiving information specifying values of at least some of the one or more input attributes.

In some embodiments, the one or more product component attributes include product arrangement attributes selected from the group consisting of a design handling attribute, a corner handling attribute, an opening handling attribute, a horizontal connection attribute, a vertical connection attribute, a base connection attribute, a vertical alignment attribute, and a horizontal alignment attribute. Accordingly, receiving information specifying at least some of the values requested for the one or more of the multiple input attributes includes receiving information specifying values of at least one of the product arrangement attributes.

Next, process 1400 proceeds to act 1410 by generating, using the information obtained that indicated the construction product category and the one or more multiple input attributes, a schema instance of the schema for the first construction product, in accordance with some embodiments of the technology described herein.

Next, process 1400 proceeds to act 1412 by storing, in a schema datastore, the schema instance generated for the first construction product in association with an identifier of the first construction product, in accordance with some embodiments of the technology described herein.

Following act 1412, process 1400 concludes. Following the conclusion of process 1400, a mapping of the construction product, being in a construction project category, to a construction project may be executed. The mapping of the construction product to the construction project may include obtaining an initial construction project model for a construction project and obtaining a selection of the first construction product for evaluating its use in the construction project. To map the construction product to the construction project, the mapping includes executing a first mapping software program, using the values of at least some of the multiple input attributes for the construction product as specified in the schema instance, to map the first construction product to the construction project model to obtain an updated construction project model. After executing the mapping software, the mapping may include outputting the updated construction project model.

In some embodiments, the construction product category of the construction product, is associated with a configurable computational pipeline. Executing the mapping software includes identifying, using the values of at least some of the multiple input attributes for the first construction product as specified in the schema instance, a first set of one or more software code portions to use for mapping the first construction product to the construction project model. A pipeline configuration module configures the first configurable computational pipeline to use the first set of one or more software code portions. A pipeline execution module includes executing the first configurable computational pipeline to obtain the updated construction project model.

In some embodiments, obtaining at least one or more input attributes, for the first construction product, includes obtaining a selection of at least one of the one or more of the multiple input attributes over whose possible values to optimize use of the first construction product. Obtaining at least one of the multiple output attributes includes obtaining a selection of at least one of the multiple output attributes to serve as at least one objective with respect to which to optimize the use of the first construction product. Following the selection of at least one or more of the multiple input attributes and at least one of the multiple output attributes, one or more product designs are identified using an optimization technique and the first mapping software program, to evaluate use of the first construction product over values of the selected input attributes with respect to the at least one objective defined using the selected at least one output attributes.

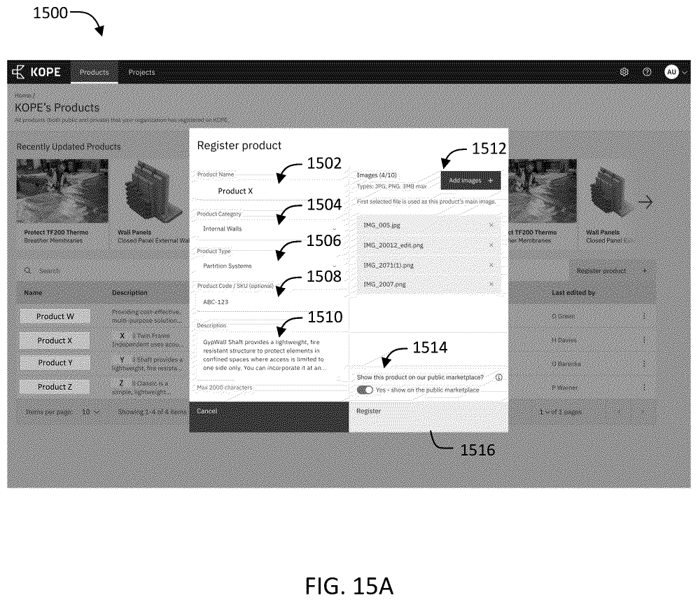

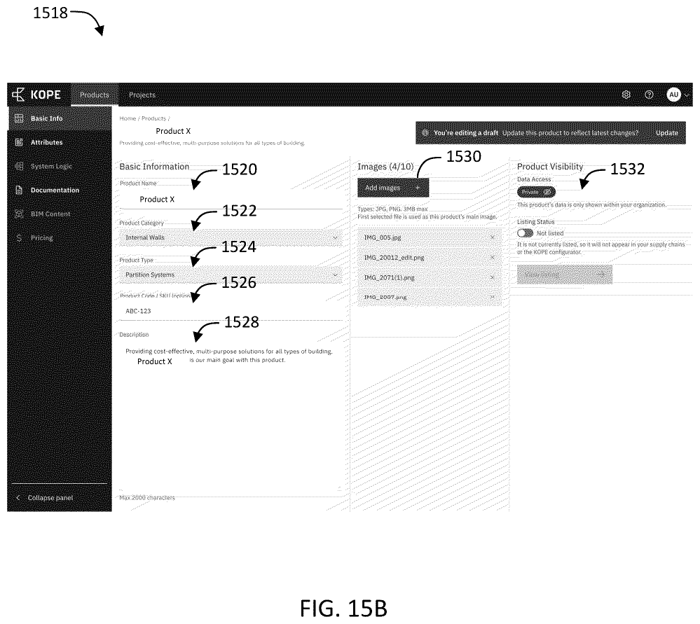

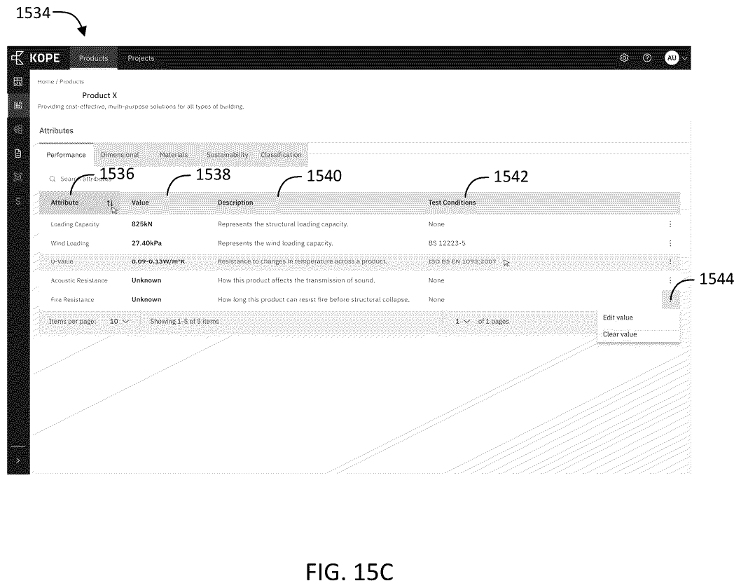

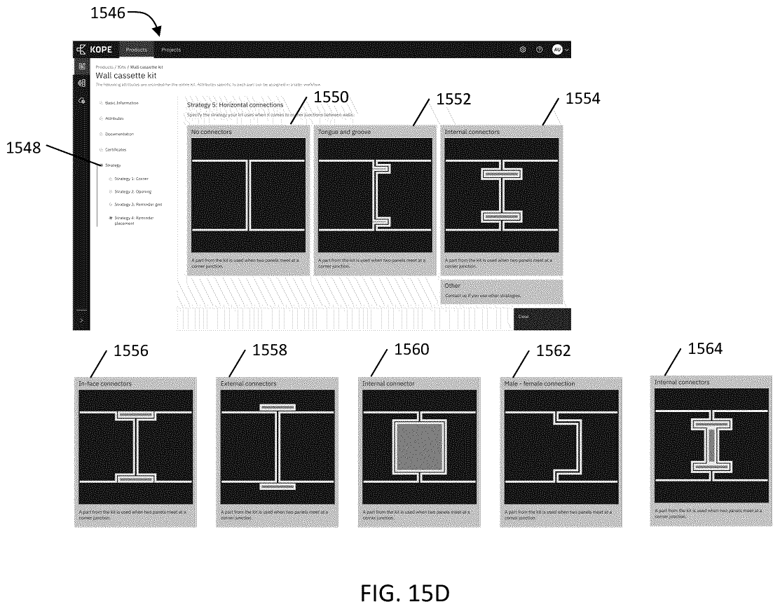

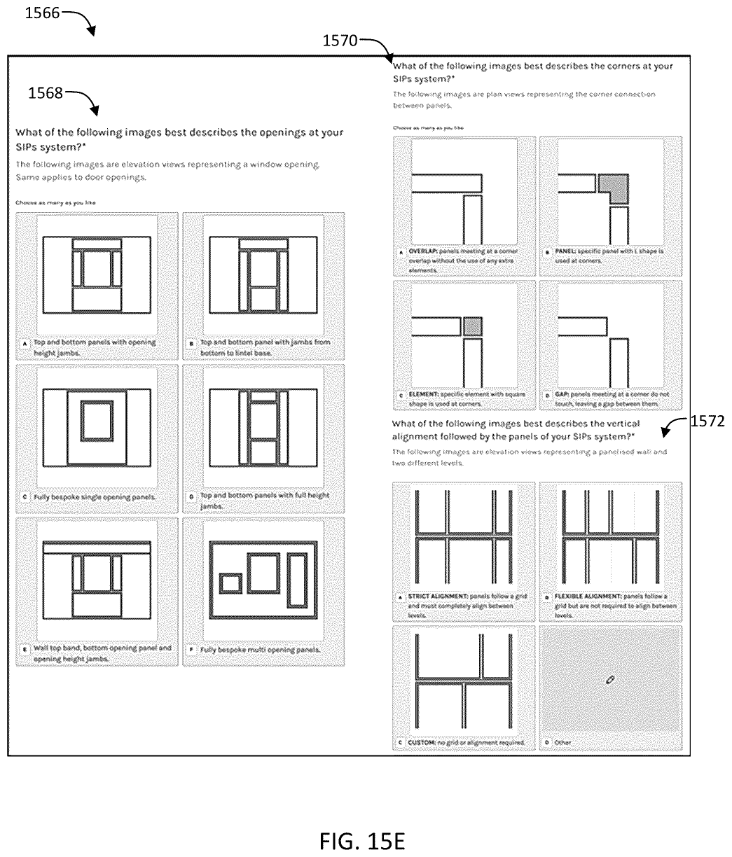

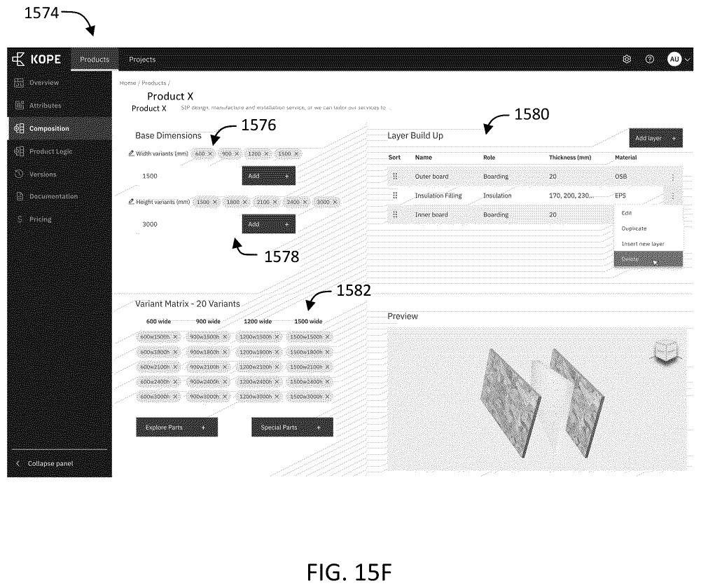

FIG. 15A illustrates an example of a GUI 1500 for registering a product with a construction software platform, in accordance with some embodiments of the technology described herein. Registering the product includes inputting a product name 1502, specifying a product category 1504, specifying a product type 1506, providing a product code/sku 1508, and providing a product description 1510. Images of the product may be added to the product registration by using control element 1412 to add image files. Toggle element 1514 may be toggled to publish the product for public viewing on the construction software platform. When the product details are complete, the product registration may be completed by selecting the register control element 1516.

FIG. 15B illustrates an example of a GUI 1518 for modifying the product details associated with the product registered in FIG. 15A. As shown in FIG. 15B, the basic details of the product such as the registered name 1520, registered product code/SKU 1526, and registered description 1528 may be edited by editing their respective fields. Additionally, images associated with the product may be edited using the control element 1530. The product visibility on the construction software platform can be edited using control element 1532. However, registered product category 1522 and registered product type 1524 may not be edited once the product is registered.

FIG. 15C illustrates an example of a GUI 1534 for editing product attributes for a registered product on a construction software platform, in accordance with some embodiments of the technology described herein. The attributes which are available for editing are defined by the product category. The attributes are displayed in table format, including attribute name column 1536, numeric value or range column 1538, description column 1540, and test condition column 1542. To edit an attribute, a supplier may select edit control element 1544 which opens a drop-down menu providing options for editing or clearing the attribute value.

FIG. 15D illustrates an example of a GUI 1546 for prompting a supplier to provide additional attribute inputs based on the category of the product, in accordance with some embodiments of the technology described herein. In some embodiments, in response to the construction software platform determining the product category, the construction software platform may display additional inputs specific to the product category. In the illustrated example of FIG. 15D, the product category is a SIPs category. The construction software platform, upon receiving input that the product category is the SIPs product category, displays additional inputs 1548 for the horizontal connections attribute. The options for the horizontal connections attribute are displayed to the supplier for them to select one or more attributes associated with their production facility. GUI 1546 displays potential attribute values for no connectors 1550, tongue and groove 1552, internal connectors 1554, in-face connectors 1556, external connectors 1558, internal connectors 1560, male-female connection 1562, and internal connectors 1564 to the supplier for their selection.

FIG. 15E illustrates an example GUI 1566 for prompting a supplier to provide additional attribute inputs based on the category of the product, in accordance with some embodiments of the technology described herein. In some embodiments, the construction software platform may prompt suppliers with questions to determine input attributes associated with the product category. As shown in the illustrated example of FIG. 15E, panel 1568 prompts the supplier to select images of the openings in their SIPs system that represent the product attribute selections that corresponds to their production capabilities. Panel 1570 prompts the supplier to select images of the corners in their SIPs system that represent the product attribute selection that corresponds to their production capabilities. Panel 1572 prompts the supplier to select images that describe the vertical alignment in their SIPs system that represent the product attribute selection that corresponds to their production capabilities.

FIG. 15F illustrates an example GUI 1574 for prompting a supplier to provide additional inputs based on the product category, in accordance with some embodiments of the technology described herein. GUI 1574 provides a width entry field 1576 for the supplier to enter width variants for their SIP system. GUI 1574 provides a height entry field 1578 for the supplier to enter height variants for their SIP system. GUI 1574 displays a variant matrix 1582 illustrating height and width combinations based on the height and width variants entered in their respective entry fields.

An example of product information absent a category schema expressed in JSON is shown in Table 5 below for a SIPs product.

TABLE 5
Example of Product Information without SIPS Schema

| | |
|---|---|
| 1 | { |
| 2 | “Id”: 30225758285356, |
| 3 | “KitId”: 28542445396490, |
| 4 | “Name”: “Company Build System”, |
| 5 | “Description”: “Steel-lined SIPS wall cassette system”, |
| 6 | “SKU”: null, |
| 7 | “Status”: “Active”, |
| 8 | “FlexConfiguratorId”: 74, |
| 9 | “Thumbnail”: |
| 10 | { |
| 11 | “Url”: |
| | “https://stkopemarketplaceprod.blob.core.windows.net/views/supplier/projectcompany.com/produ |
| | cts/30225758285356/Image/company-build-system-01.jpg” |
| 12 | }, |
| 13 | “CreatedAt”: “2023-09-28T13:02:48.545984+00:00”, |
| 14 | “LastUpdatedAt”: “2023-09-28T13:02:48.561167+00:00”, |
| 15 | “MmcSubCategory”: |
| 16 | { |
| 17 | “Name”: “SIPS (LGSF)” |
| 18 | }, |
| 19 | “BuildingSubElement”: |
| 20 | { |
| 21 | “Name”: “Full Structural Shell” |
| 22 | }, |
| 23 | “Documents”: |
| 24 | [ |
| 25 | { |
| 26 | “Id”: 30225758335794, |
| 27 | “Description”: null, |
| 28 | “InformationType”: “Promotional”, |
| 29 | “Name”: “Introducing_Company_Digital_Brochure”, |
| 30 | “TenantId”: “projectcompany.com”, |
| 31 | “Url”: |
| | “https://stkopemarketplaceprod.blob.core.windows.net/views/supplier/projectcompany.com/produ |
| | cts/30225758285356/Promotional/introducing_company_digital_brochure.pdf”, |
| 32 | “TypeExtension”: “pdf” |
| 33 | } |
| 34 | ], |
| 35 | “Supplier”: |
| 36 | { |
| 37 | “Organisation”: |
| 38 | { |
| 39 | “Id”: 74, |
| 40 | “Name”: “Company” |
| 41 | } |
| 42 | }, |
| 43 | “AttributeSets”: |
| 44 | { |
| 45 | “materials”: |
| 46 | { |
| 47 | “finishMaterial”: “Cement bonded particle board”, |
| 48 | “insulationMaterial”: “PU Foam” |
| 49 | }, |
| 50 | “dimensional”: |
| 51 | { |
| 52 | “overallWidth”: “185mm”, |
| 53 | “overallHeight”: “2400mm”, |
| 54 | “overallLength”: “215-1125mm” |
| 55 | }, |
| 56 | “sustainability”: |
| 57 | { |
| 58 | “materialSourceCountry”: “GB”, |
| 59 | “productManufactureCountry”: “GB” |
| 60 | } |
| 61 | }, |
| 62 | } |

In some embodiments, the category schema may be expressed along with the product information in JSON, as shown in Table 6 below for a SIPs product. In contrast with the product information shown in table 5 above, Table 6 below specifies the category attributes that are shared by products in the category.

TABLE 6
Example of Product Information with SIPS Schema

| | |
|---|---|
| 1 | { |
| 2 | “Id”: 30225758285356, |
| 3 | “KitId”: 28542445396490, |
| 4 | “Name”: “Company Build System”, |
| 5 | “Description”: “Steel-lined SIPS wall cassette system”, |
| 6 | “SKU”: null, |
| 7 | “Status”: “Active”, |
| 8 | “FlexConfiguratorId”: 74, |
| 9 | “Thumbnail”: |
| 10 | { |
| 11 | “Url”: |
| | “https://stkopemarketplaceprod.blob.core.windows.net/views/supplier/projectcompany.com/produ |
| | cts/30225758285356/Image/company-build-system-01.jpg” |
| 12 | }, |
| 13 | “CreatedAt”: “2023-09-28T13:02:48.545984+00:00”, |
| 14 | “LastUpdatedAt”: “2023-09-28T13:02:48.561167+00:00”, |
| 15 | “MmcSubCategory”: |
| 16 | { |
| 17 | “Name”: “SIPS (LGSF)” |
| 18 | }, |
| 19 | “BuildingSubElement”: |
| 20 | { |
| 21 | “Name”: “Full Structural Shell” |
| 22 | }, |
| 23 | “Documents”: |
| 24 | [ |
| 25 | { |
| 26 | “Id”: 30225758335794, |
| 27 | “Description”: null, |
| 28 | “InformationType”: “Promotional”, |
| 29 | “Name”: “Introducing_Company_Digital_Brochure”, |
| 30 | “TenantId”: “projectcompany.com”, |
| 31 | “Url”: |
| | “https://stkopemarketplaceprod.blob.core.windows.net/views/supplier/projectcompany.com/produ |
| | cts/30225758285356/Promotional/introducing_company_digital_brochure.pdf”, |
| 32 | “TypeExtension”: “pdf” |
| 33 | } |
| 34 | ], |
| 35 | “Supplier”: |
| 36 | { |
| 37 | “Organisation”: |
| 38 | { |
| 39 | “Id”: 74, |
| 40 | “Name”: “Company” |
| 41 | } |
| 42 | }, |
| 43 | “AttributeSets”: |
| 44 | { |
| 45 | “materials”: |
| 46 | { |
| 47 | “finishMaterial”: “Cement bonded particle board”, |
| 48 | “insulationMaterial”: “PU Foam” |
| 49 | }, |
| 50 | “dimensional”: |
| 51 | { |
| 52 | “overallWidth”: “185mm”, |
| 53 | “overallHeight”: “2400mm”, |
| 54 | “overallLength”: “215-1125mm” |
| 55 | }, |
| 56 | “sustainability”: |
| 57 | { |
| 58 | “materialSourceCountry”: “GB”, |
| 59 | “productManufactureCountry”: “GB” |
| 60 | } |
| 61 | }, |
| 62 | “CategorySchema”: |
| 63 | { |
| 64 | “GeometryRequired”: |
| 65 | [ |
| 66 | { |
| 67 | “name”: “centerline”, |
| 68 | “type”: “line” |
| 69 | }, |
| 70 | { |
| 71 | “name”: “elevationProfile”, |
| 72 | “type”: “profile” |
| 73 | } |
| 74 | ], |
| 75 | “Inputs”: |
| 76 | { |
| 77 | “Dimensions”: |
| 78 | { |
| 79 | “Standard height”:[ 2000, 2400 ], |
| 80 | “Standard width”: [ 1200 ], |
| 81 | “Minimum width”: |
| 82 | { |
| 83 | “min”: 100, |
| 84 | “max”: 500, |
| 85 | “multipleOf”: 50 |
| 86 | }, |
| 87 | “Rebate”: |
| 88 | { |
| 89 | “min”: 10, |
| 90 | “max”: 100, |
| 91 | “multipleOf”: 10 |
| 92 | } |
| 93 | }, |
| 94 | “Components”: |
| 95 | { |
| 96 | “Boarding material”: “OSB”, |
| 97 | “Boarding thickness”: [ 11, 15, 18 ], |
| 98 | “Insulation material”: “EPS”, |
| 99 | “Insulation thickness”: [ 100, 125, 150, 200, 250 ] |
| 100 | }, |
| 101 | “Strategies”: |
| 102 | { |
| 103 | “Design”: “Wall Elevation”, |
| 104 | “Corner”: “Corner overlap”, |
| 105 | “Opening”: “Lintel and Sill”, |
| 106 | “Horizontal connection”: “Single spline”, |
| 107 | “Base connection”: “Rail”, |
| 108 | “Vertical alignment”: “Strict”, |
| 109 | “Vertical connection”: “Full height only” |
| 110 | }, |
| 111 | “Cost”: |
| 112 | { |
| 113 | “Panel cost”: |
| 114 | { |
| 115 | “Unit”: “USD”, |
| 116 | “Value”: 300 |
| 117 | }, |
| 118 | “Timber plate cost”: |
| 119 | { |
| 120 | “Unit”: “USD”, |
| 121 | “Value”: 10 |
| 122 | }, |
| 123 | “Spline cost”: |
| 124 | { |
| 125 | “Unit”: “USD”, |
| 126 | “Value”: 20 |
| 127 | }, |
| 128 | “Solid post cost”: |
| 129 | { |
| 130 | “Unit”: “USD”, |
| 131 | “Value”: 50 |
| 132 | } |
| 133 | } |
| 134 | } |
| 135 | } |
| 136 | } |

As an example of a product associated with different category than the SIPs category shown above in Table 6, an example of a product in the plasterboard category is included below in Table 7.

TABLE 7
Example of Product Information from Plasterboard Category

| | |
|---|---|
| 1 | { |
| 2 | “Id”: 30225751685986, |
| 3 | “KitId”: 28542445391537, |
| 4 | “Name”: “British Gypsum Gyprock”, |
| 5 | “Description”: “Moisture-resistant plasterboard system”, |
| 6 | “SKU”: “GPR-MR-01”, |
| 7 | “Status”: “Active”, |
| 8 | “FlexConfiguratorId”: 123, |
| 9 | “Thumbnail”: |
| 10 | { |
| 11 | “Url”: |
| | “https://stkopemarketplaceprod.blob.core.windows.net/views/supplier/britishgypsum.com/product |
| | s/30225751685986/Image/gyprock-01.jpg” |
| 12 | }, |
| 13 | “CreatedAt”: “2023-09-28T13:02:48.545984+00:00”, |
| 14 | “LastUpdatedAt”: “2023-09-28T13:02:48.561167+00:00”, |
| 15 | “MmcSubCategory”: |
| 16 | { |
| 17 | “Name”: “Plasterboard” |
| 18 | }, |
| 19 | “BuildingSubElement”: |
| 20 | { |
| 21 | “Name”: “Internal partitions” |
| 22 | }, |
| 23 | “Documents”: |
| 24 | [ |
| 25 | { |
| 26 | “Id”: 60225758331153, |
| 27 | “Description”: null, |
| 28 | “InformationType”: “Promotional”, |
| 29 | “Name”: “Gyprock Overview”, |
| 30 | “TenantId”: “britishgypsum.com”, |
| 31 | “Url”: |
| | “https://stkopemarketplaceprod.blob.core.windows.net/views/supplier/britishgypsum.com/product |
| | s/30225751685986/Promotional/Gyprock Overview.pdf”, |
| 32 | “TypeExtension”: “pdf” |
| 33 | } |
| 34 | ], |
| 35 | “Supplier”: |
| 36 | { |
| 37 | “Organisation”: |
| 38 | { |
| 39 | “Id”: 93, |
| 40 | “Name”: “British Gypsum” |
| 41 | } |
| 42 | }, |
| 43 | “AttributeSets”: |
| 44 | { |
| 45 | “materials”: |
| 46 | { |
| 47 | “finishMaterial”: “Cement bonded particle board” |
| 48 | }, |
| 49 | “dimensional”: |
| 50 | { |
| 51 | “overallWidth”: “1200mm”, |
| 52 | “overallHeight”: “2400mm” |
| 53 | }, |
| 54 | “sustainability”: |
| 55 | { |
| 56 | “materialSourceCountry”: “GB”, |
| 57 | “productManufactureCountry”: “GB” |
| 58 | } |
| 59 | }, |
| 60 | “CategorySchema”: |
| 61 | { |
| 62 | “GeometryRequired”: |
| 63 | [ |
| 64 | { |
| 65 | “name”: “elevationProfile”, |
| 66 | “type”: “profile” |
| 67 | } |
| 68 | ], |
| 69 | “Inputs”: |
| 70 | { |
| 71 | “Dimensions”: |
| 72 | { |
| 73 | “Heights available”: [ 2000, 2400 ], |
| 74 | “Widths available”: [ 1200 ], |
| 75 | “Minimum width”: 1200 |
| 76 | }, |
| 77 | “Components”: |
| 78 | { |
| 79 | “Boarding material”: “Plaster”, |
| 80 | “Boarding thickness”: [ 9, 13, 18 ], |
| 81 | }, |
| 82 | “Strategies”: |
| 83 | { |
| 84 | “Corner”: “Corner overlap”, |
| 85 | “Opening”: “Lintel and Sill”, |
| 86 | “Vertical alignment”: “Strict” |
| 87 | }, |
| 88 | “Cost”: |
| 89 | { |
| 90 | “Panel cost”: |
| 91 | { |
| 92 | “Unit”: “USD”, |
| 93 | “Value”: 300 |
| 94 | } |
| 95 | } |
| 96 | } |
| 97 | } |
| 98 | } |

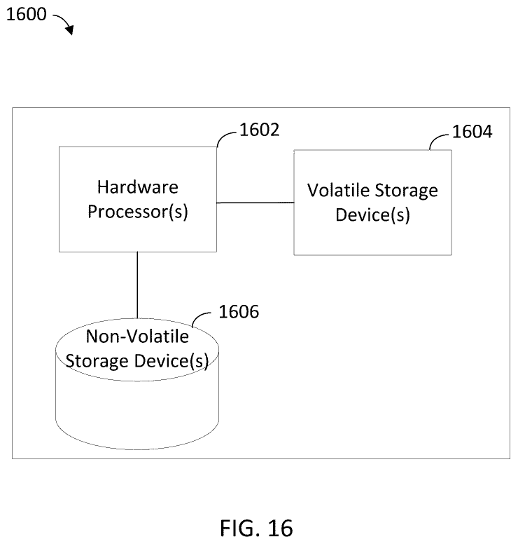

FIG. 16 illustrates an example of a computer system 1600, in accordance with some embodiments of the technology described herein. The computer system 1600 may include one or more computer hardware processors 1602 and one or more articles of manufacture that include non-transitory computer-readable storage media, for example, one or more volatile storage device(s) 1604 (e.g., random access memory or any other suitable type of memory) and one/or one or more non-volatile storage devices 1606 (e.g., a hard disk, a flash memory, etc.). The hardware processor(s) 1602 may control writing data to and reading data from the volatile storage device(s) 1604 and the non-volatile storage device(s) 1606 in any suitable manner. To perform any of the functionality described herein, including with respect to any process described herein, the hardware processor(s) 1602 may execute one or more processor-executable instructions stored in one or more non-transitory computer-readable storage media (e.g., the volatile storage device(s) 1604 and/or non-volatile storage device(s) 1606), which may serve as non-transitory computer-readable storage media storing processor-executable instructions for execution by the hardware processor(s) 1602.

### Example Aspects

1. A method for use by a construction software platform for evaluating use of one or more construction products in a construction project, the method comprising: executing the construction software platform using at least one computer hardware processor to perform: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

2. The method of aspect 1, wherein obtaining the initial construction project model comprises obtaining one or more files specifying a model including spatial elements, materials, and/or shapes.

3. The method of aspect 1 or 2, wherein obtaining the initial construction project model comprises obtaining a model file selected from the group consisting of an Industry Foundation Classes (IFC) model file, a Revit (RVT) file, an RFA file, a STEP file, a DWG file, a JSON file, and/or a drawing exchange format (DXF) file.

4. The method of aspect 3, wherein obtaining the model file comprises receiving the model file using at least one communication network.

5. The method of any one of aspects 1-4, wherein obtaining the selection of the first construction product comprises: receiving, via a graphical user interface, a selection of the first construction product category; presenting, via the graphical user interface, a listing of one or more construction products in the first construction product category including the first construction product; receiving, via the graphical user interface, the selection of the first construction product.

6. The method of aspect 5, wherein the graphical user interface is an interface presented to a user via an Internet browser application or an application program executing on a device of the user.

7. The method of any one of aspects 1-6, wherein the construction software platform comprises multiple mapping software programs each of the multiple mapping software programs for mapping construction products in a respective construction product category to construction project models and being stored in association with information identifying the respective construction product category, and wherein identifying the first mapping software program comprises selecting, as the first mapping software program and from among the multiple mapping software programs, a mapping software program that is stored in association with information identifying the first construction product category or in association with the first construction product.

8. The method of any one of aspects 1-7, wherein executing the first mapping software program to map the first construction product to the initial construction project model comprises: generating a product design comprising an arrangement of one or more instances of the first construction product with respect to the initial construction project model.

9. The method of aspect 8, wherein the product design specifies at least positioning of the one or more instances of the first construction product with respect to one another and with respect to the initial construction project model.

10. The method of aspect 8, wherein outputting the updated construction project model comprises: outputting a three-dimensional (3D) model of the initial construction project model with the product design arranged thereon.

11. The method of any one of aspects 1-10, wherein the updated construction project model is a 3D model including the initial construction project model and one or more instances of the first construction product arranged thereon; wherein outputting the updated construction project model comprises outputting a rendering of the updated construction project model.

12. The method of any one of aspects 1-11, further comprising: obtaining a selection of a second construction product for evaluating its use in the construction project, the second construction product being in a second construction project category; and identifying, using the second construction product category or second construction product, a second mapping software program, different from the first mapping software program, for mapping the second construction product to the initial construction project model, wherein the executing comprises executing the first mapping software program to map the first construction product to the initial construction project model and the second mapping software program to map the second construction product to the initial construction project model to obtain the updated construction project model.

13. The method of any one of aspects 1-12, wherein the first construction product is associated with a schema instance of a schema associated with the first construction product category, the schema comprising attributes shared by construction products in the first construction product category, the schema instance specifying values of at least some of the attributes for the first construction product, and wherein the executing is performed using the values of the at least some of attributes for the first construction product indicated in the schema instance.

14. The method of any one of aspects 1-13, further comprising: modifying one or more of the values of the at least some of the attributes to obtain modified attribute values; and executing, using the modified attribute values, the first mapping software program to map the first construction product to the initial construction project model.

15. The method of aspect 13, wherein the first construction product category is associated with a configurable computational pipeline, and wherein executing the first mapping software program comprises: identifying, using at least some of the values of the at least some attributes for the first construction product as specified in the schema instance, a first set of one or more software code portions to use for mapping the first construction product to the initial construction project model, configuring the first configurable computational pipeline to use the first set of one or more software code portions; and executing the first configurable computational pipeline to obtain the updated construction project model.

16. The method of aspect 13, wherein the attributes include multiple input attributes, the method further comprising: obtaining, for the first construction product, a selection of: at least one of the multiple input attributes over whose possible values to optimize use of the first construction product; at least one of the multiple output attributes to serve as at least one objective with respect to which to optimize the use of the first construction product; and identifying one or more product designs, using an optimization technique and the first mapping software program, to evaluate use of the first construction product over values of the selected input attributes with respect to the at least one objective defined using the selected at least one output attribute.

17. The method of any one of aspects 1-16, wherein the first construction product category is selected from the group consisting of: boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, and whole-building system.

18. A system for evaluating use of one or more construction products in a construction project, the system comprising: at least one computer hardware processor to perform: at least one non-transitory computer-readable storage medium storing processor executable instructions that, when executed by the at least one computer hardware processor, cause the at least one computer hardware processor to perform: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

19. At least one non-transitory computer-readable storage medium storing processor executable instructions that, when executed by at least one computer hardware processor, cause the at least one computer hardware processor to perform a method for evaluating use of one or more construction products in a construction project, the method comprising: (A) obtaining an initial construction project model for the construction project; (B) obtaining a selection of a first construction product for evaluating its use in the construction project, the first construction product being in a first construction project category; (C) identifying, using the first construction product category or the first construction product, a first mapping software program for mapping the first construction product to the initial construction project model; (D) executing the first mapping software program to map the first construction product to the initial construction project model to obtain an updated construction project model; and (E) outputting the updated construction project model.

20. A method for use by a construction software platform for evaluating use of one or more construction products, the method comprising: executing the construction software platform using at least one computer hardware processor to perform: (A) obtaining a selection of a first construction product for evaluating its use, the first construction product being in a first construction project category; (B) identifying, using the first construction product category or the first construction product, a first mapping software program for generating a product design composed of one or more instances of the first construction product; (C) executing the first mapping software program to generate the product design composed of the one or more instance of the first construction product; and (D) outputting the product design.

21. A system for evaluating use of one or more construction products, the system comprising: at least one computer hardware processor to perform: at least one non-transitory computer-readable storage medium storing processor executable instructions that, when executed by the at least one computer hardware processor, cause the at least one computer hardware processor to perform: (A) obtaining a selection of a first construction product for evaluating its use, the first construction product being in a first construction project category; (B) identifying, using the first construction product category or the first construction product, a first mapping software program for generating a product design composed of one or more instances of the first construction product; (C) executing the first mapping software program to generate the product design composed of the one or more instance of the first construction product; and (D) outputting the product design.

22. At least one non-transitory computer-readable storage medium storing processor executable instructions that, when executed by at least one computer hardware processor, cause the at least one computer hardware processor to perform a method for evaluating use of one or more construction products, the method comprising: (A) obtaining a selection of a first construction product for evaluating its use, the first construction product being in a first construction project category; (B) identifying, using the first construction product category or the first construction product, a first mapping software program for generating a product design composed of one or more instances of the first construction product; (C) executing the first mapping software program to generate the product design composed of the one or more instance of the first construction product; and (D) outputting the product design.

23. A method for using optimization to evaluate use of one or more construction products in a construction project, the one or more construction products including a first construction product in a first construction product category, the method comprising: using at least one computer hardware processor to perform: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

24. The method of aspect 23, wherein the multiple input attributes include one or more attributes selected from the group consisting of: one or more product dimension attributes, one or more product component attributes, one or more product arrangement attributes, one or more product pricing attributes, one or more product quantity attributes, one or more product environmental attributes, one or more product performance attributes, one or more product material attributes.

25. The method of aspect 23 or 24, wherein the multiple output attributes include one or more attributes selected from the group consisting of: one or more attributes indicating quantity of product instances used in product design pricing attributes, one or more attributes indicating cost of materials used in product design.

26. The method of any one of aspects 23-25, wherein the multiple input attributes include a first input attribute, and the schema instance specifies at least one continuous range of possible values for the first input attribute.

27. The method of any one of aspects 23-25, wherein the multiple input attributes include a first input attribute, and the schema instance specifies a discrete set of possible values for the first input attribute.

28. The method of any one of aspects 23-27, wherein (B) comprises: presenting, via a graphical user interface, a listing of at least some of the one or more of the multiple input attributes; and receiving, via the graphical user interface, the selection of the at least one of the one or more of the multiple input attributes over whose possible values to optimize use of the first construction product.

29. The method of aspect 28, wherein (B) further comprises: presenting, via the graphical user interface, a listing of at least some of the multiple output attributes; and receiving, via the graphical user interface, the selection of the at least one of the multiple output attributes to serve as the at least one objective with respect to which to optimize the use of the first construction product, the selection indicating, for each particular attribute of the at least one of the multiple output attributes, whether to maximize or minimize with respect to the particular output attribute during optimization.

30. The method of any one of aspects 23-29, wherein the optimization technique comprises a multi-objective optimization technique.

31. The method of aspect 30, wherein the multi-objective technique comprises a multi-objective genetic optimization technique.

32. The method of aspect 31, wherein the multi-objective genetic optimization technique is a non-dominated sorting genetic algorithm (NSGA), a generalized differential evolution (GDE) algorithm, or a multi-objective evolutionary algorithm based on decomposition (MOEA/D) algorithm.

33. The method of any one of aspects 23-32, wherein (C) comprises: generating P populations of input values, each of the P populations of input values specifying an initial set of input values for the selected input attributes, wherein P is an integer greater than 1 that represents the number of the populations; generating multiple product designs by, for each particular population of the P populations, executing the first mapping software program configured with the particular population of the input values to obtain a respective product design; scoring the generated multiple product designs using the at least one objective with respect to which to optimize use of the first construction product to obtain a plurality of scores; and generating a new set of P populations of input values from the P populations of input values and the plurality of scores.

34. The method of any one of aspects 23-33, wherein outputting information about the identified one or more product designs comprises: outputting values of one or more of the output attributes determined for each of the one or more product designs.

35. The method of any one of aspects 23-34, wherein the first construction product category is selected from the group consisting of: boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, and whole-building system.

36. A system for using optimization to evaluate use of one or more construction products in a construction project, the one or more construction products including a first construction product in a first construction product category, the system comprising: at least one computer hardware processor to perform: at least one non-transitory computer-readable storage medium storing processor executable instructions that, when executed by the at least one computer hardware processor, cause the at least one computer hardware processor to perform: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

37. At least one non-transitory computer-readable storage medium storing processor executable instructions that, when executed by the at least one computer hardware processor, cause the at least one computer hardware processor to perform a method for using optimization to evaluate use of one or more construction products in a construction project, the one or more construction products including a first construction product in a first construction product category, the method comprising: (A) obtaining a schema instance of a schema associated with the first construction product category, the schema comprising attributes shared by construction products in the first construction product category, the attributes including multiple input attributes and multiple output attributes, the schema instance specifying values of at least some of the attributes for the first construction product including: for each particular input attribute of one or more of the multiple input attributes, a respective set of possible values of the particular input attribute; (B) obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; (C) identifying one or more product designs, using an optimization technique and a first mapping software program for mapping the first construction product to a construction project model, to evaluate use of the first construction product over values of the selected input attributes with respect to the at least one objective defined using the selected at least one output attribute; and (D) outputting information about the identified one or more product designs.

38. A method for evaluating use of one or more construction products in a construction project, the one or more construction products including a first construction product in a first construction product category, the method comprising: using at least one computer hardware processor to perform: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

39. The method of aspect 38, wherein construction products belong to construction product categories, wherein the construction product categories belong to construction product category groups, and wherein each of the construction product category groups is associated with a respective configurable computational pipeline for mapping construction products in the construction products category group to construction project models.

40. The method of aspect 39, wherein the construction product category groups include a first construction product category group associated with the first configurable computational pipeline, wherein the first construction product category group includes the first construction product category and a second construction product category, the second construction product category including a second construction product, the method further comprising: obtaining a second schema instance of a second schema associated with the second construction product category, the second schema comprising second attributes shared by construction products in the second construction product category, the second schema instance specifying values of at least some of the second attributes for the second construction product including one or more values for one or more product arrangement attributes; mapping the second construction product to the initial construction project model by using a second mapping software program comprising the first configurable computational pipeline associated with the first construction product category group, the mapping comprising: identifying, using the one or more values for the one or more product arrangement attributes specified by the second schema instance, a second set of one or more software code portions to use for mapping the second construction product to the initial construction project model, wherein the second set of one or more software code portions includes at least one software code portion not in the first set of one or more software code portions; configuring the first configurable computational pipeline to use the second set of one or more software code portions; and executing the first configurable computational pipeline.

41. The method of aspect 39, wherein the construction product category groups include: a first construction product category group associated with the first configurable computational pipeline, and a second construction product category group associated with a second configurable computational pipeline different from the first configurable computational pipeline.

42. The method of aspect 41, wherein the second construction product category group includes a second construction product category, wherein the second construction product category includes a second construction product, wherein the method further comprises obtaining a second schema instance of a second schema associated with the second construction product category, the second schema comprising second attributes shared by construction products in the second construction product category, the second schema instance specifying values of at least some of the second attributes for the second construction product including one or more values for one or more product arrangement attributes, and wherein (B) comprises mapping the first construction product and the second construction product to the initial construction project model to obtain an updated construction project model by using the first mapping software program which comprises the first configurable computational pipeline and a second mapping software program which comprises the second configurable computational pipeline, the mapping comprising: identifying, using the one or more values for the one or more product arrangement attributes specified by the second schema instance, a second set of one or more software code portions to use for mapping the second construction product to the initial construction project model; configuring the second configurable computational pipeline to use the second set of one or more software code portions; and executing the second configurable computational pipeline.

43. The method of any one of aspects 38-42, wherein the first schema instance specifying the one or more values for the one or more product arrangement attributes selected from the group consisting of a design handling attribute, a corner handling attribute, an opening handling attribute, a horizontal connection attribute, a vertical connection attribute, a base connection attribute, a vertical alignment attribute, a horizontal alignment attribute, an adjacency constraint attribute, a patterning strategy attribute, a layer build up attribute, a directional layout attribute, an interface strategy attribute, a perimeter framing attribute, a zone region framing attribute, an opening framing attribute, a hollow zone attribute, a variable space sizing attribute, an edge treatment attribute, and an edge cut attribute.

44. The method of any one of aspects 38-43, wherein the first construction product category is selected from the group consisting of: boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, whole-building system.

45. A system for evaluating use of one or more construction products in a construction project, the one or more construction products including a first construction product in a first construction product category, the system comprising: at least one computer hardware processor to perform: at least one non-transitory computer-readable storage medium storing processor executable instructions that, when executed by the at least one computer hardware processor, cause the at least one computer hardware processor to perform: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

46. At least one non-transitory computer-readable storage medium storing processor executable instructions that, when executed by the at least one computer hardware processor, cause the at least one computer hardware processor to perform a method for evaluating use of one or more construction products in a construction project, the one or more construction products including a first construction product in a first construction product category, the method comprising: (A) obtaining a first schema instance of a first schema associated with the first construction product category, the first schema comprising attributes shared by construction products in the first construction product category, the first schema instance specifying values of at least some of the attributes for the first construction product including one or more values for one or more product arrangement attributes; (B) mapping the first construction product to an initial construction project model to obtain an updated construction project model by using a first mapping software program comprising a first configurable computational pipeline associated with the first construction product category, the mapping comprising: identifying, using the one or more values for the one or more product arrangement attributes specified by the first schema instance, a first set of one or more software code portions to use for mapping the first construction product to the initial construction project model, configuring the first configurable computational pipeline to use the first set of one or more software code portions; and executing the first configurable computational pipeline to obtain the updated construction project model; and (C) outputting the updated construction project model.

47. A method for registering one or more construction products with a construction software platform, the method comprising: executing the construction software platform using at least one computer hardware processor to perform: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

48. The method of aspect 47, wherein the multiple input attributes include one or more input attributes selected from the group consisting of: one or more product dimension attributes, one or more product component attributes, one or more product arrangement attributes, one or more product pricing attributes, one or more product quantity attributes, one or more product environmental attributes, one or more product performance attributes, and one or more product material attributes, and wherein (D) comprises receiving information specifying values of at least some of the one or more input attributes.

49. The method of aspect 48, wherein the one or more product component attributes include product arrangement attributes selected from the group consisting of a design handling attribute, a corner handling attribute, an opening handling attribute, a horizontal connection attribute, a vertical connection attribute, a base connection attribute, a vertical alignment attribute, and a horizontal alignment attribute, an adjacency constraint attribute, a patterning strategy attribute, a layer build up attribute, a directional layout attribute, an interface strategy attribute, a perimeter framing attribute, a zone region framing attribute, an opening framing attribute, a hollow zone attribute, a variable space sizing attribute, an edge treatment attribute, and an edge cut attribute, and wherein (D) comprises receiving information specifying values of at least one of the product arrangement attributes.

50. The method of any one of aspects 47-49, wherein the first construction product category is selected from the group consisting of: boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, and whole-building system.

51. The method of any one of aspects 47-50, further comprising: obtaining an initial construction project model for a construction project; obtaining, via the graphical user interface, a selection of the first construction product for evaluating its use in the construction project, the first construction product being in a first construction project category; executing a first mapping software program, using the values of the at least some of the multiple input attributes for the first construction product as specified in the schema instance, to map the first construction product to the initial construction project model to obtain an updated construction project model; and outputting the updated construction project model.

52. The method of aspect 51, wherein the first construction product category is associated with a configurable computational pipeline, and wherein executing the first mapping software program comprises: identifying, using the values of the at least some of the multiple input attributes for the first construction product as specified in the schema instance, a first set of one or more software code portions to use for mapping the first construction product to the initial construction project model, configuring the first configurable computational pipeline to use the first set of one or more software code portions; and executing the first configurable computational pipeline to obtain the updated construction project model.

53. The method of aspect 51, further comprising: obtaining, for the first construction product, a selection of: at least one of the one or more of the multiple input attributes over whose possible values to optimize use of the first construction product; at least one of the multiple output attributes to serve as at least one objective with respect to which to optimize the use of the first construction product; and identifying one or more product designs, using an optimization technique and the first mapping software program, to evaluate use of the first construction product over values of the selected input attributes with respect to the at least one objective defined using the selected at least one output attribute.

54. A system for registering one or more construction products with a construction software platform, the system comprising: at least one computer hardware processor to perform: at least one non-transitory computer-readable storage medium storing processor executable instructions that, when executed by the at least one computer hardware processor, cause the at least one computer hardware processor to perform: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

55. At least one non-transitory computer-readable storage medium storing processor executable instructions that, when executed by the at least one computer hardware processor, cause the at least one computer hardware processor to perform a method for registering one or more construction products with a construction software platform, the method comprising: (A) obtaining, via at graphical user interface, information about a first construction product to be registered with the construction software platform, the information indicating a first construction product category for the first construction product; (B) obtaining a schema associated with the first construction product category, the schema specifying multiple input attributes of products in the first construction product category; (C) requesting, via the graphical user interface, input specifying first construction product values for one or more of the multiple input attributes; (D) receiving, via the graphical user interface, information specifying at least some of the values requested at (C); (E) generating, using the information obtained at (A) and (D), a schema instance of the schema for the first construction product, the schema instance specifying values of at least some of the multiple input attributes for the first construction product; and (F) storing, in a schema datastore, the schema instance generated for the first construction product in association with an identifier of the first construction product.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. The software code may be implemented in any suitable computing environment including, for example, a cloud computing environment. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined (e.g., the processes described herein in connection with FIGS. 2, 8, 11, and 14) herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine or interpreted using an appropriate execution environment for an interpreted language when an interpreted language is used.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer- and/or processor-executable instructions that can be employed to program a computer or other processor to implement various aspects of the technology as described above. The processor-executable instructions may include compiled code and/or interpreted code. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules (or, simply, “modules”), executed by one or more computers or other devices. Generally, modules include routines, programs, objects, components, data structures, etc. that perform particular tasks or implement particular abstract data types. Typically, the functionality of the modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the dataset fields with locations in a computer-readable medium that conveys relationship between the dataset fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 2, 8, 11, and 14. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for use by a construction software platform for evaluating use of one or more construction products in a construction project, the method comprising:
executing the construction software platform using at least one computer hardware processor to perform:
(A) obtaining an initial construction project model for the construction project;
(B) obtaining a selection of a first construction product for evaluating its use in the construction project, the first construction product being in a first construction project category;
(C) identifying, using the first construction product category or the first construction product, a first mapping software program for mapping the first construction product to the initial construction project model;
(D) executing the first mapping software program to map the first construction product to the initial construction project model to obtain an updated construction project model; and
(E) outputting the updated construction project model.

2. The method of claim 1, wherein obtaining the initial construction project model comprises obtaining one or more files specifying a model including spatial elements, materials, and/or shapes.

3. The method of claim 1, wherein obtaining the initial construction project model comprises obtaining a model file selected from the group consisting of an Industry Foundation Classes (IFC) model file, a Revit (RVT) file, an RFA file, a STEP file, a DWG file, a JSON file, and a drawing exchange format (DXF) file.

4. The method of claim 3, wherein obtaining the model file comprises receiving the model file using at least one communication network.

5. The method of claim 1, wherein obtaining the selection of the first construction product comprises:
receiving, via a graphical user interface, a selection of the first construction product category;
presenting, via the graphical user interface, a listing of one or more construction products in the first construction product category including the first construction product; and
receiving, via the graphical user interface, the selection of the first construction product.

6. The method of claim 5, wherein the graphical user interface is an interface presented to a user via an Internet browser application or an application program executing on a device of the user.

7. The method of claim 1,
wherein the construction software platform comprises multiple mapping software programs each of the multiple mapping software programs for mapping construction products in a respective construction product category to construction project models and being stored in association with information identifying the respective construction product category, and
wherein identifying the first mapping software program comprises selecting, as the first mapping software program and from among the multiple mapping software programs, a mapping software program that is stored in association with information identifying the first construction product category or in association with the first construction product.

8. The method of claim 1, wherein executing the first mapping software program to map the first construction product to the initial construction project model comprises:
generating a product design comprising an arrangement of one or more instances of the first construction product with respect to the initial construction project model.

9. The method of claim 8, wherein the product design specifies at least positioning of the one or more instances of the first construction product with respect to one another and with respect to the initial construction project model.

10. The method of claim 8, wherein outputting the updated construction project model comprises:
outputting a three-dimensional (3D) model of the initial construction project model with the product design arranged thereon.

11. The method of claim 1,
wherein the updated construction project model is a 3D model including the initial construction project model and one or more instances of the first construction product arranged thereon; and
wherein outputting the updated construction project model comprises outputting a rendering of the updated construction project model.

12. The method of claim 1, further comprising:
obtaining a selection of a second construction product for evaluating its use in the construction project, the second construction product being in a second construction project category; and
identifying, using the second construction product category or second construction product, a second mapping software program, different from the first mapping software program, for mapping the second construction product to the initial construction project model,
wherein the executing comprises executing the first mapping software program to map the first construction product to the initial construction project model and the second mapping software program to map the second construction product to the initial construction project model to obtain the updated construction project model.

13. The method of claim 1,
wherein the first construction product is associated with a schema instance of a schema associated with the first construction product category, the schema comprising attributes shared by construction products in the first construction product category, the schema instance specifying values of at least some of the attributes for the first construction product, and
wherein the executing is performed using the values of the at least some of attributes for the first construction product indicated in the schema instance.

14. The method of claim 13, further comprising:
modifying one or more of the values of the at least some of the attributes to obtain modified attribute values; and
executing, using the modified attribute values, the first mapping software program to map the first construction product to the initial construction project model.

15. The method of claim 13,
wherein the first construction product category is associated with a configurable computational pipeline, and
wherein executing the first mapping software program comprises:
identifying, using at least some of the values of the at least some attributes for the first construction product as specified in the schema instance, a first set of one or more software code portions to use for mapping the first construction product to the initial construction project model,
configuring the first configurable computational pipeline to use the first set of one or more software code portions; and
executing the first configurable computational pipeline to obtain the updated construction project model.

16. The method of claim 13, wherein the attributes include multiple input attributes, the method further comprising:
obtaining, for the first construction product, a selection of:
at least one of the multiple input attributes over whose possible values to optimize use of the first construction product;
at least one of the multiple output attributes to serve as at least one objective with respect to which to optimize the use of the first construction product; and
identifying one or more product designs, using an optimization technique and the first mapping software program, to evaluate use of the first construction product over values of the selected input attributes with respect to the at least one objective defined using the selected at least one output attribute.

17. The method of claim 1, wherein the first construction product category is selected from the group consisting of: boarding, solid wall panels, closed wall panels, twinwall, open wall panels, structural insulated panels (SIPs), insulated concrete panels, hollowcore floor, concrete lattice floor, floor cassette, solid floor panels, roof panels, roof trusses, prefabricated stairs, prefabricated plant, prefabricated balconies, pods, volumetric modules, facade systems, and whole-building system.

18. A system for evaluating use of one or more construction products in a construction project, the system comprising:
at least one computer hardware processor to perform:
at least one non-transitory computer-readable storage medium storing processor executable instructions that, when executed by the at least one computer hardware processor, cause the at least one computer hardware processor to perform:
(A) obtaining an initial construction project model for the construction project;
(B) obtaining a selection of a first construction product for evaluating its use in the construction project, the first construction product being in a first construction project category;
(C) identifying, using the first construction product category or the first construction product, a first mapping software program for mapping the first construction product to the initial construction project model;
(D) executing the first mapping software program to map the first construction product to the initial construction project model to obtain an updated construction project model; and
(E) outputting the updated construction project model.

19. The system of claim 18, wherein the first construction product is associated with a schema instance of a schema associated with the first construction product category, the schema comprising attributes shared by construction products in the first construction product category, the schema instance specifying values of at least some of the attributes for the first construction product, and wherein the executing is performed using the values of the at least some of attributes for the first construction product indicated in the schema instance.

20. At least one non-transitory computer-readable storage medium storing processor executable instructions that, when executed by at least one computer hardware processor, cause the at least one computer hardware processor to perform a method for evaluating use of one or more construction products in a construction project, the method comprising:
(A) obtaining an initial construction project model for the construction project;
(B) obtaining a selection of a first construction product for evaluating its use in the construction project, the first construction product being in a first construction project category;
(C) identifying, using the first construction product category or the first construction product, a first mapping software program for mapping the first construction product to the initial construction project model;
(D) executing the first mapping software program to map the first construction product to the initial construction project model to obtain an updated construction project model; and
(E) outputting the updated construction project model.
